(19) United States
(12) Patent Application Publication
(10) Pub. No.: US 2026/0211834 A1
(43) Pub. Date: Jul. 23, 2026

(54) Translating Between CXL.cache Messages for Multi-Host Cache Coherence and Memory Sharing

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/577,025

(22) Filed: Mar. 24, 2026

Related U.S. Application Data
(63) Continuation-in-part of application No. 19/371,779, filed on Oct. 28, 2025.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/695,957, filed on Sep. 18, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.

(51) Int. Cl. G06F 13/42

(52) U.S. Cl. CPC G06F 13/4221; G06F 2213/0026

(57) ABSTRACT

Translating between CXL.cache messages may enable large-scale AI clusters to interconnect heterogeneous accelerators via scale-up fabrics and disaggregated memory pools. Such translations may include receiving a CXL.cache Host-to-Device (H2D) request from a first entity, translating the H2D request to a CXL.cache Device-to-Host (D2H) request, and sending the D2H request to a second entity. The translation may encompass opcodes, addresses, and transaction identifiers. One system comprises first and second CXL interfaces and a computer that receives an H2D request via the first interface, translates the request to a D2H request, and sends the D2H request via the second interface. The translation may include address translation between Host Physical Address (HPA) spaces utilized by different entities. The translation capabilities may enable communication between entities that cannot communicate directly due to protocol direction constraints, supporting applications such as disaggregated memory systems, multi-GPU clusters, and heterogeneous computing platforms.

### CROSS-REFERENCE TO RELATED APPLICATIONS

This Application claims priority to: U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; U.S. Provisional Patent Application No. 63/811,859, filed May 25, 2025; and U.S. Provisional Patent Application No. 63/784,089, filed Apr. 5, 2025. This Application is also a Continuation-In-Part of U.S. patent application Ser. No. 19/371,779, filed Oct. 28, 2025, which claims priority to: U.S. Provisional Patent Application No. 63/752,940, filed Feb. 3, 2025; U.S. Provisional Patent Application No. 63/743,658, filed Jan. 10, 2025; and U.S. Provisional Patent Application No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Patent Application No. 63/719,640, filed 12 Nov. 2024; U.S. Provisional Patent Application No. 63/701,554, filed 30 Sep. 2024; U.S. Provisional Patent Application No. 63/695,957, filed 18 Sep. 2024; U.S. Provisional Patent Application No. 63/678,045, filed 31 Jul. 2024; U.S. Provisional Patent Application No. 63/652,165, filed 27 May 2024; and U.S. Provisional Patent Application No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Patent Application No. 63/609,833, filed 13 Dec. 2023.

### BACKGROUND

Compute Express Link (CXL) is an interconnect technology that enables cache-coherent memory access and high-bandwidth communication between hosts and devices in modern computing systems. CXL builds upon the physical and electrical interface defined by PCIe while adding protocols that support memory semantics and cache coherency operations. The CXL specification defines sub-protocols, including CXL.io for input/output operations, CXL.mem for memory access, and CXL.cache for cache coherency.

CXL.cache enables devices to cache host memory with coherency, utilizing distinct message channels for communication in different directions. Host-to-Device (H2D) messages carry requests, responses, and data from a host toward a device, while Device-to-Host (D2H) messages carry requests, responses, and data from a device toward a host. The H2D channel includes H2D request messages that may carry snoop opcodes along with address information and transaction identifiers such as Unique Queue IDs (UQIDs). The D2H channel includes D2H request messages that may carry read and cache management opcodes along with address information and command queue identifiers (CQIDs). These directional channels operate according to the roles defined in the CXL specification, wherein hosts issue H2D messages and devices issue D2H messages.

Computing systems may incorporate hosts that operate with Host Physical Address (HPA) spaces for memory access and resource allocation. The HPA space utilized by a host defines the physical address range through which the host accesses memory resources. Cache coherency operations within CXL.cache reference addresses within these HPA spaces to identify cachelines subject to coherency actions such as invalidation, data transfer, or state transitions.

### SUMMARY

Heterogeneous computing architectures may incorporate hosts within computing systems, wherein these hosts may utilize different address spaces while requiring coordinated access to shared resources. In such multi-host environments, there may be scenarios where a first host operating with a first Host Physical Address (HPA) space needs to maintain cache coherency with a second host operating with a second HPA space. However, direct communication between hosts utilizing CXL.cache may be constrained by the directional nature of the protocol, wherein H2D messages flow from hosts toward devices and D2H messages flow from devices toward hosts. Some of the implementations address these challenges by providing translation between CXL.cache messages, facilitating memory coherency operations, cacheline invalidations, and data transfers while maintaining the requirements of CXL.cache.

In various implementations, a method for translating between CXL messages comprises receiving, from a first entity, a CXL.cache H2D request; translating the CXL.cache H2D request to a CXL.cache D2H request; and sending the CXL.cache D2H request to a second entity. The translation may encompass various aspects of the protocol messages, including opcodes, addresses, and transaction identifiers, thereby enabling coherent communication between entities that cannot communicate directly due to protocol direction constraints.

In other implementations, a system comprises first and second interfaces based on CXL, and a computer coupled to the first and second interfaces. The computer is configured to receive, from a first entity via the first interface, a CXL.cache H2D request comprising a first address belonging to a first HPA space; translate the CXL.cache H2D request to a CXL.cache D2H request comprising a second address belonging to a second HPA space; and send the CXL.cache D2H request to a second entity via the second interface. The system may enable diverse architectures such as disaggregated memory systems, multi-GPU clusters, or heterogeneous computing platforms.

In still other implementations, a system comprises first and second interfaces based on CXL and a computer coupled to the first and second interfaces. The computer is configured to receive a CXL.cache H2D request from a first entity, translate the H2D request to a CXL.cache D2H request, and send the D2H request to a second entity, wherein the translation enables cacheline state orchestration between a first cache maintained by the first entity and a second cache maintained by the second entity.

### BRIEF DESCRIPTION OF THE DRAWINGS

FIG. 1A illustrates an example of a system that translates between first and second CXL.cache;

FIG. 1B illustrates an example of a transaction flow diagram (TFD) demonstrating translations between CXL.cache H2D SnpInv request and CXL.cache D2H CLFlush request;

FIG. 1C illustrates an example of a TFD demonstrating translations between CXL.cache H2D SnpCur request and CXL.cache D2H RdCurr request;

FIG. 2A illustrates an example of a system that translates between CXL.cache messages, such as between CXL.cache Host-to-Device (H2D) requests and CXL.cache Device-to-Host (D2H) requests;

FIG. 2B illustrates an example of a TFD demonstrating translations between CXL.cache transactions;

FIG. 3A illustrates an example of a system that translates between CXL.cache messages, such as between CXL.cache H2D requests comprising Snoops and CXL.cache D2H requests comprising read opcodes;

FIG. 3B illustrates an example of a TFD demonstrating translations between CXL.cache H2D request comprising SnpData and CXL.cache D2H request comprising RdShared;

FIG. 3C illustrates an example of a TFD demonstrating translations between CXL.cache H2D request comprising SnpData and CXL.cache D2H request comprising RdOwn;

FIG. 3D illustrates an example of a TFD demonstrating translations between CXL.cache H2D request comprising SnpInv and CXL.cache D2H request comprising CLFlush;

FIG. 4A illustrates an example of a TFD demonstrating translations between CXL.cache H2D SnpInv and CXL.cache D2H RdOwnNoData;

FIG. 4B illustrates an example of a TFD demonstrating translations between CXL.cache H2D SnpInv and CXL.cache D2H RdOwn, returning a cacheline in Modified state (GO-M);

FIG. 4C illustrates an example of a TFD demonstrating translations between CXL.cache H2D SnpInv and CXL.cache D2H RdOwn, returning a cacheline in Exclusive state (GO-E);

FIG. 5A illustrates an example of a system that translates between CXL.cache messages;

FIG. 5B illustrates an example of a TFD demonstrating translations between CXL.cache H2D SnpData and CXL.cache D2H RdShared, returning a cacheline in Shared state (GO-S);

FIG. 6A illustrates an example of a system that translates between CXL.cache messages that affect cacheline state transitions;

FIG. 6B illustrates an example of a transaction flow diagram (TFD) demonstrating translations between CXL.cache D2H CLFlush request and CXL.cache H2D SnpInv request;

FIG. 6C illustrates an example of a TFD demonstrating translations between CXL.cache D2H RdCurr and CXL.cache H2D SnpCur;

FIG. 7A illustrates an example of a TFD demonstrating intent-based translations between CXL.mem M2S SnpCur and CXL.cache D2H RdCurr;

FIG. 7B illustrates an example of a TFD demonstrating intent-based translations between CXL.mem M2S SnpData and CXL.cache D2H RdShared;

FIG. 7C illustrates an example of a TFD demonstrating intent-based translations between CXL.mem M2S SnpInv and CXL.cache D2H RdOwn;

FIG. 8A illustrates an example of a TFD demonstrating intent-based translations between CXL.cache D2H RdCurr and CXL.mem M2S SnpCur;

FIG. 8B illustrates an example of a TFD demonstrating intent-based translations between CXL.cache D2H RdShared and CXL.mem M2S SnpData;

FIG. 8C illustrates an example of a TFD demonstrating intent-based translations between CXL.cache D2H RdOwn and CXL.mem M2S SnpInv;

FIG. 9A illustrates an example of a system that translates between first and second CXL.mem;

FIG. 9B illustrates an example of a transaction flow diagram (TFD) demonstrating translations between CXL.mem M2S MemRdData request and CXL.mem M2S MemRd request, with optional speculative memory reads;

FIG. 10A illustrates an example of a system comprising a computer, having a buffer/cache, which translates between first and second CXL.mem;

FIG. 10B illustrates an example of a TFD demonstrating translations between a first CXL.mem M2S MemSpecRd and a second CXL.mem M2S MemSpecRd, with an optional initiation of a third CXL.mem M2S MemSpecRd;

FIG. 10C illustrates an example of a TFD demonstrating translations between CXL.mem M2S MemSpecRd and CXL.mem M2S MemRd*;

FIG. 11A illustrates an example of a system that translates between three CXL.mem interfaces;

FIG. 11B illustrates an example of a TFD demonstrating translations between four CXL.mem M2S requests;

FIG. 12A illustrates an example of a system comprising a processor/switch with a CXL device configured to enable external entities to access resources coupled to the processor;

FIG. 12B illustrates an example of a TFD demonstrating translations between first and second CXL.mem transactions comprising MemRd*;

FIG. 13A illustrates an example of a system comprising a processor configured to communicate with multiple hosts according to CXL.mem;

FIG. 13B illustrates an example of a TFD demonstrating two CXL.mem transactions directed to different memories coupled to a processor;

FIG. 14A illustrates an example of a system that translates between CXL.mem and CXL.io;

FIG. 14B illustrates an example of a TFD demonstrating translations between CXL.mem M2S request and CXL.io UIOMRd;

FIG. 14C illustrates an example of a TFD demonstrating translations between CXL.mem M2S request and CXL.io MRd;

FIG. 15A illustrates an example of a system comprising a first host coupled to a first memory, a second host coupled to a second memory, and a computer to translate between CXL.mem and CXL.io;

FIG. 15B illustrates an example of a TFD demonstrating translations between CXL.mem M2S request with data (RwD) and CXL.io Memory Write request (MWr);

FIG. 15C illustrates an example of a TFD demonstrating translations between CXL.mem M2S request with data (RwD) and CXL.io UIO Memory Write request (UIOMWr);

FIG. 16A illustrates an example of a system that translates between CXL protocols, such as between CXL.io and CXL.mem;

FIG. 16B illustrates an example of a TFD demonstrating translations between CXL.io TLPs and CXL.mem messages;

FIG. 16C illustrates an example of a TFD demonstrating translations between CXL.io UIO TLPs and CXL.mem messages;

FIG. 17A illustrates an example of a system that translates between CXL.mem and PCIe;

FIG. 17B illustrates an example of a transaction flow diagram (TFD) demonstrating translations between CXL.mem M2S request and PCIe MRd;

FIG. 17C illustrates an example of a TFD demonstrating translations between CXL.mem M2S request and PCIe UIOMRd;

FIG. 18A illustrates an example of a system comprising first and second entities coupled by a computer that translates between CXL.mem and PCIe;

FIG. 18B illustrates an example of a TFD demonstrating translations between CXL.mem M2S RwD and PCIe MWr;

FIG. 18C illustrates an example of a TFD demonstrating translations between CXL.mem M2S RwD and PCIe UIOMWr;

FIG. 19A illustrates an example of a system comprising a cable that translates between CXL-based traffic and PCIe-based traffic;

FIG. 19B illustrates an example of a TFD demonstrating translations performed by an active cable between CXL.mem transactions and PCIe transactions;

FIG. 20A illustrates an example of a system that translates between PCIe and CXL.mem;

FIG. 20B illustrates an example of a TFD demonstrating translations between PCIe TLPs and CXL.mem messages;

FIG. 20C illustrates an example of a TFD demonstrating translations between PCIe UIO TLPs and CXL.mem messages;

FIG. 21A illustrates an example of a system that translates between CXL-based traffic and PCIe-based traffic;

FIG. 21B illustrates an example of a TFD demonstrating translations between CXL.io UIOMRd and PCIe UIOMRd;

FIG. 21C illustrates an example of a TFD demonstrating translations between CXL.io UIOMRd and PCIe MRd;

FIG. 22A illustrates an example of a system that translates between CXL.io traffic;

FIG. 22B illustrates an example of a TFD demonstrating translations between CXL.io MRd and CXL.io UIOMRd;

FIG. 22C illustrates an example of a TFD demonstrating translations between CXL.io UIOMRd and CXL.io MRd;

FIG. 23A illustrates a system comprising a Fabric Resource Entity (FRE) coupled to a CXL Fabric, a computer coupled to the FRE, and target entities coupled to the computer;

FIG. 23B is a flowchart illustrating a method for enabling bidirectional communication by an FRE in a CXL Fabric;

FIG. 24A illustrates an example of a system that translates between first and second PCIe-based protocols;

FIG. 24B illustrates an example of a TFD demonstrating translations between PCIe MRd and PCIe UIOMRd; and

FIG. 24C illustrates an example of a TFD demonstrating translations between PCIe UIOMRd and PCIe MRd.

### DETAILED DESCRIPTION

Heterogeneous computing architectures may incorporate hosts within computing systems, wherein these hosts may utilize different address spaces while requiring coordinated access to shared resources. In such multi-host environments, there may be scenarios where a first host operating with a first Host Physical Address (HPA) space needs to maintain cache coherency with a second host operating with a second HPA space, wherein both hosts communicate using CXL.cache. Translations between CXL.cache messages associated with different hosts may facilitate memory coherency operations, cacheline invalidations, and data transfers across different address spaces while maintaining the requirements of CXL.cache.

In various implementations, a method for translating between Compute Express Link (CXL) messages, comprising: receiving, from a first entity, a CXL.cache Host-to-Device (H2D) request; translating the CXL.cache H2D request to a CXL.cache Device-to-Host (D2H) request; and sending the CXL.cache D2H request to a second entity. The translation process may encompass various aspects of the protocol messages, including opcodes, addresses, and transaction identifiers, thereby enabling coherent communication between hosts that cannot communicate directly, such as due to protocol limitations or direction mismatches. The method may be implemented in hardware, firmware, software, or combinations thereof, and may be performed by various types of devices, such as semiconductor devices and/or RPUs.

In some implementations of the method, the first entity comprises a first host, and the CXL.cache H2D request comprises a first address belonging to a first Host Physical Address (HPA) space utilized by the first host; and wherein the second entity comprises a second host, and wherein the CXL.cache D2H request comprises a second address belonging to a second HPA space utilized by the second host. In some examples, the address translation may be implemented utilizing lookup tables, page tables, hash tables, base-and-offset calculations, and/or programmable translation functions. The first and second HPA spaces may have different sizes, different base addresses, or different memory layouts, and the translation may accommodate these differences while maintaining the meaning of the memory operations.

In some implementations of the method, the CXL.cache H2D request comprises snoop invalidate (SnpInv) and Unique Queue ID (UQID), and wherein the CXL.cache D2H request comprises CacheLine Flush (CLFlush) and command queue identifier (CQID). The translation from SnpInv to CLFlush may enable the first host to invalidate cachelines in the second host's cache hierarchy. The UQID from the H2D request may be mapped to the CQID in the D2H request, wherein this mapping may be maintained in a translation table, a tracker entry, or similar data structure.

In some implementations of the method, the CXL.cache H2D request comprises snoop invalidate (SnpInv) and Unique Queue ID (UQID), and the CXL.cache D2H request comprises command queue identifier (CQID) and Read for Ownership No Data (RdOwnNoData) or Read for Ownership (RdOwn). The translation from SnpInv to RdOwnNoData or to RdOwn may enable the first host to perform cross-orchestration of cacheline states between the cache coherency subsystems of the first host and the second host, by optionally invalidating a cacheline address in the cache hierarchy of the second host and marking the cacheline address in exclusive state, possibly preceding a write operation by the first host.

In some implementations, the method further comprises receiving from the second host a CXL.cache H2D Data, translating the CXL.cache H2D Data to a CXL.cache Device-to-Host (D2H) Data, and sending the CXL.cache D2H Data to the first host.

In some implementations of the method, the CXL.cache H2D request comprises SnpData and Unique Queue ID (UQID), and the CXL.cache D2H request comprises RdShared and command queue identifier (CQID). The translation from SnpData to RdShared may enable the first host to acquire a cacheline in shared state from the second host's cache hierarchy. RdShared may request the cacheline to be cached in shared state, which may permit both the first host and the second host to retain cached copies of the cacheline. The UQID from the H2D request may be mapped to the CQID in the D2H request, wherein this mapping may be maintained in a translation table or tracker entry.

In some implementations of the method, the CXL.cache H2D request comprises SnpData and Unique Queue ID (UQID), and the CXL.cache D2H request comprises RdOwn and command queue identifier (CQID). The translation from SnpData to RdOwn may enable the first host to acquire a cacheline in exclusive state, even though SnpData may indicate an intent to acquire shared or exclusive state. The translation logic may select RdOwn based on additional factors such as system configuration, anticipated access patterns, or optimization policies. RdOwn may cause the second host to relinquish ownership of the cacheline and provide cacheline data to the translation logic, which may forward the data to the first host.

In some implementations of the method, the CXL.cache H2D request comprises snoop invalidate (SnpInv) and Unique Queue ID (UQID), the CXL.cache D2H request comprises RdOwn and command queue identifier (CQID), and further comprising receiving from the second host a CXL.cache H2D Data message comprising cacheline data. The translation from SnpInv to RdOwn may enable the first host to acquire exclusive ownership of the cacheline while also receiving cacheline data from the second host. The second host may respond with a GO-M or GO-E indication along with the cacheline data, which may indicate that the second host previously held the cacheline in modified state, or provides the cacheline in exclusive state. The translation logic may translate the received H2D Data message to a D2H Data message for delivery to the first host, thereby completing the data transfer and cache state transition. In one example, the CXL.cache H2D request comprises an opcode selected from SnpData, or SnpCur; and wherein the CXL.cache D2H request comprises an opcode selected from RdCurr, RdOwn, RdShared, RdAny, RdOwnNoData, ItoMWr, WrCur, CleanEvict, DirtyEvict, CleanEvictNoData, WOWrInv, WOWrInvF, WrInv, or CacheFlushed. The translation logic may select appropriate D2H opcodes based on the specific H2D opcode received, preserving the intent of the original operation while adapting to the protocol requirements of the receiving host. For example, in some implementations the translation logic may translate an H2D request comprising SnpCur to a D2H request comprising RdCurr, and may further respond to the H2D request with a D2H response comprising RspSFwdM, RspIFwdM or RspVFwdV and with a D2H Data comprising data retrieved by the RdCurr D2H request. In other implementations, the translation logic may translate an H2D request comprising SnpData to a D2H request comprising RdShared; and may further respond to the H2D request with a D2H response comprising RspSFwdM and with a D2H Data comprising data retrieved by the RdShared D2H request.

In some implementations, the method further comprises receiving, from the second entity, a CXL.cache H2D Data message comprising cacheline data and command queue identifier (CQID); translating the CXL.cache H2D Data message to a CXL.cache D2H Data message comprising the cacheline data and Unique Queue ID (UQID); and sending the CXL.cache D2H Data message to the first entity. The translation of data messages may enable cacheline data to flow from the second host to the first host via the translation logic. The CQID in the H2D Data message may be translated to a corresponding UQID utilizing a previously stored mapping, enabling proper correlation with the originating request. The cacheline data may include 64 bytes or other cacheline sizes supported by CXL.cache, and may be forwarded without modification or may be subjected to additional processing such as address translation or data transformation.

In some implementations, the method further comprises receiving, from the second entity, a CXL.cache H2D response comprising a GO opcode and command queue identifier (CQID); translating the CXL.cache H2D response to a CXL.cache D2H response comprising Rsp* and Unique Queue ID (UQID); and sending the CXL.cache D2H response to the first entity. The GO response from the second host, such as GO-I, may be translated to Rsp*, such as RspIHitI, for the first host, indicating that the cacheline was not found in the device cache (i.e., the cacheline is in Invalid state). The translation may utilize the previously stored UQID-to-CQID mapping to correctly route the response back to the originating transaction.

In some implementations of the method, the CXL.cache H2D response comprises a GO opcode and a field indicating an Invalid state (GO-I), and wherein the CXL.cache D2H response comprises RspIHitI.

In some implementations, the method further comprises receiving, from the second entity, a CXL.cache H2D Data comprising command queue identifier (CQID); translating the CXL.cache H2D Data to a CXL.cache D2H response comprising *Fwd* and Unique Queue ID (UQID); and sending the CXL.cache D2H response to the first entity. The CXL.cache H2D Data from the second host may be translated to a CXL.cache D2H response comprising *Fwd*, such as RspSFwdM, RspIFwdM, or RspVFwdV, sent to the first host, indicating that a CXL.cache D2H response may be followed by a CXL.cache D2H Data, possibly enabling data transfer from the second host to the first host via the RPU.

In some implementations of the method, the CXL.cache D2H request comprises RdCurr and command queue identifier (CQID); and further comprising translating the CXL.cache H2D Data to a CXL.cache D2H response comprising RspVFwdV and Unique Queue ID (UQID).

In some implementations, the method further comprises receiving, from the second entity, a CXL.cache H2D response comprising a GO opcode and command queue identifier (CQID); translating the CXL.cache H2D response to a CXL.cache D2H Data comprising Unique Queue ID (UQID); and sending the CXL.cache D2H Data to the first entity. The CXL.cache H2D response from the second host may be translated to a CXL.cache D2H Data and sent to the first host, such as in error scenarios where synthesized data may be generated based on error responses from the second host.

In some implementations, the method further comprises exposing a CXL Type-1 device or a CXL Type-2 device to the first entity via a first interface, and exposing a CXL Type-1 device or a CXL Type-2 device to the second entity via a second interface. The device type exposure may determine the types of CXL.cache transactions that can be initiated and received by each interface. By exposing appropriate device types to each host, the translation may accommodate different system configurations and use cases. Similar or different device types may be exposed to different hosts simultaneously based on system configuration requirements.

In some implementations of the method, the translating comprises performing translations between the CXL.cache H2D request and the CXL.cache D2H request, wherein the translations comprise translations between Unique Queue ID (UQID) and command queue identifier (CQID), translations between reserved fields, and/or translations between reserved and non-reserved fields. UQIDs and CQIDs may serve as transaction identifiers in their respective protocol directions. Reserved fields in one protocol direction may be mapped to active fields in the other direction, potentially carrying additional metadata or control information.

In some implementations, the method further comprises receiving, from the second entity, a CXL.cache H2D response comprising a GO-S indication and command queue identifier (CQID); translating the CXL.cache H2D response to a CXL.cache D2H response comprising RspSHitSE and Unique Queue ID (UQID); and sending the CXL.cache D2H response to the first entity. The GO-S indication may signify that the second host is providing the cacheline in shared state, permitting concurrent caching by multiple entities. RspSHitSE may indicate to the first host that the cacheline was hit in a clean state and its current state is shared, enabling cacheline state orchestration wherein both the first host and the second host may store the cacheline in shared state. The translation may utilize a previously stored UQID-to-CQID mapping to correctly route the response back to the originating transaction.

In some implementations, the method further comprises receiving, from the second entity, a CXL.cache H2D response comprising a GO-E indication and command queue identifier (CQID); translating the CXL.cache H2D response to a CXL.cache D2H response comprising an opcode selected from RspIHitI, RspIHitSE, or RspIFwdM, and comprising Unique Queue ID (UQID); and sending the CXL.cache D2H response to the first entity. The GO-E indication may signify that the second host has granted exclusive ownership of the cacheline address. The translated D2H response opcode may indicate to the first host that the cacheline is no longer present in the cache abstraction exposed by the translation logic, enabling the first host to transition the cacheline state to exclusive. The selection among RspIHitI, RspIHitSE, or RspIFwdM may depend on the prior state of the cacheline and whether data forwarding is involved, and may enable proper cache coherency protocol completion at the first host.

In some implementations, the method further comprises receiving, from the second entity, a CXL.cache H2D response comprising a GO-M indication and command queue identifier (CQID), and a CXL.cache H2D Data message comprising cacheline data; translating the CXL.cache H2D response to a CXL.cache D2H response comprising RspIFwdM and Unique Queue ID (UQID); and sending the CXL.cache D2H response to the first entity. The GO-M indication may signify that the second host previously held the cacheline in modified state and is relinquishing ownership along with the modified data. RspIFwdM may indicate to the first host that the cacheline was found in modified state and is being forwarded, possibly enabling the first host to transition the cacheline state to modified. The modified cacheline data may be translated from the H2D Data message to a D2H Data message and forwarded to the first host, thereby completing the ownership transfer and data delivery.

In some implementations, the method further comprises exposing a cache abstraction to the first entity via a CXL.cache interface, wherein the cache abstraction acts as a proxy for a cache included in the second entity, and the CXL.cache H2D request targets the cache abstraction. The cache abstraction may appear to the first host as a device cache accessible utilizing CXL.cache transactions, while internally representing or proxying cache resources maintained by the second host. The first host may issue CXL.cache H2D requests, such as snoop requests, that target the cache abstraction, wherein the translation logic may translate these requests to CXL.cache D2H requests that affect actual caches in the second host. This proxy arrangement may enable cache coherency operations between hosts that cannot communicate directly, such as due to protocol direction constraints or address space differences.

In some implementations of the method, the translating enables cacheline state orchestration between a first cache maintained by the first entity and a second cache maintained by the second entity. The cacheline state orchestration may coordinate transitions between cache states, such as Modified, Exclusive, Shared, or Invalid (MESI) states, across the first and second caches maintained by the first and second entities, respectively, wherein a transition of the first cache to a first cache state (e.g., Exclusive) may be coordinated with a transition of the second cache to a second cache state (e.g., Invalid). The translation logic may enable the first entity to influence the cacheline state in the second entity's cache hierarchy by translating H2D requests into corresponding D2H requests that trigger appropriate cache state transitions at the second entity.

In some implementations of the method, the cacheline state orchestration comprises cross invalidation of cacheline states; and/or wherein the cacheline state orchestration enables cache-coherent memory sharing between the first entity and the second entity. Cross invalidation may enable the first host to cause invalidation of cacheline entries in the second host's cache hierarchy, or vice versa, thereby maintaining cache coherency across the multi-host system. The cacheline state orchestration may encompass transitions between various cache states such as Modified, Exclusive, Shared, or Invalid (MESI), or similar cache coherency protocols. The translation logic may track pending transactions and coordinate state transitions to maintain coherency invariants across both cache hierarchies. Additionally or alternatively, cache-coherent memory sharing may enable the first host and the second host to access shared memory regions while maintaining data consistency through the cache coherency protocol. The translation logic may facilitate coherent access by translating snoop operations, read requests, and writeback operations between the hosts, such that memory updates by one host are visible to the other host in accordance with the memory consistency model. Such cache-coherent memory sharing may be utilized in disaggregated memory systems, multi-GPU clusters, heterogeneous computing platforms, or other multi-host architectures.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: first and second interfaces based on Compute Express Link (CXL); a computer coupled to the first and second interfaces, wherein the computer is configured to: receive, from a first entity via the first interface, a CXL.cache Host-to-Device (H2D) request comprising a first address belonging to a first Host Physical Address (HPA) space; translate the CXL.cache H2D request to a CXL.cache Device-to-Host (D2H) request comprising a second address belonging to a second HPA space; and send the CXL.cache D2H request to a second entity via the second interface. The computer may include processing logic, memory for storing translation tables and transaction state, and interface controllers for managing CXL.cache communications with each host. The system may be implemented as a standalone device, integrated into a larger semiconductor component, or distributed across components within a computing platform. The translation capabilities may enable diverse system architectures such as disaggregated memory systems, multi-GPU clusters, or heterogeneous computing platforms. Additionally or alternatively, the computer may further expose a cache abstraction to the first entity via the first interface, wherein the cache abstraction acts as a proxy for a cache included in the second entity. The first host may enumerate and interact with the cache abstraction as a local device cache, while the computer internally translates cache operations to CXL.cache D2H requests directed to the second host. It may enable transparent cache coherency operations across hosts without requiring direct host-to-host communication or protocol-level awareness of the multi-host topology.

In some implementations of the system, the first entity comprises a first host utilizing the first HPA space, and the second entity comprises a second host utilizing the second HPA space; and wherein the computer is further configured to identify an intent indicated by the CXL.cache H2D request, wherein the intent comprises a cacheline state intent for a cacheline address, and wherein the translating is based at least in part on the identified intent. The computer may include logic circuits, processing elements, or firmware that analyze incoming CXL.cache H2D requests and determine the cacheline state intent from request attributes such as opcodes and address values. The identified intent may be utilized to select appropriate translation mappings, D2H request opcodes, and/or address translations. The computer may maintain intent-to-opcode mapping tables or may implement intent identification through combinational logic or state machines.

In various implementations, a system comprising: first and second interfaces based on Compute Express Link (CXL); a computer coupled to the first and second interfaces, wherein the computer is configured to: receive, from a first entity via the first interface, a CXL.cache Host-to-Device (H2D) request; translate the CXL.cache H2D request to a CXL.cache Device-to-Host (D2H) request; and send the CXL.cache D2H request to a second entity via the second interface; wherein the translation enables cacheline state orchestration between a first cache maintained by the first entity and a second cache maintained by the second entity. The system may be implemented as a standalone semiconductor device, integrated into a larger component such as an RPU, or distributed across components within a computing platform. The cacheline state orchestration may coordinate transitions between cache states across both entities, such as transition of the first cache to Exclusive state that is coordinated with transition of the second cache to an Invalid state, wherein translating the CXL.cache messages enables coherency operations that would otherwise be prevented by protocol constraints. The first and second interfaces may expose CXL Type-1 or CXL Type-2 device interfaces to the respective entities, enabling the entities to interact with the system utilizing CXL.cache transactions.

In some implementations of the system, the cacheline state orchestration comprises cross invalidation of cacheline states, and wherein the cacheline state orchestration enables cache-coherent memory sharing between the first entity and the second entity. Cross invalidation may enable the first entity to cause invalidation of cacheline entries in the second entity's cache hierarchy, or vice versa, which may enable the first cache to transition to an Exclusive state coordinated with a transition of the second cache to an Invalid state, thereby maintaining cache coherency across a multi-entity system. Cache-coherent memory sharing may enable the first entity and the second entity to access shared memory regions while maintaining data consistency through the cache coherency protocol. The computer may facilitate coherent access by translating snoop operations, read requests, and writeback operations between the entities, and may be utilized in disaggregated memory systems, multi-GPU clusters, heterogeneous computing platforms, or other multi-entity architectures.

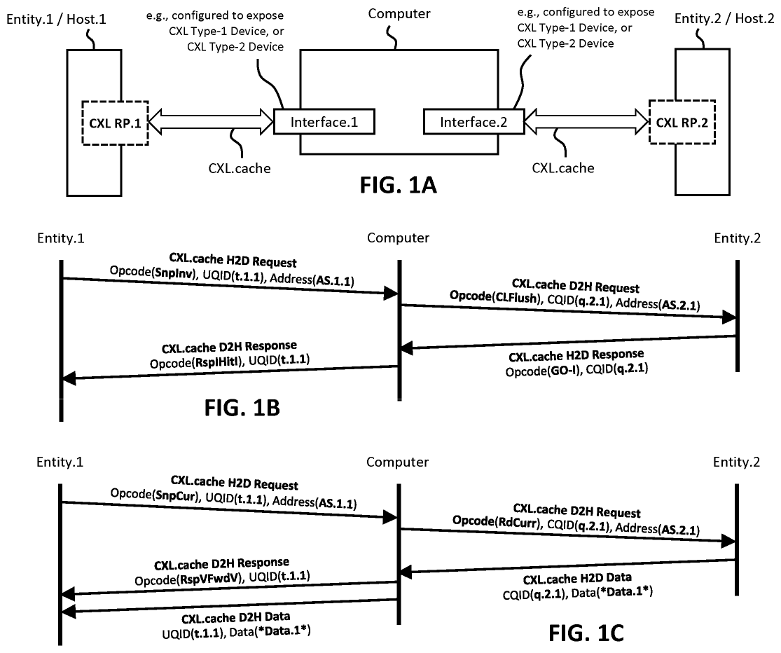

FIG. 1A illustrates an example of a system comprising a computer coupled between a first interface (Interface.1) and a second interface (Interface.2). The first interface may expose a CXL type-1 device or a CXL type-2 device, and may communicate according to a first CXL.cache with a first entity, such as a first host (Host.1), optionally via a first CXL root port (CXL RP.1) of the first entity. Similarly, the second interface may expose a CXL type-1 device or a CXL type-2 device, and may communicate according to a second CXL.cache with a second entity (Entity.2), such as a second host (Host.2), optionally via a second CXL root port (CXL RP.2) of the second entity. The computer may: extract physical addresses within messages received via the first interface, wherein these addresses may be from a first HPA space utilized by the first entity; translate these addresses; and generate messages carrying the translated physical addresses for transmission via the second interface; wherein these translated addresses may correspond to a second HPA space utilized by the second entity. Optionally, the interfaces may be implemented as internal and/or external interfaces of a semiconductor device comprising the computer.

FIG. 1B illustrates an example of a TFD demonstrating translations, performed by a computer, between first CXL.cache messages received from a first entity (Entity.1), such as a first host (Host.1), and second CXL.cache messages sent to a second entity (Entity.2), such as a second host (Host.2), possibly enabling the first entity to maintain, at least partly, memory sharing and/or memory coherency with the second entity, such as by enabling the first entity to invalidate cachelines in the second entity. The first entity may initiate a first CXL.cache transaction that includes a CXL.cache H2D request comprising Opcode(SnpInv), UQID(t.1.1), and Address(AS.1.1). The computer may translate the first CXL.cache transaction to a second CXL.cache transaction that includes a CXL.cache D2H request comprising Opcode(CLFlush), CQID(q.2.1), and Address(AS.2.1), and may send the CXL.cache D2H request to the second entity. Upon receiving a response from the second entity, which may include a CXL.cache H2D response comprising Opcode(GO-I) and CQID(q.2.1), the computer may translate the CXL.cache H2D response to a CXL.cache D2H response comprising Opcode(RspIHitI), and UQID(t.1.1). The computer may perform further translations, such as opcode translations, e.g., translating between CXL.cache H2D request opcodes, such as Snp* (e.g., SnpData, SnpInv, and SnpCur), and CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed. The computer may further perform other translations, such as field translations between messages conforming to the first CXL.cache transaction and messages conforming to the second CXL.cache transaction, such as translations between UQIDs and CQIDs, translations between reserved fields, and/or translations between reserved and non-reserved fields.

FIG. 1C illustrates an example of a TFD demonstrating translations performed by a computer between CXL.cache transactions, wherein the transactions may include messages such as requests, responses, and optionally data messages. A first entity (Entity.1), such as a first host (Host.1), may send to the computer a CXL.cache H2D request comprising Opcode(SnpCur), UQID(t.1.1), and Address(AS.1.1), wherein the CXL.cache H2D request may indicate a snoop request for the current version of a cacheline. The computer may translate the CXL.cache H2D request to a CXL.cache D2H request comprising Opcode(RdCurr), CQID(q.2.1), and Address(AS.2.1), wherein the CXL.cache D2H request may indicate a read request from the computer to the second entity for the current version of the cacheline. The computer may provide intent-based translations, such as by identifying intents in CXL.cache H2D requests received from the first entity, such as intents to get the current version of a cacheline, and utilizing the identified intents for translating between the CXL.cache H2D requests and the CXL.cache D2H requests. The second entity may respond to the CXL.cache D2H request comprising the RdCurr opcode with a CXL.cache H2D Data comprising CQID(q.2.1) and Data(*Data.1*). The computer may translate the CXL.cache H2D Data to a CXL.cache D2H response comprising Opcode(RspVFwdV) and UQID(t.1.1) and may send the CXL.cache D2H response to the first entity. The computer may further translate the CXL.cache H2D Data to a CXL.cache D2H Data comprising UQID(t.1.1) and Data(*Data.1*) and may send the CXL.cache D2H Data to the first entity.

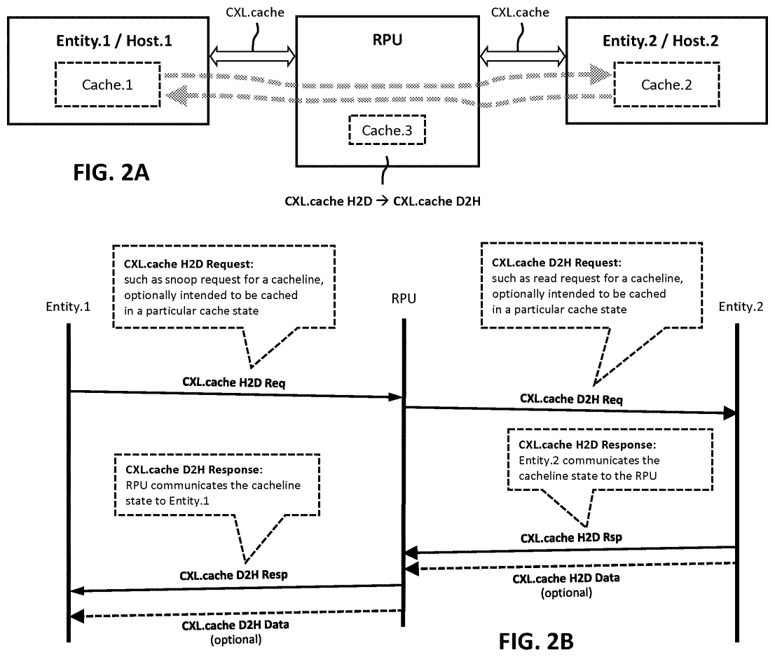

FIG. 2A illustrates an example of a system comprising an RPU and an optional third cache (Cache.3). The RPU may utilize CXL.cache for communicating with a first entity (Entity.1), such as a first host (Host.1), which may include a first cache (Cache.1). The RPU may further utilize CXL.cache for communicating with a second entity (Entity.2), such as a second host (Host.2), which may include a second cache (Cache.2). The RPU may translate between CXL.cache transactions, or between CXL.cache messages, such as between CXL.cache H2D requests and CXL.cache D2H requests, between CXL.cache H2D responses and CXL.cache D2H responses, and optionally between CXL.cache H2D Data messages and CXL.cache D2H Data messages, possibly enabling cacheline state orchestration between the first cache, the second cache, and optionally the third cache, wherein the cacheline state orchestration may be utilized, at least partly, for enabling memory sharing, such as cache-coherent memory sharing, between the first entity and the second entity. In some examples, the first entity may issue CXL.cache H2D requests, such as snoop requests, that may target a cache maintained by the RPU, such as the third cache (Cache.3) that may be included in the RPU. In other examples, the first entity may issue CXL.cache H2D requests, such as snoop requests, that may target a cache abstraction maintained by the RPU, wherein the RPU may act as a proxy for a cache included in the second entity, such as the second cache (Cache.2), and wherein the RPU may affect the second cache utilizing CXL.cache D2H requests that may cause cacheline state transitions in the second cache.

FIG. 2B illustrates an example of a TFD demonstrating translations, performed by an RPU, between CXL.cache transactions, wherein the transactions may include messages such as requests, responses, and optionally data messages. A first entity (Entity.1), such as a first host (Host.1), may send to the RPU a CXL.cache H2D request, such as a snoop request for a cacheline optionally intended to be cached in a particular cache state in the first entity. In a first example, the first entity may send to the RPU a CXL.cache H2D request comprising SnpData, that may indicate a snoop request from the first entity for a cacheline that is intended to be cached in either shared or exclusive state at the first entity. In a second example, the first entity may send to the RPU a CXL.cache H2D request comprising SnpInv, that may indicate a snoop request from the first entity for a cacheline that is intended to be cached in exclusive state at the first entity. The RPU may translate the CXL.cache H2D request to a CXL.cache D2H requests, such as a read request for a cacheline, optionally intended to be cached in particular cache state, and send the CXL.cache D2H requests to the second entity. The RPU may provide intent-based translations, such as by identifying intents in CXL.cache H2D requests received from the first entity and utilizing the identified intents for translating the CXL.cache H2D requests to the CXL.cache D2H requests.

In a first example, the RPU may translate a CXL.cache H2D request comprising SnpData, to a CXL.cache D2H request comprising RdShared, which requests a cacheline read to be cached in shared state, wherein the translation may enable the first entity to transition the cacheline state to shared, resulting in cacheline state orchestration between caches maintained by the first entity and caches maintained by the second entity. In a second example, the RPU may translate a CXL.cache H2D request comprising SnpInv to a CXL.cache D2H request comprising RdOwnNoData, requesting from the second entity to get exclusive ownership of a cacheline address, wherein the translation may invalidate the cacheline maintained by the second entity and may enable the first entity to acquire exclusive ownership and transition the cacheline state to exclusive, resulting in cacheline state orchestration between caches maintained by the first entity and caches maintained by the second entity.

The second entity may respond to the CXL.cache D2H request with a CXL.cache H2D response, which may communicate the cacheline state (e.g., via GO-S, GO-E) from the second entity to the RPU, wherein the RPU may translate the CXL.cache H2D response to a CXL.cache D2H response, which may communicate the cacheline state to the first entity. In some examples, the second entity may also respond to the CXL.cache D2H request with a CXL.cache H2D Data, such as when the second entity forwards modified data or when the CXL.cache D2H request comprises a read opcode, such as RdOwn, that return data. The RPU may translate the CXL.cache H2D Data to a CXL.cache D2H Data, and may send the CXL.cache D2H Data to the first entity. The RPU may perform further translations, such as opcode translations, e.g., translating between CXL.cache H2D request opcodes, such as snoops (e.g., SnpData, SnpInv, or SnpCur), and CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed. The RPU may further perform other translations, such as translations between CXL.cache messages, translations between reserved fields, and/or translations between reserved and non-reserved fields.

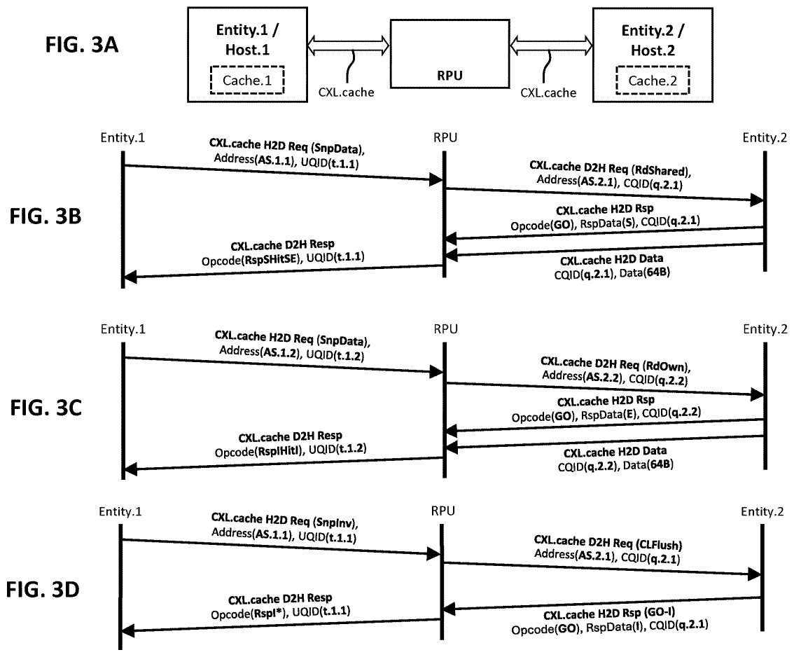

FIG. 3A illustrates an example of a system comprising an RPU that utilizes CXL.cache for communicating with a first entity (Entity.1), such as a first host (Host.1), which may include a first cache (Cache.1). The RPU may further utilize CXL.cache for communicating with a second entity (Entity.2), such as a second host (Host.2), which may include a second cache (Cache.2). The RPU may translate between CXL.cache transactions, or between CXL.cache messages, such as between CXL.cache H2D requests comprising snoops, and CXL.cache D2H requests comprising read opcodes, possibly enabling cacheline state orchestration between the first cache, and the second cache, wherein the cacheline state orchestration may be utilized, at least partly, for enabling memory sharing, such as cache-coherent memory sharing, between the first entity and the second entity.

FIG. 3B illustrates an example of a TFD demonstrating translations, performed by an RPU, between CXL.cache transactions, wherein the transactions may include messages such as requests, responses, and optionally data messages. A first entity (Entity.1), such as a first host (Host.1), may send to the RPU a CXL.cache H2D request comprising SnpData, Address(AS.1.1), and UQID(t.1.1), wherein the CXL.cache H2D request may indicate a snoop request from the first entity to the RPU for a cacheline that is intended to be cached in either shared or exclusive state at the first entity. The RPU may translate the CXL.cache H2D request to a CXL.cache D2H request comprising RdShared, Address(AS.2.1), and CQID(q.2.1), wherein the CXL.cache D2H request may indicate a read request from the RPU to the second entity for a cacheline to be cached in shared state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdShared with a CXL.cache H2D response comprising Opcode(GO), RspData(S), and CQID(q.2.1), and may further respond with a CXL.cache H2D Data comprising CQID(q.2.1) and Data(64B), wherein the Opcode(GO) and RspData(S) may indicate a GO-S shared state of the cacheline received by the RPU from the second entity. The RPU may translate the CXL.cache H2D response to a CXL.cache D2H response comprising Opcode(RspSHitSE) and UQID(t.1.1), wherein the Opcode(RspSHitSE) may indicate that the line was hit in a clean state and its current state is shared, possibly resulting in cacheline state orchestration between the first cache and the second cache, where both caches may store the cacheline in a shared state. The RPU may further perform other translations, such as translations between CXL.cache messages, translations between reserved fields, and/or translations between reserved and non-reserved fields. In some examples, the first entity may issue CXL.cache H2D requests, such as snoop requests, that may target a cache abstraction maintained by the RPU, wherein the RPU may expose a device cache over CXL.cache that may act as a proxy for caches included in the second entity, and wherein the RPU may affect caches in the second entity utilizing CXL.cache D2H requests that may cause cacheline state transitions in these caches.

FIG. 3C illustrates another example of a TFD demonstrating translations between CXL.cache transactions. A first entity (Entity.1), such as a first host (Host.1), may send to the RPU a CXL.cache H2D request comprising SnpData, Address(AS.1.2), and UQID(t.1.2), wherein the CXL.cache H2D request may indicate a snoop request from the first entity to the RPU for a cacheline that is intended to be cached in either shared or exclusive state at the first entity. The RPU may translate the CXL.cache H2D request to a CXL.cache D2H request comprising RdOwn, Address(AS.2.2), and CQID(q.2.2), wherein the CXL.cache D2H request may indicate a read request to the second entity for a cacheline to be cached in exclusive state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests. The second entity may respond to the CXL.cache D2H request comprising RdOwn with a CXL.cache H2D response comprising Opcode(GO), RspData(E), and CQID(q.2.2), and may further respond with a CXL.cache H2D Data comprising CQID(q.2.2) and Data(64B), wherein the Opcode(GO) and RspData(E) may indicate a GO-E exclusive state of the cacheline received by the RPU from the second entity. The RPU may translate the CXL.cache H2D response to a CXL.cache D2H response comprising Opcode(RspIHitI) and UQID(t.1.2), wherein the Opcode(RspIHitI) may indicate that the cacheline was not found in the caches, possibly resulting in cacheline state orchestration between the first cache and the second cache, wherein the first cache may transition the cacheline state to exclusive given that the second cache does not have that cacheline.

FIG. 3D illustrates an example of a TFD demonstrating translations, performed by an RPU, between CXL.cache transactions, wherein the transactions may include messages such as requests, responses, and optionally data messages. A first entity (Entity.1), such as a first host (Host.1), may send to the RPU a CXL.cache H2D request comprising SnpInv, Address(AS.1.1), and UQID(t.1.1), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising CLFlush, Address(AS.2.1), and CQID(q.2.1), wherein the CXL.cache D2H request may indicate a request from the RPU to the second entity to invalidate (flush) the cacheline. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests. The second entity may respond to the CXL.cache D2H request comprising CLFlush with a CXL.cache H2D response comprising Opcode(GO), RspData(I), and CQID(q.2.1), wherein the Opcode(GO) and RspData(I) may indicate a GO-I and may confirm the invalidation of the cacheline. The RPU may translate the CXL.cache H2D response to a CXL.cache D2H response comprising Opcode(RspI*) and UQID(t.1.1), wherein the Opcode(RspI*), such as RspIHitI, RspIHitSE, or RspIFwdM, may indicate that the line is no longer at the cache, possibly resulting in cacheline state orchestration between the first cache and the second cache, wherein the first cache may transition the cacheline state to exclusive, given that the second cache does not have that cacheline. In some examples, the first entity may issue CXL.cache H2D requests, such as snoop requests, that may target a cache abstraction maintained by the RPU, wherein the RPU may expose a device cache over CXL.cache that may act as a proxy for caches included in the second entity, and wherein the RPU may affect caches in the second entity utilizing CXL.cache D2H requests that may cause cacheline state transitions in these caches.

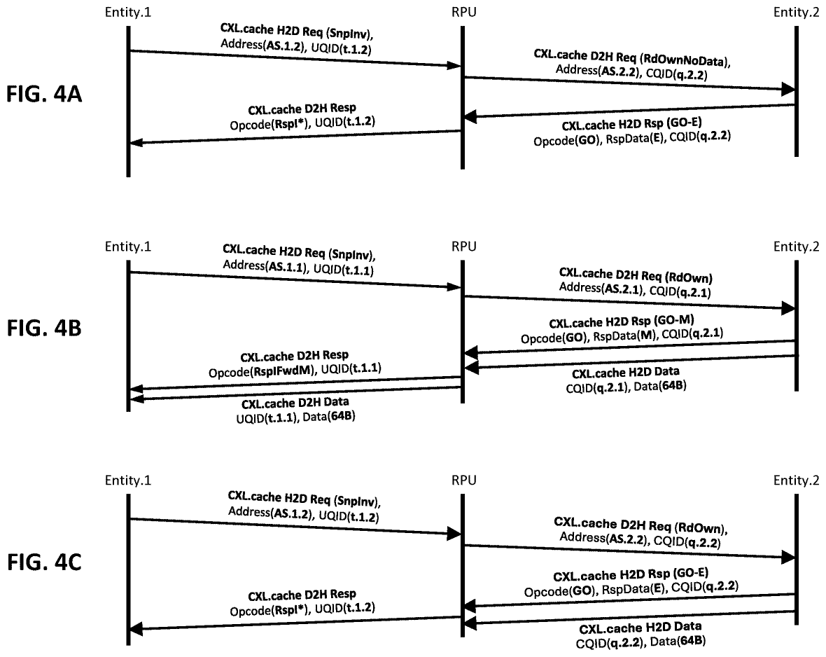

FIG. 4A illustrates an example of a TFD demonstrating translations performed by an RPU between CXL.cache transactions, wherein the transactions may include messages such as requests, responses, and optionally data messages. A first entity (Entity.1), such as a first host (Host.1), may send to the RPU a CXL.cache H2D request comprising SnpInv, Address(AS.1.2), and UQID(t.1.2), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising RdOwnNoData, Address(AS.2.2), and CQID(q.2.2), wherein the CXL.cache D2H request may indicate an intent to get exclusive ownership of the cacheline address indicated in the address field. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests. The second entity may respond to the CXL.cache D2H request comprising RdOwnNoData with a CXL.cache H2D response comprising Opcode(GO), RspData(E), and CQID(q.2.2), wherein the Opcode(GO) and RspData(E) may indicate a GO-E exclusive state of the cacheline received by the RPU from the second entity. The RPU may translate the CXL.cache H2D response to a CXL.cache D2H response comprising Opcode(RspI*) and UQID(t.1.2), wherein the Opcode(RspI*), such as RspIHitI, RspIHitSE, or RspIFwdM, may indicate that the line is no longer at the cache, possibly resulting in cacheline state orchestration between the first cache and the second cache, wherein the first cache may transition the cacheline state to exclusive given that the second cache does not have that cacheline.

FIG. 4B illustrates an example of a TFD demonstrating translations performed by an RPU between CXL.cache transactions, wherein the transactions may include messages such as requests, responses, and optionally data messages. A first entity (Entity.1), such as a first host (Host.1), may send to the RPU a CXL.cache H2D request comprising SnpInv, Address(AS.1.1), and UQID(t.1.1), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising RdOwn, Address(AS.2.1), and CQID(q.2.1), wherein the CXL.cache D2H request may indicate a read request from the RPU to the second entity for a cacheline to be cached in exclusive state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdOwn with a CXL.cache H2D response comprising Opcode(GO), RspData(M), and CQID(q.2.1), and may further respond with a CXL.cache H2D Data comprising CQID(q.2.1) and Data(64B), wherein the Opcode(GO) and RspData(M) may indicate a GO-M, and wherein the RPU may receive the cacheline in Modified state. The RPU may translate the CXL.cache H2D response to a CXL.cache D2H response comprising Opcode(RspIFwdM) and UQID(t.1.1), that may indicate to the first entity that the cacheline being snooped is now in I (Invalid) state after having hit the line in M (Modified) state, possibly resulting in cacheline state orchestration between the first cache and the second cache, wherein the first cache may transition the cacheline state to modified given that the second cache delivered a modified cacheline and was further invalidated.

FIG. 4C illustrates an example of a TFD demonstrating translations performed by an RPU between CXL.cache transactions. A first entity (Entity.1), such as a first host (Host.1), may send to the RPU a CXL.cache H2D request comprising SnpInv, Address(AS.1.2), and UQID(t.1.2), wherein the CXL.cache H2D request may indicate a snoop invalidate from the first entity to the RPU for a cacheline that is intended to be cached in exclusive state at the first entity. The RPU may translate the CXL.cache H2D request to a CXL.cache D2H request comprising RdOwn, Address(AS.2.2), and CQID(q.2.2), wherein the CXL.cache D2H request may indicate a read request from the RPU to the second entity for a cacheline to be cached in exclusive state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdOwn with a CXL.cache H2D response comprising Opcode(GO), RspData(E), and CQID(q.2.2), and may further respond with a CXL.cache H2D Data comprising CQID(q.2.2) and Data(64B), wherein the Opcode(GO) and RspData(E) may indicate a GO-E exclusive state of the cacheline received by the RPU from the second entity. The RPU may translate the CXL.cache H2D response to a CXL.cache D2H response comprising Opcode(RspI*) and UQID(t.1.2), wherein the Opcode(RspI*), such as RspIHitI, RspIHitSE, or RspIFwdM, may indicate that the line is no longer at the cache, possibly resulting in cacheline state orchestration between the first cache and the second cache, wherein the first cache may transition the cacheline state to exclusive given that the second cache does not have that cacheline.

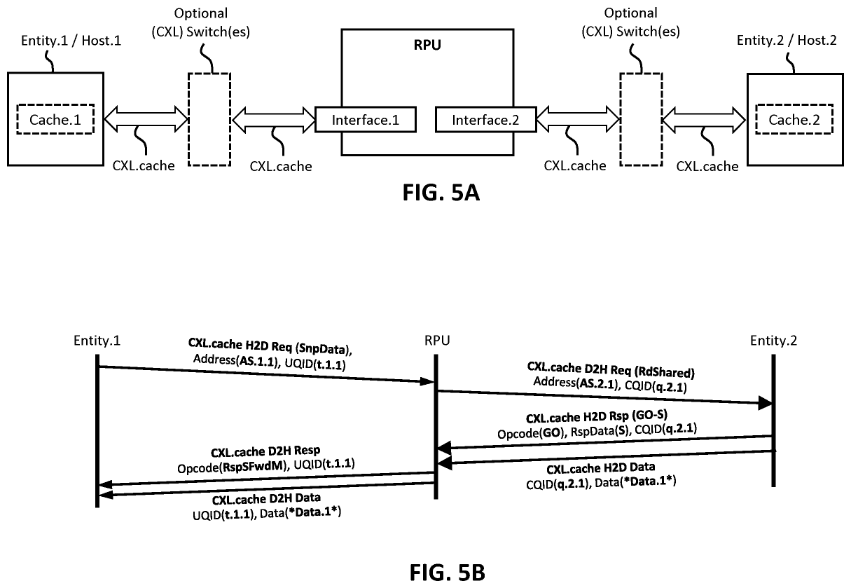

FIG. 5A illustrates an example of a system comprising an RPU that may utilize CXL.cache for communicating with a first entity (Entity.1), such as a first host (Host.1), which may include a first cache (Cache.1). The RPU may further utilize CXL.cache for communicating with a second entity (Entity.2), such as a second host (Host.2), which may include a second cache (Cache.2). The RPU may translate between CXL.cache transactions, and may further translate between CXL.cache messages, such as between CXL.cache H2D requests comprising snoop (e.g., SnpData) opcodes, and CXL.cache D2H requests comprising read opcodes (e.g., RdShared), possibly enabling cacheline state orchestration between the first cache and the second cache, such as cross coordination of cacheline states, wherein the cacheline state orchestration may be utilized, at least partly, for enabling memory sharing, such as cache-coherent memory sharing, between the first entity and the second entity. Optionally, the RPU may be implemented in an IC package having high-speed differential I/O balls positioned according to a ball grid array layout defined by the PCIe 5.0, 6.0, or 7.0 Retimer Supplemental Features and Standard BGA Footprint Specification. The RPU may extract physical addresses within messages received via the first interface, wherein these addresses may correspond to a first HPA space utilized by the first entity; translate these addresses; and generate messages carrying the translated physical addresses for transmission via the second interface; wherein these translated addresses may correspond to a second HPA space utilized by the second entity. Optional CXL switch(es) may be positioned between the first interface and the first entity, and/or between the second interface and the second entity.

FIG. 5B illustrates an example of a TFD demonstrating translations performed by an RPU between CXL.cache transactions, wherein the transactions may include messages such as requests, responses, and optionally data messages. A first entity (Entity.1), such as a first host (Host.1), may send to the RPU a CXL.cache H2D request comprising SnpData, Address(AS.1.1), and UQID(t.1.1), wherein the CXL.cache H2D request may indicate a snoop from the first entity to the RPU for a cacheline that is intended to be cached in either shared or exclusive state at the first entity (the exclusive state may be cached at the first entity only if all devices respond with RspI*). The RPU may translate the CXL.cache H2D request to a CXL.cache D2H request comprising RdShared, Address(AS.2.1), and CQID(q.2.1), wherein the CXL.cache D2H request may indicate a read request from the RPU to the second entity for a cacheline to be cached in shared state. The RPU may provide intent-based translations, such as by identifying intents in CXL.cache H2D requests received from the first entity, such as intents to acquire a shared state or an exclusive state for a cacheline, and utilizing the identified intents for translating between the CXL.cache H2D requests and the CXL.cache D2H requests.

The second entity may respond to the CXL.cache D2H request comprising RdShared with a CXL.cache H2D response comprising Opcode(GO), RspData(S), and CQID(q.2.1), and may further respond with a CXL.cache H2D Data comprising CQID(q.2.1) and Data(*Data.1*), wherein the Opcode(GO) and RspData(S) may indicate a GO-S, and wherein the RPU may receive the cacheline in Shared state. The RPU may translate the CXL.cache H2D response to a CXL.cache D2H response comprising Opcode(RspSFwdM) and UQID(t.1.1), that may indicate to the first entity that the cacheline being snooped is now in S (Shared) state after having hit the line in M (Modified) state, possibly enabling an explicit delivery of data from the RPU to the first entity. The RPU may further translate the CXL.cache H2D Data to a CXL.cache D2H Data comprising UQID(t.1.1) and Data(*Data.1*). The RPU may utilize *FwdM such as RspSFwdM when translating the CXL.cache H2D response to the CXL.cache D2H response, wherein the *FwdM may enable data transfer from the RPU to the first entity utilizing the CXL.cache D2H Data, irrespective of the actual GO-S response from the second entity. Such translation may enable delivery of a cacheline data in shared state from the second entity to the first entity via the RPU, a path that is not supported by the CXL specification.

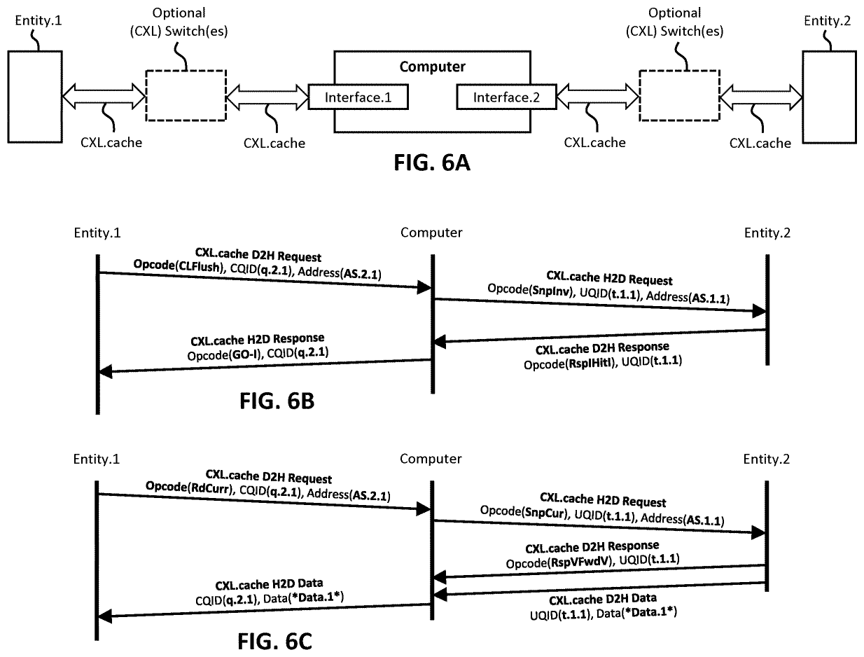

FIG. 6A illustrates an example of a system comprising a computer coupled between a first interface (Interface.1) that may communicate according to CXL.cache with a first entity (Entity.1), and a second interface (Interface.2) that may communicate according to CXL.cache with a second entity (Entity.2), possibly enabling the first entity to communicate with the second entity, such as via affecting cacheline state transitions in the second entity. The computer may extract physical addresses within messages received via the first interface, wherein these addresses may refer to a first physical address space utilized by the first entity; translate these addresses; and generate messages carrying the translated physical addresses for transmission via the second interface; wherein these translated addresses may correspond to a second physical address space utilized by the second entity. In some examples, the first address space and the second address space may be associated with a single HPA space. Optional CXL switch(es) may be positioned between the first interface and the first entity, and/or between the second interface and the second entity. In some examples, the computer may be implemented as a chiplet, or as a functional unit within an IC such as an accelerator, a processor, or a switch. In other examples, the computer may be implemented as a discrete component, such as in an IC package having high-speed differential I/O balls positioned according to a ball grid array layout defined by a PCIe Retimer Supplemental Features and Standard BGA Footprint Specification.

FIG. 6B illustrates an example of a TFD demonstrating translations, such as intent-based translations, performed by a computer, between first CXL.cache messages received from a first entity (Entity.1), such as a first device (Device.1), and second CXL.cache messages sent to a second entity (Entity.2), such as a second device (Device.2), possibly enabling the first entity to maintain, at least partly, cacheline state orchestration, memory coherency, and/or memory sharing with the second entity, such as by enabling the first entity to invalidate cachelines in the second entity. The first entity may initiate a first CXL.cache transaction that may include a CXL.cache D2H request comprising Opcode(CLFlush), CQID(q.2.1), and Address(AS.2.1). The computer may translate the first CXL.cache transaction to a second CXL.cache transaction that may include a CXL.cache H2D request comprising Opcode(SnpInv), UQID(t.1.1), and Address(AS.1.1), and may send the CXL.cache H2D request to the second entity. Upon receiving a response from the second entity, which may include a CXL.cache D2H response comprising Opcode(RspIHitI), and UQID(t.1.1), the computer may translate the CXL.cache D2H response to a CXL.cache H2D response comprising Opcode(GO-I) and CQID(q.2.1).

The computer may perform further translations, such as opcode translations, e.g., translating between CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed, and CXL.cache H2D request opcodes, such as Snp* (e.g., SnpData, SnpInv, and SnpCur). The computer may further perform other translations, such as field translations between messages conforming to the first CXL.cache transaction and messages conforming to the second CXL.cache transaction, such as translations between UQIDs and CQIDs, translations between reserved fields, and/or translations between reserved and non-reserved fields.

FIG. 6C illustrates an example of a TFD demonstrating translations performed by a computer between CXL.cache transactions, wherein the transactions may include messages such as requests, responses, and optionally data messages. A first entity (Entity.1), such as a first device (Device.1), may send to the computer a CXL.cache D2H request comprising Opcode(RdCurr), CQID(q.2.1), and Address(AS.2.1), wherein the CXL.cache D2H request may indicate a read request from the first entity to the computer for the current version of a cacheline. The computer may translate the CXL.cache D2H request to a CXL.cache H2D request comprising Opcode(SnpCur), UQID(t.1.1), and Address(AS.1.1), and may send the CXL.cache H2D request to the second entity, wherein the CXL.cache H2D request may indicate a snoop request from the computer to the second entity for the current version of the cacheline. The computer may provide intent-based translations, such as by identifying intents in CXL.cache D2H requests received from the first entity, such as intents to get the current version of a cacheline, and utilizing the identified intents for translating between the CXL.cache D2H requests and the CXL.cache H2D requests. The second entity may respond to the CXL.cache H2D request comprising the SnpCur with a CXL.cache D2H response comprising Opcode(RspVFwdV) and UQID(t.1.1), and with a CXL.cache D2H Data comprising UQID(t.1.1) and Data(*Data.1*). The computer may translate the CXL.cache D2H Data to a CXL.cache H2D Data comprising CQID(q.2.1) and Data(*Data.1*), and may send the CXL.cache H2D Data to the first entity.

In various implementations, a method for translating between Compute Express Link (CXL) messages, comprising: receiving a first CXL message from a first entity; identifying a cacheline state intent based on at least one of a first opcode, a Snoop Type (SnpType), a Metadata Field (MetaField), or a Metadata Value (MetaValue) of the first CXL message, wherein the cacheline state intent pertains to a cacheline address specified in the first CXL message; translating the first CXL message to a second CXL message comprising a second opcode selected based at least in part on the identified cacheline state intent, wherein the second opcode differs from the first opcode; and sending the second CXL message to a second entity. The first entity may include a first host, the second entity may include a second host, and the entities may communicate using CXL. The cacheline state intent may indicate a desired cache state, such as Modified, Exclusive, Shared, or Invalid (MESI) that an entity seeks to acquire or affect for the cacheline address. For CXL.cache messages, the intent may be derived from the opcode, such as SnpData, SnpInv, or SnpCur for H2D requests, or RdOwn, RdShared, or CLFlush for D2H requests. For CXL.mem messages, the intent may be derived from the opcode, the SnpType, or a combination thereof, wherein the SnpType may indicate No-Op, SnpInv, or SnpData snoop requirements. By identifying the intent from the incoming message, the translation logic may select an appropriate opcode for the outgoing message that achieves the desired cache state transition, wherein the selected opcode differs from the incoming opcode due to differences in protocol direction or protocol type. The method may be performed by an RPU, a semiconductor device, or other computing apparatus positioned between the first entity and the second entity.

In some implementations of the method, the first CXL message comprises a CXL.cache Host-to-Device (H2D) request, and the first opcode is selected from SnpData, SnpInv, or SnpCur; and wherein the second CXL message comprises a CXL.cache Device-to-Host (D2H) request, and the second opcode is selected from RdOwn, RdShared, RdOwnNoData, RdCurr, RdAny, or CLFlush. The translation from CXL.cache H2D request to CXL.cache D2H request may enable inter-host communication via a device positioned between the hosts, wherein the device may expose CXL.cache interfaces to each host. H2D requests comprise snoops, such as SnpData, SnpInv, or SnpCur that indicate different cacheline state intents, while D2H requests comprise read or cache operation opcodes such as RdOwn, RdShared, RdOwnNoData, RdCurr, or CLFlush that achieve the corresponding cache state transitions.

In some implementations of the method, the first opcode comprises SnpData, the second opcode is selected from RdShared or RdOwn, whereby RdShared is selected to enable both the first entity and the second entity to retain cached copies of the cacheline in shared state, and whereby RdOwn is selected to cause the second entity to relinquish ownership and provide cacheline data for exclusive state acquisition by the first entity. SnpData indicates a snoop request for a cacheline that is intended to be cached in either shared or exclusive state at the first entity. The translation logic may determine whether shared or exclusive state is desired based on additional context, system configuration, or bias state information. RdShared requests a cacheline to be cached in shared state, enabling concurrent caching by multiple entities. RdOwn requests a cacheline to be cached in exclusive or modified state, causing the second entity to relinquish ownership and provide cacheline data to the translation logic for forwarding to the first entity.

In some implementations of the method, the first opcode comprises SnpInv, the second opcode is selected from CLFlush, RdOwnNoData, or RdOwn, whereby CLFlush is selected to invalidate the cacheline at the second entity without data return, whereby RdOwnNoData is selected to acquire exclusive ownership of the cacheline without data return, and whereby RdOwn is selected to acquire exclusive ownership of the cacheline with cacheline data return from the second entity. SnpInv indicates a snoop request that invalidates the cacheline at the receiving device and signals intent to acquire exclusive state at the first entity. The translation logic may determine whether data transfer is required based on data caching policies associated with the translation logic, the first entity's cache state, pending write operations, or other context. CLFlush requests flushing of the cacheline at the second entity, which may include data return if the cacheline is in Modified state, and may be selected when invalidation of the second entity's cached copy is the primary intent. RdOwnNoData requests exclusive ownership without data return and may be selected when the first entity will overwrite the entire cacheline. RdOwn requests exclusive ownership with data return and may be selected when the first entity requires current cacheline contents before modification.

In some implementations of the method, the first opcode comprises SnpCur, the second opcode comprises RdCurr, and whereby the translation enables the first entity to obtain current cacheline data from the second entity without modifying cache states at either the first entity or the second entity. SnpCur indicates a snoop request to obtain the current version of the cacheline without requiring change of cache states in the hierarchy. RdCurr indicates a read request to get the most current data without changing the existing state in any cache. The translation from SnpCur to RdCurr may enable the first entity to read current data from the second entity without affecting cache coherency states, which may be useful for I/O data operations, such as I/O-coherent reads (e.g., I/O-coherency mode), monitoring, debugging, or speculative operations.

In some implementations of the method, the first CXL message comprises a CXL.cache Device-to-Host (D2H) request, and the first opcode is selected from RdOwn, RdOwnNoData, RdShared, RdCurr, or CLFlush; and wherein the second CXL message comprises a CXL.cache Host-to-Device (H2D) request, and the second opcode is selected from SnpData, SnpInv, or SnpCur based on the cacheline state intent indicated by the first opcode. The translation from CXL.cache D2H request to CXL.cache H2D request may enable inter-device communication, wherein a read request or cache operation from one device is translated to a snoop request targeting another device. The translation logic may map RdShared to SnpData when the intent is to acquire shared state with possible data return, may map RdOwn, CLFlush, or RdOwnNoData to SnpInv when the intent is exclusive ownership acquisition or invalidation, and may map RdCurr to SnpCur when the intent is non-state-changing data access.

In some implementations of the method, the first CXL message comprises a CXL.mem Master-to-Subordinate (M2S) request; and wherein the second CXL message comprises a CXL.cache Device-to-Host (D2H) request, and the second opcode is selected from RdOwn, RdOwnNoData, RdShared, RdCurr, RdAny, or CLFlush. The translation from CXL.mem M2S request to CXL.cache D2H request may enable memory access operations from a first entity utilizing CXL.mem to be translated into cache coherency operations targeting a second entity utilizing CXL.cache. A set of fields in the M2S request, which may include SnpType, MetaField, or MetaValue, may indicate the cacheline state intent, which may be utilized to select an appropriate D2H request opcode. The translation logic may bridge between the CXL.mem and CXL.cache domains while preserving the intent of the memory operation.

In some implementations of the method, the CXL.mem M2S request comprises the SnpType and the MetaValue, the CXL.cache D2H request comprises the second opcode, and the second opcode is selected based on the SnpType and the MetaValue. The combination of SnpType and MetaValue in the M2S request may provide finer-grained indication of the cacheline state intent than SnpType alone. For example, an M2S request with SnpType indicating SnpData and MetaValue indicating Shared(S) may result in selection of RdShared. The translation logic may utilize both fields to determine the appropriate D2H request opcode.

In some implementations of the method, the CXL.mem M2S request comprises the SnpType that comprises SnpCur, and the CXL.cache D2H request comprises the second opcode that comprises RdCurr. The SnpCur to RdCurr translation may enable requests for a non-cacheable but current value of a cacheline, such as for I/O-coherent reads. The M2S request may further include MetaValue indicating Invalid (I) to indicate that the requester will not cache the line. RdCurr may retrieve the most current data from the second entity without causing state transitions in any cache. Upon receiving a response, such as a CXL.cache H2D Data, the computer may translate the response to a CXL.mem S2M DRS comprising MemData and a CXL.mem S2M NDR comprising Cmp.

In some implementations of the method, the CXL.mem M2S request comprises the SnpType that comprises SnpData, and the CXL.cache D2H request comprises the second opcode that comprises RdShared. The SnpData to RdShared translation may enable the requester to acquire a cacheline in shared state, permitting concurrent caching by multiple entities. The M2S request may further include MetaValue indicating Shared (S) to indicate the host may have at most a shared copy of the line. Upon receiving a response from the second entity, which may include a CXL.cache H2D response comprising GO-S, the computer may translate the response to a CXL.mem S2M NDR comprising Cmp-S, providing an indication for Shared state.

In some implementations of the method, the CXL.mem M2S request comprises the SnpType that comprises SnpInv, and the CXL.cache D2H request comprises the second opcode that comprises RdOwn. The SnpInv to RdOwn translation may enable the requester to acquire exclusive ownership of a cacheline, causing the second entity to relinquish any cached copies. The M2S request may further include MetaValue indicating Any (A) to indicate the host may have a shared, exclusive, or modified copy of the line. Upon receiving a response from the second entity, which may include a CXL.cache H2D response comprising GO-E or GO-M, the computer may translate the response to a CXL.mem S2M NDR comprising Cmp-E, providing an indication for Exclusive ownership.

In some implementations of the method, the second opcode is selected based on the SnpType as follows: RdOwn or RdOwnNoData is selected when the SnpType indicates SnpInv for exclusive ownership acquisition with or without data return respectively, CLFlush is selected when the SnpType indicates SnpInv for cacheline invalidation without ownership acquisition, and RdShared is selected when the SnpType indicates SnpData for shared state acquisition. The SnpType in the M2S request may indicate SnpInv for invalidation snoops or SnpData for data snoops. When SnpType indicates SnpInv, the translation logic may select RdOwn if data return is required, RdOwnNoData if exclusive ownership without data is sufficient, or CLFlush if invalidation is needed. When SnpType indicates SnpData, the translation logic may select RdShared to acquire the cacheline in shared state. This mapping enables CXL.mem operations to be properly coordinated with CXL.cache coherency.

In some implementations of the method, the first CXL message comprises a CXL.cache Device-to-Host (D2H) request, and the first opcode is selected from RdOwn, RdShared, RdCurr, RdAny, or CLFlush; and wherein the second CXL message comprises a CXL.mem Master-to-Subordinate (M2S) request comprising MemRd* and a second SnpType. The translation from CXL.cache D2H request to CXL.mem M2S request may enable cache coherency operations from a first entity utilizing CXL.cache to be translated into memory access operations targeting a second entity utilizing CXL.mem. The D2H request opcode may indicate the cacheline state intent, which may be utilized to select an appropriate SnpType value for the M2S request. For example, a D2H request comprising RdOwn may be translated to an M2S request comprising MemRd with SnpType set to SnpInv, while a D2H request comprising RdShared may be translated to an M2S request comprising SnpType set to SnpData.

In some implementations of the method, the CXL.cache D2H request comprises the first opcode, and the second SnpType is set based on the cacheline state intent indicated by the first opcode. The translation logic may analyze the first opcode to determine the cacheline state intent and set the second SnpType accordingly. For example, RdOwn may indicate intent to acquire exclusive state, resulting in SnpType being set to SnpInv, while RdShared may indicate intent to acquire shared state, resulting in SnpType being set to SnpData. This intent-based translation may enable CXL.cache operations to be properly coordinated with CXL.mem coherency semantics.

In some implementations of the method, the CXL.cache D2H request comprises the first opcode that comprises RdCurr, and the CXL.mem M2S request comprises the second SnpType that comprises SnpCur. The RdCurr to SnpCur translation may enable requests for a non-cacheable but current value of a cacheline via the CXL.mem interface. The M2S request may further include MetaField indicating MS0 and MetaValue indicating Invalid (I) to indicate that the requester may not cache the line. Upon receiving a response from the second entity, which may include a CXL.mem S2M DRS comprising MemData and a CXL.mem S2M NDR comprising Cmp, the computer may translate the response to a CXL.cache H2D Data for delivery to the first entity.

In some implementations of the method, the CXL.cache D2H request comprises the first opcode comprising RdShared, and the CXL.mem M2S request comprises the second SnpType comprising SnpData. The RdShared to SnpData translation may enable the CXL.cache requester to acquire a cacheline in shared state via the CXL.mem interface. The M2S request may further include MetaField indicating MS0 and MetaValue indicating Shared (S). Upon receiving a response from the second entity, which may include a CXL.mem S2M NDR comprising Cmp-S providing an indication for Shared state, the computer may translate the response to a CXL.cache H2D response comprising GO-S and a CXL.cache H2D Data comprising the cacheline data.

In some implementations of the method, the CXL.cache D2H request comprises the first opcode comprising RdOwn, and the CXL.mem M2S request comprises the second SnpType comprising SnpInv. The RdOwn to SnpInv translation may enable the CXL.cache requester to acquire exclusive ownership of a cacheline via the CXL.mem interface, typically receiving the cacheline in Exclusive or Modified state. The M2S request may further include MetaField indicating MS0 and MetaValue indicating Any (A). Upon receiving a response from the second entity, which may include a CXL.mem S2M NDR comprising Cmp-E providing an indication for Exclusive ownership, the computer may translate the response to a CXL.cache H2D response comprising GO-E and a CXL.cache H2D Data comprising the cacheline data.

In some implementations, the method further comprises maintaining a mapping between cacheline state intents and corresponding opcodes for the second CXL message, wherein the cacheline state intent indicates whether the first entity seeks to acquire a cache state that permits concurrent caching by other entities, a cache state that requires exclusive ownership, or invalidation of the cacheline at the second entity; and wherein the translating comprises utilizing the mapping to select the second opcode to achieve the indicated cache state transition at the second entity. The mapping may be implemented as a lookup table, combinational logic, or programmable translation function that associates each cacheline state intent with one or more candidate opcodes for the second CXL message. The cacheline state intent may be categorized as shared state acquisition (permitting concurrent caching), exclusive state acquisition (requiring the second entity to relinquish cached copies), or invalidation (causing the second entity to discard cached copies without ownership transfer). The translation logic may utilize the mapping to select an opcode that achieves the desired cache state transition while considering additional context such as whether data return is required.

In some implementations, the method further comprises receiving, from the second entity, a response message indicating a cache state based on at least one of a third opcode or cacheline data included in the response message; translating the response message to a translated response message comprising a fourth opcode selected based on the cache state indicated by the response message; wherein the fourth opcode differs from the third opcode; and sending the translated response message to the first entity. The response message may include a CXL.cache H2D response such as GO-M, GO-E, GO-S, or GO-I indicating Modified, Exclusive, Shared, or Invalid (MESI) cacheline state, respectively. The translation logic may select an opcode for the translated response message, such as a CXL.cache D2H response comprising RspIHitI, RspSHitSE, RspIFwdM, or similar, which communicates the resulting cacheline state to the first entity. The translation may utilize a previously stored identifier mapping to correctly route the response back to the originating transaction.

In some implementations of the method, the cache state indicated by the response message indicates shared state, exclusive state, or modified state; and wherein the fourth opcode is selected as follows: RspSHitSE is selected when the third opcode indicates GO-S for shared state to communicate that the cacheline is available in shared state, RspIHitI or RspIHitSE is selected when the third opcode indicates GO-E for exclusive state to communicate that the cacheline is no longer present in the cache abstraction, and RspIFwdM is selected when the third opcode indicates GO-M for modified state to communicate that modified data is being forwarded. The GO-S indication signifies that the second entity is providing the cacheline in shared state, permitting concurrent caching by multiple entities, and the translation logic may select RspSHitSE to indicate to the first entity that the cacheline was hit in a clean state and its current state is shared. The GO-E indication signifies that the second entity has granted exclusive ownership, and the translation logic may select RspIHitI or RspIHitSE to indicate that the cacheline is no longer present in the cache abstraction. The GO-M indication signifies that the second entity previously held the cacheline in modified state and is relinquishing ownership along with modified data, and the translation logic may select RspIFwdM to indicate that modified data is being forwarded.

In some implementations, the method further comprises exposing a cache abstraction to the first entity, wherein the cache abstraction appears to the first entity as a device cache accessible via CXL transactions, whereby the cache abstraction acts as a proxy for cache resources maintained by the second entity, and wherein the first entity issues CXL messages targeting the cache abstraction that are translated to outgoing CXL messages affecting actual caches in the second entity based on the identified cacheline state intent. The cache abstraction may be exposed as a CXL Type-1 or CXL Type-2 device interface that the first entity may enumerate and interact with as a local device cache. The first entity may issue CXL messages, such as snoop requests, that target the cache abstraction, wherein the translation logic may identify the cacheline state intent from these messages and translate them to appropriate outgoing CXL messages that affect actual caches in the second entity. This proxy arrangement may enable cache coherency operations between entities that cannot communicate directly due to protocol direction constraints or address space differences.

In some implementations of the method, the translating enables cacheline state orchestration between a first cache maintained by the first entity and a second cache maintained by the second entity; wherein the cacheline state orchestration enables the first entity to affect cache states in the second cache through the translated second CXL message, and indicates transitions between at least two states selected from Modified, Exclusive, Shared, or Invalid (MESI) according to a cache coherency protocol. Cacheline state orchestration may encompass coordinated transitions between various cache states according to MESI or similar cache coherency protocols. The translation logic may enable the first entity to cause invalidation, downgrade, or ownership transfer of cachelines in the second entity's cache hierarchy by translating the first entity's CXL messages into appropriate CXL messages for the second entity.

In some implementations of the method, the cacheline state orchestration further enables cache-coherent memory sharing between the first entity and the second entity by allowing both entities to access shared memory resources while maintaining data consistency. The translation logic may track pending transactions and coordinate state transitions to maintain coherency invariants across both cache hierarchies, enabling cache-coherent memory sharing in disaggregated memory systems, multi-GPU clusters, heterogeneous computing platforms, or other multi-entity architectures.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: a computer configured to: receive, from a first entity, a first Compute Express Link (CXL) message; identify a cacheline state intent based on at least one of a first opcode, a Snoop Type (SnpType), a Metadata Field (MetaField), or a Metadata Value (MetaValue) of the first CXL message, wherein the cacheline state intent pertains to a cacheline address specified in the first CXL message; translate the first CXL message to a second CXL message comprising a second opcode selected based at least in part on the identified cacheline state intent, wherein the second opcode differs from the first opcode; and send the second CXL message to a second entity. The computer may include processing logic, memory for storing translation tables and transaction state, and interface controllers for managing CXL communications with each entity. The system may be implemented as a standalone device, integrated into a larger semiconductor component, or distributed across multiple components within a computing platform. The translation capabilities may enable diverse system architectures such as disaggregated memory systems, multi-host configurations, multi-GPU clusters, or heterogeneous computing platforms.

In some implementations of the system, the computer is included within a semiconductor device comprising a first CXL.cache interface configured to receive CXL.cache Host-to-Device (H2D) requests from the first entity and a second CXL.cache interface configured to send CXL.cache Device-to-Host (D2H) requests to the second entity; wherein the semiconductor device is positioned between the first entity and the second entity to enable inter-entity communication based on translating snoops received from the first entity to read or cache operation opcodes sent to the second entity based on the identified cacheline state intent. The semiconductor device may be implemented as an ASIC, FPGA, SoC, RPU, or other integrated circuit technology. The first CXL.cache interface may receive H2D requests comprising snoops such as SnpData, SnpInv, or SnpCur, and the second CXL.cache interface may send D2H requests comprising opcodes such as RdOwn, RdShared, RdOwnNoData, or CLFlush selected based on the cacheline state intent. Each interface may include physical layer circuits, link layer controllers, and protocol layer engines specifically designed for CXL.cache communication.

In some implementations of the system, the first CXL message comprises a CXL.mem Master-to-Subordinate (M2S) request, the second CXL message comprises a CXL.cache Device-to-Host (D2H) request, and wherein the computer is configured to bridge between CXL.mem and CXL.cache by identifying the cacheline state intent, based on at least one of the SnpType or the first opcode, and selecting an opcode for the D2H request that achieves a corresponding cache state transition at the second entity. The computer may be configured to bridge between CXL.mem and CXL.cache domains, enabling memory access operations from entities utilizing CXL.mem to be coordinated with cache coherency operations targeting entities utilizing CXL.cache. The system may analyze SnpType values to determine whether SnpInv or SnpData is indicated, and may select corresponding D2H request opcodes such as RdOwn, RdOwnNoData, CLFlush, or RdShared to achieve the intended cache state transition. This bridging capability may enable heterogeneous systems where different entities utilize different CXL protocols.

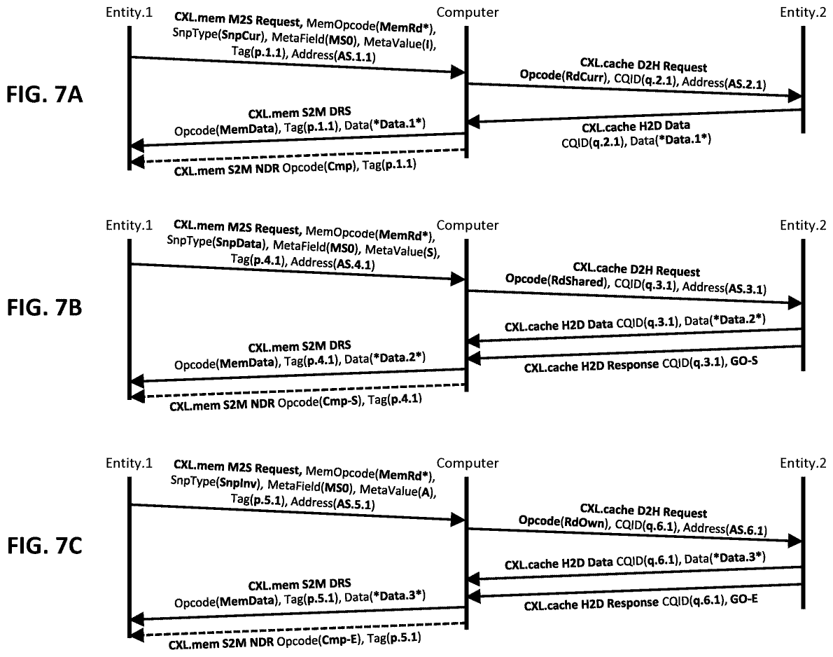

FIG. 7A illustrates an example of a TFD demonstrating intent-based translations between CXL.mem messages received from a first entity (Entity.1), such as a first host (Host.1), and CXL.cache messages sent to a second entity (Entity.2), such as a second host (Host.2), possibly enabling the first entity to access resources mapped to an address space utilized by the second entity. The first entity may initiate a CXL.mem transaction that may include a CXL.mem M2S request comprising MemOpcode(MemRd*), SnpType(SnpCur), MetaField(MS0), MetaValue(I), Tag(p.1.1), and Address(AS.1.1), wherein the CXL.mem M2S request may indicate an intent to request a non-cacheable but current value of a cacheline. The computer may perform intent-based translation between the CXL.mem domain and the CXL.cache domain, by translating the CXL.mem transaction to a CXL.cache transaction that may include a CXL.cache D2H request comprising Opcode(RdCurr), CQID(q.2.1), and Address(AS.2.1), wherein the CXL.cache D2H request may indicate a corresponding intent to request a non-cacheable but current value of a cacheline by utilizing RdCurr. The computer may send the CXL.cache D2H request to the second entity. Upon receiving a response from the second entity, which may include a CXL.cache H2D Data comprising CQID(q.2.1) and Data(*Data.1*), the computer may translate the CXL.cache H2D Data to a CXL.mem S2M DRS comprising Opcode(MemData), Tag(p.1.1), and Data(*Data.1*), and may further translate the CXL.cache H2D Data to a CXL.mem S2M NDR comprising Opcode(Cmp) and Tag(p.1.1). The computer may perform further translations, such as address translations, translations between CXL.mem Tags and CXL.cache CQIDs, translations between reserved fields, and/or opcode translations, e.g., translating between CXL.mem M2S request opcodes, such as MemRd*, and CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed.

FIG. 7B illustrates an example of a TFD demonstrating intent-based translations wherein a first entity may initiate a CXL.mem transaction that may include a CXL.mem M2S request comprising MemOpcode(MemRd*), SnpType(SnpData), MetaField(MS0), MetaValue(S), Tag(p.4.1), and Address(AS.4.1), wherein the CXL.mem M2S request may indicate an intent to request a shared copy of the cacheline. A computer may perform intent-based translation between the CXL.mem domain and the CXL.cache domain, and may translate the CXL.mem transaction to a CXL.cache transaction that may include a CXL.cache D2H request comprising Opcode(RdShared), CQID(q.3.1), and Address(AS.3.1), wherein the CXL.cache D2H request may indicate a corresponding intent to request a cacheline to be cached in shared state by utilizing RdShared. The computer may send the CXL.cache D2H request to a second entity. Upon receiving a response from the second entity, which may include a CXL.cache H2D Data comprising CQID(q.3.1) and Data(*Data.2*), and may further include CXL.cache H2D response comprising CQID(q.3.1) and GO-S, the computer may translate the CXL.cache H2D Data to a CXL.mem S2M DRS comprising Opcode(MemData), Tag(p.4.1), and Data(*Data.2*), and may further translate the CXL.cache H2D response to a CXL.mem S2M NDR comprising Opcode(Cmp-S) and Tag(p.4.1), wherein Cmp-S may provide an indication from the DCOH to the first entity for Shared state.

FIG. 7C illustrates an example of a TFD demonstrating intent-based translations wherein a first entity may initiate a CXL.mem transaction that may include a CXL.mem M2S request comprising MemOpcode(MemRd*), SnpType(SnpInv), MetaField(MS0), MetaValue(A), Tag(p.5.1), and Address(AS.5.1), wherein the CXL.mem M2S request may indicate an intent to request an exclusive copy of the cacheline. A computer may perform intent-based translation between the CXL.mem domain and the CXL.cache domain, and may translate the CXL.mem transaction to a CXL.cache transaction that may include a CXL.cache D2H request comprising Opcode(RdOwn), CQID(q.6.1), and Address(AS.6.1), wherein the CXL.cache D2H request may indicate a corresponding intent to request a cacheline to be cached in any writeable state by utilizing RdOwn, typically receiving the cacheline in Exclusive (GO-E) or Modified (GO-M) state, and wherein the computer may send the CXL.cache D2H request to a second entity. Upon receiving a response from the second entity, which may include a CXL.cache H2D Data comprising CQID(q.6.1) and Data(*Data.3*), and may further include a CXL.cache H2D response comprising CQID(q.6.1) and GO-E, the computer may translate the CXL.cache H2D Data to a CXL.mem S2M DRS comprising Opcode(MemData), Tag(p.5.1), and Data(*Data.3*), and may further translate the CXL.cache H2D response to a CXL.mem S2M NDR comprising Opcode(Cmp-E) and Tag(p.5.1), wherein Cmp-E may provide an indication from the DCOH to the first entity for Exclusive ownership.

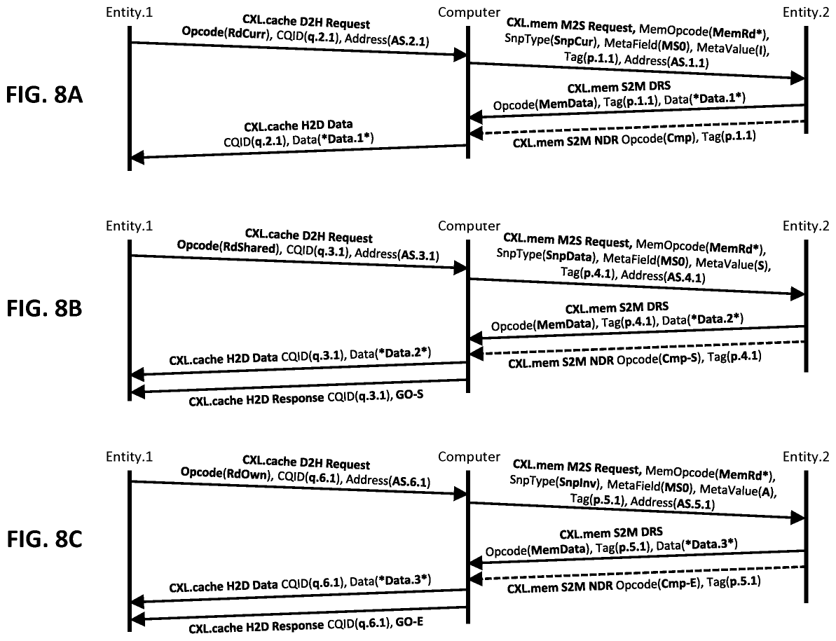

FIG. 8A illustrates an example of a TFD demonstrating intent-based translations between CXL.cache messages received from a first entity (Entity.1), such as a first device (Device.1), and CXL.mem messages sent to a second entity (Entity.2), such as a second device (Device.2), possibly enabling the first entity to access resources mapped to an address space utilized by the second entity. The first entity may initiate a CXL.cache transaction that may include a CXL.cache D2H request comprising Opcode(RdCurr), CQID(q.2.1), and Address(AS.2.1), wherein the CXL.cache D2H request may indicate an intent to request a non-cacheable but current value of a cacheline by utilizing RdCurr.

The computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpCur), MetaField(MS0), MetaValue(I), Tag(p.1.1), and Address(AS.1.1). The CXL.mem M2S request may indicate a corresponding intent to request a non-cacheable but current value of a cacheline. The computer may send the CXL.mem M2S request to the second entity. Upon receiving a response from the second entity, which may include a CXL.mem S2M DRS comprising Opcode(MemData), Tag(p.1.1), and Data(*Data.1*), and may further include a CXL.mem S2M NDR comprising Opcode(Cmp) and Tag(p.1.1), the computer may translate the CXL.mem S2M DRS to a CXL.cache H2D Data comprising CQID(q.2.1) and Data(*Data.1*). The computer may perform further translations, such as address translations, translations between CXL.cache CQIDs and CXL.mem Tags, translations between reserved fields, and/or opcode translations, e.g., translating between CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed, and CXL.mem M2S request opcodes, such as MemRd*.

FIG. 8B illustrates an example of a TFD demonstrating intent-based translations wherein a first entity may initiate a CXL.cache transaction that may include a CXL.cache D2H request comprising Opcode(RdShared), CQID(q.3.1), and Address(AS.3.1), wherein the CXL.cache D2H request may indicate an intent to request a cacheline to be cached in shared state by utilizing RdShared. A computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpData), MetaField(MS0), MetaValue(S), Tag(p.4.1), and Address(AS.4.1), wherein the CXL.mem M2S request may indicate a corresponding intent to request a shared copy of the cacheline, and wherein the computer may send the CXL.mem M2S request to the second entity. Upon receiving a response from the second entity, which may include a CXL.mem S2M DRS comprising Opcode(MemData), Tag(p.4.1), and Data(*Data.2*), and may further include a CXL.mem S2M NDR comprising Opcode(Cmp-S) and Tag(p.4.1), the Cmp-S may provide an indication from the DCOH to the computer for Shared state. The computer may translate the CXL.mem S2M DRS to a CXL.cache H2D Data comprising CQID(q.3.1) and Data(*Data.2*), and may further translate the CXL.mem S2M DRS and/or the CXL.mem S2M NDR to a CXL.cache H2D response comprising CQID(q.3.1) and GO-S.

FIG. 8C illustrates an example of a TFD demonstrating intent-based translations wherein a first entity may initiate a CXL.cache transaction that may include a CXL.cache D2H request comprising Opcode(RdOwn), CQID(q.6.1), and Address(AS.6.1), wherein the CXL.cache D2H request may indicate an intent to request a cacheline to be cached in any writeable state by utilizing RdOwn, typically receiving the cacheline in Exclusive (GO-E) or Modified (GO-M) state. A computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpInv), MetaField(MS0), MetaValue(A), Tag(p.5.1), and Address(AS.5.1), wherein the CXL.mem M2S request may indicate a corresponding intent to request an exclusive copy of the cacheline, and wherein the computer may send the CXL.mem M2S request to a second entity. Upon receiving a response from the second entity, which may include a CXL.mem S2M DRS comprising Opcode(MemData), Tag(p.5.1), and Data(*Data.3*), and may further include a CXL.mem S2M NDR comprising Opcode(Cmp-E) and Tag(p.5.1), the Cmp-E may provide an indication from the DCOH to the computer for Exclusive ownership. The computer may translate the CXL.mem S2M DRS to a CXL.cache H2D Data comprising CQID(q.6.1) and Data(*Data.3*), and may further translate the CXL.mem S2M DRS and/or the CXL.mem S2M NDR to a CXL.cache H2D response comprising CQID(q.6.1) and GO-E.

Modern data center architectures increasingly utilize disaggregated memory systems wherein multiple compute hosts may require access to shared memory resources through different protocols and address spaces. CXL.mem enables memory access between a CXL host and CXL devices, wherein different CXL device types may utilize different CXL.mem revisions and/or instances. Translations between different CXL.mem messages may enable CXL communications between a CXL device and CXL hosts, may facilitate memory prefetching and speculative read operations to reduce access latency, and/or may enable novel architectures wherein hosts access memory devices without an intervening CXL switch, contrary to standard CXL topologies, which require a CXL switch between hosts and a Single Logical Device (SLD), a Multi-Logical Device (MLD), or a Global Fabric-Attached Memory Device (GFD), when hosts require access to the same device.

In various implementations, a method for translating between Compute Express Link (CXL) messages, comprising: receiving, from a first entity, a first CXL.mem Master-to-Subordinate (M2S) request; translating, by a computer, the first CXL.mem M2S request to a second CXL.mem M2S request, wherein value of at least one field, selected from MemOpcode, Tag, or Address, is different between the first and second CXL.mem M2S requests; and sending the second CXL.mem M2S request to a second entity. The translation between CXL.mem M2S requests may enable communication between a first entity, such as a CXL host, and a second entity, such as a CXL device that utilizes different CXL.mem revisions and/or fields values. The modified fields may affect protocol fields including physical addresses which may be carried in Address fields for address space mapping, opcodes which may be carried in MemOpcode fields for protocol semantic adaptation, or Tags for transaction management. The computer may selectively translate values of one or more of these field types depending on the incompatibility between the CXL host's protocol and the CXL device's protocol. Physical address translation may enable access across different memory domains, opcode translation may enable different operations or device type bridging, and Tag translation may enable transaction tracking across protocol boundaries.

In some implementations of the method, the first entity comprises a CXL host, and the first CXL.mem M2S request comprises a first physical address belonging to a first Host Physical Address (HPA) space utilized by the CXL host; and wherein the second entity comprises a CXL device, and the second CXL.mem M2S request comprises a second physical address within an address space exposed by the second entity. The address translation between HPA spaces may enable a CXL host to access memory resources exposed by a CXL device that utilizes a different HPA space.

In some implementations of the method, the at least one field comprises the Address, the first CXL.mem M2S request comprises a first physical address belonging to a first Host Physical Address (HPA) space utilized by the first entity, and the second CXL.mem M2S request comprises a second physical address belonging to a second HPA space utilized by the second entity. The physical address translation between HPA spaces may involve mapping memory locations from the CXL host's address space to corresponding locations in the address space utilized by the second entity. The computer may maintain address translation tables, implement base-and-offset calculations, or utilize programmable mapping functions to convert between addresses from the different address spaces. The first and second HPA spaces may differ in size, base addresses, memory layouts, or granularity, and the translation algorithm may accommodate these differences while preserving memory operation semantics.

In some implementations of the method, the at least one field comprises the MemOpcode and the Tag, the first CXL.mem M2S request comprises a first opcode and a first Tag, and the second CXL.mem M2S request comprises a second opcode and a second Tag. The first and second opcodes may correspond to different memory access behaviors, and the first and second Tags may belong to different transaction identifier queues.

In some implementations of the method, the first opcode is selected from MemRd, MemRdData, MemRdTEE, MemRdDataTEE, and MemSpecRd; and wherein the second opcode is selected from MemInv, MemRd, MemRdData, MemRdTEE, MemRdDataTEE, MemInvTEE, MemSpecRd, MemInvNT, MemInvP, MemClnEvct, MemInvPTEE, MemSpecRdTEE, MemClnEvctTEE, or MemClnEvctU. Different opcodes are typically associated with different values or different encodings of an opcode field, such as MemOpcode in CXL.mem M2S Req. For example, according to CXL 3.2 specification, MemRdData is associated with the value 0010b of MemOpcode, whereas MemRd is associated with the value 0001b of MemOpcode. The translation from MemRdData to MemRd may enable protocol adaptation between different CXL device types, wherein MemRdData may be associated with CXL Type-3 device operations while MemRd may be associated with CXL Type-2 device operations. The Tag translation may involve maintaining a bidirectional mapping between the host-side and device-side transaction identifiers.

In some implementations, the method further comprises initiating a third CXL.mem M2S request, and sending the third CXL.mem M2S request to the second entity. The computer may generate additional requests, such as speculative memory read requests or predictive read requests that may facilitate data readiness before, or without, the CXL host explicitly requesting it. The decision to initiate the additional operations may be based on pattern recognition algorithms analyzing the CXL host's memory access behavior, statistical models predicting future access locations, configurable prefetch policies defining aggressiveness and scope of speculation, and/or bandwidth availability assessments determining when additional operations that may be speculative, predictive, or performed on a best-effort basis, will not interfere with requests originated by the CXL host.

In some implementations of the method, the third CXL.mem M2S request comprises MemSpecRd; or wherein the third CXL.mem M2S request comprises MemRd*, and further comprising receiving, from the second entity, a CXL.mem S2M DRS comprising MemData. The computer may generate speculative read requests, such as CXL.mem M2S requests comprising MemSpecRd opcodes, to start a memory access before, or without, the CXL host explicitly requesting it. Speculative reads may enable latency savings, such as when the memory resource exhibits long access times, e.g., due to slow memory media, or when the memory read address references remote memory resources over a fabric or a network. Additionally or alternatively, the computer may further generate prefetch read requests, such as CXL.mem M2S requests comprising MemRd* opcodes, to prefetch data before, or without, the CXL host explicitly requesting it. The prefetched data may be stored in the computer's local buffers or caches for rapid delivery when subsequently requested.

In some implementations, the method further comprises detecting sequential access patterns in physical addresses of prior CXL.mem M2S requests received from the first entity, and initiating the third CXL.mem M2S request targeting a next sequential physical address. The computer may track physical addresses from consecutive CXL.mem M2S requests received from the CXL host to identify sequential access patterns indicative of linear memory traversal. Upon detecting that the CXL host has accessed certain addresses in sequence, the computer may speculatively prefetch data from subsequent addresses before the CXL host explicitly requests them. The sequential pattern detection may account for cacheline boundaries, page boundaries, or other memory organization units to optimize prefetch granularity.

In some implementations, the method further comprises detecting strided access patterns in physical addresses of prior CXL.mem M2S requests received from the first entity, calculating a stride distance between accessed addresses, and initiating the third CXL.mem M2S request targeting a physical address offset by the stride distance. The computer may identify non-sequential but regular access patterns wherein the CXL host accesses memory locations separated by a consistent stride distance, such as when processing array elements or matrix columns. For example, if the computer observes accesses to addresses A, A+S, A+2S, where S represents the stride, it may speculatively prefetch from address A+3S. The stride detection algorithm may maintain a history buffer of recent addresses and compute stride patterns using difference calculations or pattern matching algorithms.

In some implementations of the method, the at least one field comprises the Address, the first CXL.mem M2S request comprises a first physical address and first MemSpecRd, and the second CXL.mem M2S request comprises a second physical address and second MemSpecRd; and further comprising translating the first physical address to the second physical address.

In some implementations of the method, the at least one field further comprises the MemOpcode, and the value of the MemOpcode is different between the first and second CXL.mem M2S requests; or wherein the first CXL.mem M2S request conforms to a first CXL specification revision, and the second CXL.mem M2S request conforms to a second CXL specification revision; and further comprising exposing, by the computer, a CXL Type-2 device or CXL Type-3 device to the first entity via a first interface, and exposing a root port to the second entity via a second interface. When the CXL host initiates its own speculative reads using MemSpecRd opcodes, the computer may perform physical address translation while preserving the speculative semantics of the request. The translation enables the host-initiated speculative operations to target the correct memory locations in the address space utilized by the second entity, enabling end-to-end speculative prefetching across different address domains. Additionally or alternatively, the translation between different CXL specification revisions may involve adapting message formats, field encodings, and protocol semantics between the revisions. For example, CXL 1.1 to CXL 2.0 translations may require handling new fields introduced in CXL 2.0, managing deprecated features from CXL 1.1, adjusting field widths or bit positions, and/or converting between different opcode encodings used in each version. The asymmetric interface configuration enables the computer to present different protocol roles to each connected entity. By exposing a CXL Type-2 or Type-3 device to the CXL host, the computer can receive memory requests as a subordinate device. By exposing a root port to the second entity (which may be a CXL device), the computer can initiate memory requests as a master. This dual-role architecture enables the computer to bridge protocols that would otherwise be incompatible due to both entities expecting to communicate with complementary protocol endpoints.

In some implementations of the method, the at least one field comprises the Address and the Tag; wherein the first CXL.mem M2S request comprises MemRd*, a first Tag, and a first physical address; and wherein the second CXL.mem M2S request comprises a second Tag and a second physical address; and further comprising receiving from the second entity a first CXL.mem Subordinate-to-Master Data Response (S2M DRS) comprising the second Tag; translating the first CXL.mem S2M DRS to a second CXL.mem S2M DRS comprising the first Tag; and sending the second CXL.mem S2M DRS to the first entity. The response translation may reverse the Tag mapping performed during request translation, ensuring that the CXL host receives responses with Tags matching its original requests. The computer may maintain a Tag translation table or utilize algorithmic Tag generation to translate between device-side Tags (second Tag) and host-side Tags (first Tag). Additionally, the computer may consolidate or filter response messages, potentially absorbing No Data Response messages while forwarding only Data Response messages to simplify the message flow.

In some implementations of the method, the second entity comprises a Global Fabric-Attached Memory (G-FAM) or a Global Fabric-Attached Memory Device (GFD); and wherein there is no CXL switch positioned between the computer and the second entity; and further comprising receiving, from a third entity, a third CXL.mem M2S request, translating the third CXL.mem M2S request to a fourth CXL.mem M2S request, and sending the fourth CXL.mem M2S request to the second entity; and wherein there is no CXL switch positioned between the computer and the third entity. The CXL specification mandates that GFDs connect through a Virtual CXL Switch (VCS) for proper protocol handling and routing. This implementation bypasses that requirement by having the computer perform the applicable translations and routing functions, eliminating the CXL switch from the topology. Removing the switch traversal delays may reduce latency, reduce cost by eliminating switch hardware, and/or simplify system configuration by reducing the number of CXL components requiring management. The translation of requests from multiple entities to a common destination entity, without an intervening CXL switch, may enable topologies where the computer aggregates traffic from multiple sources. The computer may maintain separate translation contexts for each source entity to preserve transaction isolation and enable independent address mappings.

In some implementations of the method, the third entity comprises a second CXL host, the second entity comprises a CXL device, and there is no CXL switch positioned between the third entity and the second entity. The computer enables multi-host access the same CXL device, without the CXL switch typically required for such multi-host configurations, by implementing separate translation contexts for each host, including independent address mappings, Tag translations, and transaction queues. The computer may also implement arbitration algorithms to fairly schedule requests from multiple hosts, coherency protocols to manage shared memory access, and isolation algorithms to prevent unauthorized cross-host memory access.

In some implementations, the method further comprises receiving, from a third entity, a third CXL.mem M2S request, translating the third CXL.mem M2S request to a fourth CXL.mem M2S request, and sending the fourth CXL.mem M2S request to the second entity; wherein the second entity exposes memory, and there is no CXL switch positioned between the computer and the second entity. The memory-exposing entity, such as a memory-exposing CXL device, may be accessed by hosts through the computer's translations without requiring a CXL switch. The computer may implement memory virtualization to present each host with its own view of the device's memory, memory partitioning to allocate specific regions to each host, or memory pooling to dynamically assign memory resources based on demand. The translation may ensure that each host's memory operations target the appropriate memory regions while maintaining isolation and coherency as required.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: first and second entities; a computer configured to: receive a first CXL.mem Master-to-Subordinate (M2S) request from the first entity, wherein CXL denotes Compute Express Link; translate the first CXL.mem M2S request to a second CXL.mem M2S request, wherein value of at least one field, selected from MemOpcode, Tag, or Address, is different between the first and second CXL.mem M2S requests; and send the second CXL.mem M2S request to the second entity. The translation enables communication between components that may utilize different addressing schemes, Tag management conventions, and/or memory operation types, which enables flexible system topologies where entities need not share compatible protocol parameters.

In some implementations of the system, the second entity comprises a second CXL device of a second type, the computer exposes resources associated with the second entity to the first entity via a first CXL device of a first type, and the first type and the second type are different. The translation may further enable abstraction of component identities, such as exposing resources associated with a CXL Type-3 device as a CXL Type-2 device, or exposing resources associated with a CXL Type-2 device as a CXL Type-1 device.

In some implementations of the system, the second entity comprises a CXL Type-3 device, and wherein the computer exposes resources associated with the second entity to the first entity via a CXL Type-2 device. Exposing resources associated with a CXL Type-3 device as a CXL Type-2 device may enable different caching behaviors or coherency models than those natively supported by the Type-3 device.

In some implementations of the system, the second entity comprises a CXL Type-2 device, and wherein the computer exposes memory resources associated with the second entity to the first entity via a CXL Type-3 device. Exposing memory resources associated with a CXL Type-2 device as a CXL Type-3 device may enable simplified memory access semantics for hosts that do not require the full capabilities of Type-2 devices, potentially reducing complexity in system configurations.

In some implementations, the system further comprises a third entity, wherein the computer is further configured to: receive a third CXL.mem M2S request from the third entity; translate the third CXL.mem M2S request to a fourth CXL.mem M2S request, wherein value of at least one field, selected from MemOpcode, Tag, or Address, is different between the third and fourth CXL.mem M2S requests; and send the fourth CXL.mem M2S request to the second entity. The ability of the computer to aggregate and translate requests from multiple sources to a common destination entity enables the multi-host or multi-initiator configuration with the third entity. The computer may perform independent translations for each source entity, enabling per-entity address mapping, Tag namespace management, and/or opcode policies. This enables the second entity, such as a CXL memory device, to serve multiple initiators through the same physical interface while maintaining logical separation of their respective transactions.

In some implementations of the system, the first entity comprises a first host, the third entity comprises a second host, the second entity comprises a CXL device, and there is no CXL switch positioned between the CXL device and the first and second hosts. The CXL specification requires SLDs, MLDs, and GFDs to connect to multiple hosts through a VCS within a CXL switch. This implementation eliminates the requirement for a CXL switch by using the computer to perform the applicable translations, routing decisions, and multi-host coordination functions. The computer may implement the logical equivalent of VCS functionality while operating as a translation unit rather than a switch component, enabling new deployment models and system architectures not contemplated by the standard CXL topology requirements.

In some implementations of the system, the computer is further configured to maintain separate address translation tables for the first and third entities, mapping first and third addresses from first and third address spaces utilized by the first and third entities, respectively, to second addresses within a second address space utilized by the second entity. The separate address translation tables may enable memory isolation between the entities, such as between hosts, preventing unauthorized cross-host memory access. Each translation table may map a host's virtual view of a CXL device to distinct physical regions, implementing hardware-enforced memory protection without requiring CXL switch-based isolation mechanisms. Mapping to non-overlapping regions may enable memory pooling and ensure that memory operations from one host cannot inadvertently or maliciously access another host's allocated memory space, whereas mapping to overlapping regions may enable memory sharing between hosts.

In some implementations of the system, the second entity comprises a second CXL device, and wherein the computer exposes resources associated with the second entity to the first entity via a first CXL device and to the third entity via a third CXL device. The virtualization of the single physical CXL device, such as a memory expander, into multiple virtual devices enables each host to operate as if it has exclusive access to a dedicated memory expander. The computer may present different capacity values, latency characteristics, bandwidth allocations, or feature sets to each host through the virtual device abstraction. This virtualization may include managing separate configuration spaces, capability registers, and control interfaces for each virtual device instance.

In various implementations, a method for enabling multi-host access to a Compute Express Link (CXL) device, comprising: receiving, from a first entity, a first CXL.mem Master-to-Subordinate (M2S) request carrying a first physical address; receiving, from a second entity, a second CXL.mem M2S request carrying a second physical address; translating the first and second physical addresses to third and fourth physical addresses within an address space utilized by a CXL device; generating third and fourth CXL.mem M2S requests comprising the third and fourth physical addresses, respectively; and sending the third and fourth CXL.mem M2S requests to the CXL device. A standard CXL switch typically uses HDM decoders for routing purposes in order to determine which downstream port (DPID/Port ID) should receive the request, and then forwards the original request containing the HPA. Additionally, the standard CXL switch does not perform the HPA-to-DPA translation itself when acting as a router to an endpoint device like an MLD/MHD. This implementation overcomes these limitations by interposing address translation and request routing logic between the CXL hosts and the CXL device. The translation of physical addresses may enable each host to maintain its own memory view while the CXL device may utilize a separate address space, with the translation logic managing the mapping between addresses from the host address spaces and the address space utilized by the CXL device.

In some implementations of the method, the first and second entities comprise first and second CXL hosts, respectively, the CXL device comprises a CXL memory expander, the first and second physical addresses from the first and second CXL hosts target overlapping memory regions, and further comprising implementing coherency control between the first and second CXL hosts for the overlapping memory regions. When hosts access overlapping memory regions, the computer may implement coherency mechanisms including snoop filtering to track which host has cached copies of specific memory lines, invalidation broadcasting to notify hosts when shared data is modified, and/or lock management to serialize concurrent access to the same memory locations. These coherency controls operate independently of CXL switch-based coherency mechanisms, implementing coherency protocols within the translation logic.

In some implementations of the method, the CXL device comprises a CXL memory expander, and further comprising implementing quality-of-service (QoS) policies associated with the first and second entities, wherein the QoS policies comprise bandwidth allocation or latency prioritization for memory accesses to the CXL memory expander. The QoS implementation may prevent an entity (such as a CXL host) from monopolizing the memory expander's resources while guaranteeing minimum performance levels for predetermined workloads. Bandwidth allocation may utilize token bucket algorithms, rate limiting mechanisms, or credit-based flow control to regulate the rate of requests forwarded from each entity. Latency prioritization may involve request reordering based on configured priority levels, deadline scheduling for time-sensitive operations, and/or preferential queue management for high-priority entities.

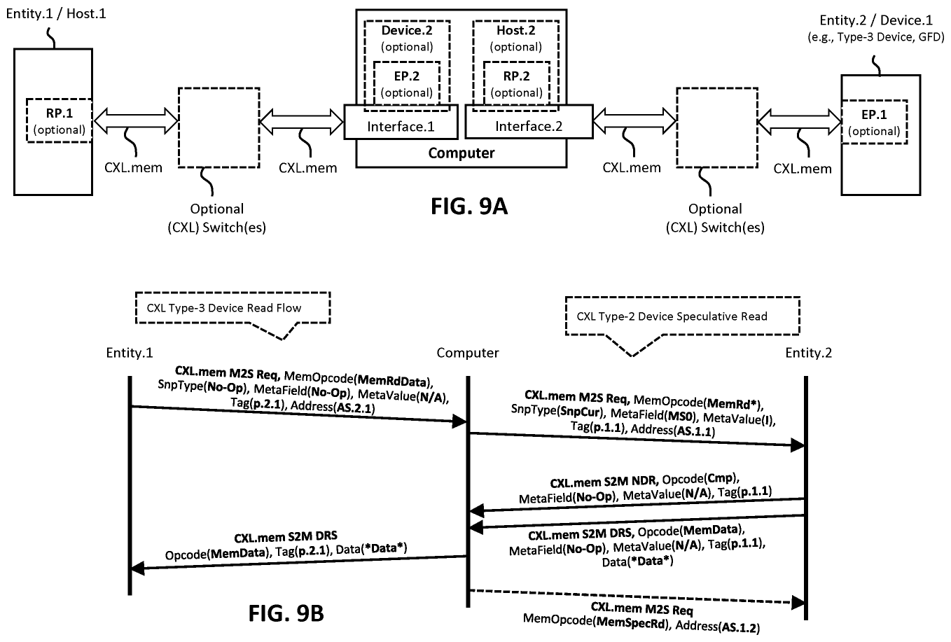

FIG. 9A illustrates an example of a system comprising a computer coupled between a first interface (Interface.1) and a second interface (Interface.2), wherein both the first and second interfaces may communicate according to CXL.mem. The first interface may expose resources associated with a second device (Device.2), such as a CXL type-2 device or a CXL type-3 device, optionally comprising a second endpoint (EP.2), and may communicate according to CXL.mem with a first entity (Entity.1), such as a first host (Host.1), possibly via a first root port (RP.1) of the first host. The second interface may expose a root port (RP.2), via which the computer may communicate as a second host (Host.2) according to CXL.mem with a second entity (Entity.2), such as a first CXL device (Device.1), which may include a first endpoint (EP.1). Additionally or alternatively, the first CXL device may include a Global Fabric-Attached Memory (G-FAM) Device (GFD). The computer may extract physical addresses from messages received via the first interface, wherein these addresses may be from a first HPA space utilized by the first host; translate these addresses; and generate messages carrying the translated physical addresses for transmission via the second interface; wherein these translated addresses may correspond to a physical address space exposed by the computer over the second interface. Optional CXL switch(es) may be positioned between the first interface and the first entity, and/or between the second interface and the second entity. In some examples, the computer and at least one of the first entity and the second entity may be included within the same IC package, optionally coupled via one or more UCIe links.

FIG. 9B illustrates an example of a transaction flow diagram (TFD) demonstrating translations, optionally performed by a computer, between first CXL.mem messages received from a first entity (Entity.1), such as a first host (Host.1), that may utilize a first CXL.mem, and second CXL.mem messages, sent to a second entity (Entity.2), such as a first CXL device (Device.1), that may utilize a second CXL.mem, possibly enabling the computer to abstract resources of the second entity, and possibly enabling the first entity to access resources of the second entity utilizing different memory flow types, such as utilizing optimized type-3 memory flows, instead of type-2 memory flows that may be utilized by the second entity. Additionally or alternatively, the computer may further initiate speculative memory reads targeting the second entity, and may handle memory prefetching on behalf of the first entity, possibly acting as a proxy of the first entity when communicating with the second entity. The first entity may initiate a first CXL.mem transaction that may include a first CXL.mem M2S Req comprising MemOpcode(MemRdData), SnpType(No-Op), MetaField(No-Op), MetaValue(N/A), Tag(p.2.1), and Address(AS.2.1). The computer may translate the first CXL.mem transaction to a second CXL.mem transaction that may include a second CXL.mem M2S Req comprising MemOpcode(MemRd*), SnpType(SnpCur), MetaField(MS0), MetaValue(I), Tag(p.1.1), and Address(AS.1.1), and may send the second CXL.mem M2S Req to the second entity. Upon receiving one or more responses from the second entity, that may include a CXL.mem S2M NDR comprising Opcode(Cmp), MetaField(No-Op), MetaValue(NA), and Tag(p.1.1), and may further include a first CXL.mem S2M DRS comprising Opcode(MemData), MetaField(No-Op), MetaValue(NA), Tag(p.1.1), and Data(*Data*), the computer may translate the one or more responses from the second entity to a second CXL.mem S2M DRS comprising Opcode(MemData), Tag(p.2.1), and Data(*Data*), and may send the second CXL.mem S2M DRS to the first entity.

One example of a speculative memory read targeting the second entity includes a CXL.mem M2S Req comprising MemOpcode(MemSpecRd) and Address(AS.1.2), which may utilize the speculative memory reads, optionally on behalf of the first entity, to facilitate data prefetches and potentially reduce read latency from the second entity. When utilizing MemSpecRd, some of the CXL.mem M2S Req fields, such as Tag, MetaField, MetaValue, and SnpType, may be reserved. The computer may perform further translations, such as opcode translations, e.g., translating between a first CXL.mem M2S Req opcode, such as MemRdData, and a second CXL.mem M2S Req opcode, such as MemRd. The computer may further perform other translations, such as field translations between messages conforming to the first CXL.mem and messages conforming to the second CXL.mem, such as translations between CXL.mem Tags of the two protocols, translations between values of reserved fields of the two protocols, and translations between values of reserved and non-reserved fields of the two protocols. In some examples, the computer may translate between protocols conforming to different CXL revisions, such as translating between transactions of the first CXL.mem conforming to CXL 1.1, which may be utilized by the first entity, and transactions of the second CXL.mem conforming to CXL 2.0, which may be utilized by the second entity.

In some examples, the computer may act as a second device (Device.2), such as a CXL type-3 device or CXL type-2 device optionally comprising a protocol endpoint, and terminate the first CXL.mem transaction. The computer may then issue the second CXL.mem transaction, optionally acting as an independent protocol initiator, such as a second host (Host.2), and may utilize translated fields from the first CXL.mem transaction for constructing the second CXL.mem transaction. In other examples, the computer may maintain, at least partly, an end-to-end transaction context along the path between the first entity and the second entity, optionally without terminating CXL.mem transactions received from the first entity, such as by preserving, at least partly, transaction-related identification fields. In one example, the computer may reuse CXL.mem Tags received from the first entity for constructing CXL.mem Tags sent to the second entity, hence optionally preserving, at least partly, a transaction identifier over the path between the first entity and the second entity, for maintaining, at least partly, an end-to-end transaction context along that path.

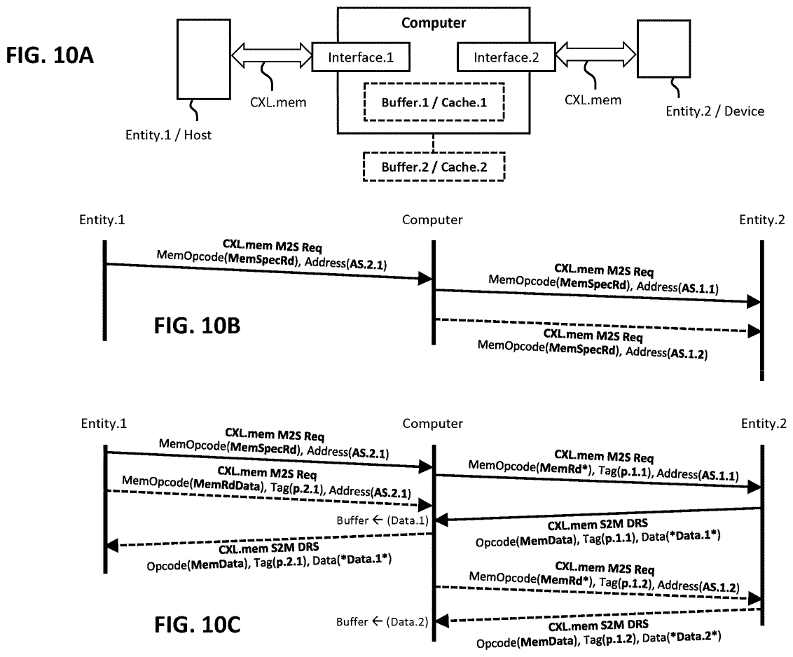

FIG. 10A illustrates an example of a system comprising a computer coupled between a first interface (Interface.1) and a second interface (Interface.2), wherein both the first and second interfaces may communicate according to CXL.mem. The first interface may communicate according to first CXL.mem with a first entity (Entity.1), such as a host. The second interface may communicate according to second CXL.mem with a second entity (Entity.2), such as a device, such as a CXL type-3 device or a Global Fabric-Attached Memory (G-FAM) Device (GFD). The computer may extract field values, such as addresses, opcodes, or Tags, from messages received via the first interface; translate one or more of these field values; and generate messages carrying the translated field values for transmission via the second interface. The computer may include a first buffer (Buffer.1) or a first cache (Cache.1), and may be coupled to a second buffer (Buffer.2) or a second cache (Cache.2). The computer may utilize the buffers or caches for storing data, such as data read from the second entity, data written to the second entity, or data prefetched by the computer from the second entity. Optional CXL switch(es) may be positioned between the first interface and the first entity, and/or between the second interface and the second entity. In some examples, the computer and at least one of the first entity and the second entity may be included within the same IC package, optionally coupled via one or more UCIe links.

FIG. 10B illustrates an example of a TFD demonstrating translations, optionally performed by a computer, between CXL.mem M2S MemSpecRd requests received from a first entity (Entity.1), such as a host, that may utilize a first CXL.mem, and CXL.mem M2S MemSpecRd requests sent to a second entity (Entity.2), such as a CXL device, that may utilize a second CXL.mem, possibly enabling the computer to facilitate data readiness and reduce read latency from the second entity. Additionally or alternatively, the computer may initiate further speculative memory reads targeting the second entity, and may handle memory prefetching on behalf of the first entity, possibly acting as a proxy of the first entity when communicating with the second entity. The first entity may initiate a first CXL.mem transaction that may include a first CXL.mem M2S Req comprising MemOpcode(MemSpecRd) and Address(AS.2.1). When utilizing MemSpecRd, some of the CXL.mem M2S Req fields, such as Tag, MetaField, MetaValue, and SnpType, may be reserved. The computer may translate the first CXL.mem transaction to a second CXL.mem transaction that may include a second CXL.mem M2S Req comprising MemOpcode(MemSpecRd) and Address(AS.1.1), and may send the second CXL.mem M2S Req to the second entity. In some examples, the computer may further translate the first CXL.mem transaction to a third CXL.mem transaction that may include a third CXL.mem M2S Req comprising MemOpcode(MemSpecRd) and Address(AS.1.2), and may send the third CXL.mem M2S Req to the second entity, possibly facilitating the readiness of further data reads that may be expected from the first entity. The computer may further perform other translations, such as translations between messages conforming to the first CXL.mem and messages conforming to the second CXL.mem, translations between reserved fields, and/or translations between reserved and non-reserved fields. In some examples, the computer may translate between protocols conforming to different CXL revisions, such as translating between transactions of the first CXL.mem conforming to CXL 1.1, which may be utilized by the first entity, and transactions of the second CXL.mem conforming to CXL 2.0, which may be utilized by the second entity.

FIG. 10C illustrates an example of a TFD demonstrating translations between CXL.mem messages received from a first entity (Entity.1), such as a host, that may utilize a first CXL.mem, and CXL.mem messages sent to a second entity (Entity.2), such as a CXL device, that may utilize a second CXL.mem, possibly enabling the computer to abstract resources of the second entity and to facilitate data readiness and reduce read latency by prefetching data from the second entity. The first entity may initiate a speculative memory read by initiating a first CXL.mem transaction that may include a first CXL.mem M2S Req comprising MemOpcode(MemSpecRd) and Address(AS.2.1), wherein the first entity may send the first CXL.mem M2S Req to the computer. When utilizing MemSpecRd, some of the CXL.mem M2S Req fields, such as Tag, MetaField, MetaValue, and SnpType, may be reserved. The computer may translate the speculative memory read to a demand read, such as by translating the first CXL.mem transaction to a second CXL.mem transaction that may include a second CXL.mem M2S Req comprising MemOpcode(MemRd*), Tag(p.1.1), and Address(AS.1.1), wherein the computer may send the second CXL.mem M2S Req to the second entity.

Upon receiving one or more responses from the second entity, that may include a first CXL.mem S2M DRS comprising Opcode(MemData), Tag(p.1.1), and Data(*Data.1*), the computer may store *Data.1* in a buffer or a cache, and may further respond to an outstanding read request, if exists, from the first entity, such as a third CXL.mem transaction that may include a third CXL.mem M2S Req comprising MemOpcode(MemRdData), Tag(p.2.1), and Address(AS.2.1), wherein the computer may respond to this request with a second CXL.mem S2M DRS comprising Opcode(MemData), Tag(p.2.1), and Data(*Data.1*), and may send the second CXL.mem S2M DRS to the first entity. Optionally, such as in order to prefetch the next data from the second entity, the computer may further translate the first CXL.mem transaction to a fourth CXL.mem transaction that may include a fourth CXL.mem M2S Req comprising MemOpcode(MemRd*), Tag(p.1.2), and Address(AS.1.2), and may send the fourth CXL.mem M2S Req to the second entity. Upon receiving one or more responses from the second entity, that may include a third CXL.mem S2M DRS comprising Opcode(MemData), Tag(p.1.2), and Data(*Data.2*), the computer may store *Data.2* in the buffer or the cache, wherein the prefetched *Data.2* may be ready for consumption by the first entity, potentially reducing read latency from the second entity as perceived from the first entity. The computer may perform further translations, such as opcode translations, e.g., translating between a first CXL.mem M2S Req opcode, such as MemSpecRd, and a second CXL.mem M2S Req opcode, such as MemRd*.

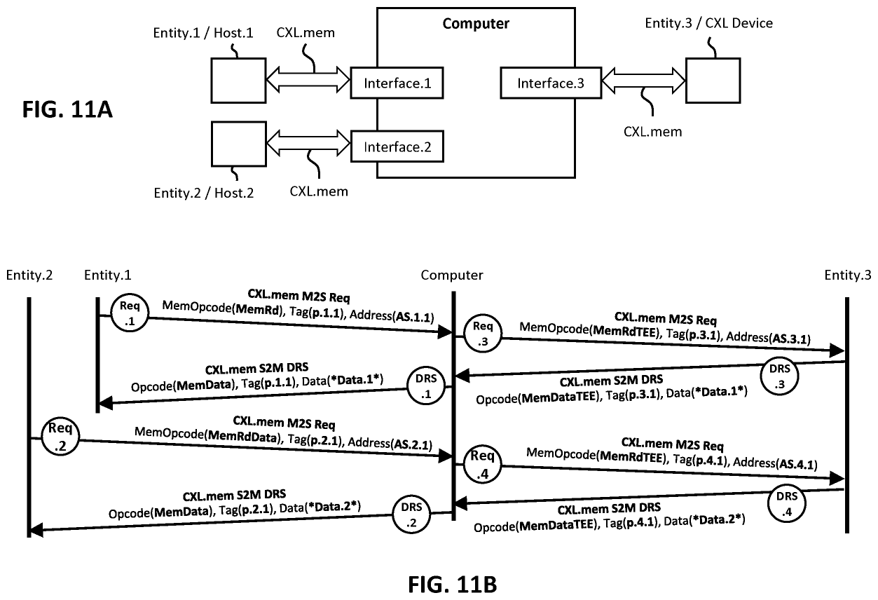

FIG. 11A illustrates an example of a system comprising a computer coupled to a first interface (Interface.1), a second interface (Interface.2), and a third interface (Interface.3). The computer may: (i) receive, via the first interface, a first CXL.mem Master-to-Subordinate request (M2S request) from a first entity (Entity.1), such as a first host (Host.1); (ii) receive, via the second interface, a second CXL.mem M2S request from a second entity (Entity.2), such as a second host (Host.2); (iii) translate the first and second CXL.mem M2S requests to third and fourth CXL.mem M2S requests, respectively; and (iv) send, via the third interface, the third and fourth CXL.mem M2S requests to a third entity (Entity.3), such as a CXL device, that may include an endpoint (EP). Additionally or alternatively, the CXL device may include a Global Fabric-Attached Memory (G-FAM) Device (GFD). In some examples, the computer may further: (i) extract first values of fields, such as first addresses, first opcodes, or first Tags, from messages received via the first interface, translate these first values, and generate messages carrying the translated first values for transmission via the third interface; and/or (ii) extract second values of fields, such as second addresses, second opcodes, or second Tags, from messages received via the second interface, translate these second values, and generate messages carrying the translated second values for transmission via the third interface. In some examples, the computer and at least one of the first entity, the second entity, and the third entity, may be included within the same IC package, optionally coupled via one or more UCIe links.

FIG. 11B illustrates an example of a TFD demonstrating translations, such as translations, optionally performed by a computer, between CXL.mem M2S requests received from a first entity (Entity.1) and a second entity (Entity.2), and CXL.mem M2S requests sent to a third entity (Entity.3), such as a CXL device, possibly enabling the computer to abstract resources of the third entity, such as memory resources, and to expose these resources to the first entity, which may be a first host (Host.1), and to the second entity, which may be a second host (Host.2). In some examples, the translations may enable two hosts to access memory resources of a CXL device. The first entity may initiate a first CXL.mem M2S request (marked as Req.1) comprising MemOpcode(MemRd), Tag(p.1.1), and Address(AS.1.1). The computer may translate the first CXL.mem M2S request to a third CXL.mem M2S request (marked as Req.3) comprising MemOpcode(MemRdTEE), Tag(p.3.1), and Address(AS.3.1), and may send the third CXL.mem M2S request to the third entity. Upon receiving one or more responses from the third entity, which may include a third CXL.mem S2M DRS (marked as DRS.3) comprising Opcode(MemDataTEE), Tag(p.3.1), and Data(*Data.1*), the computer may translate the third CXL.mem S2M DRS to a first CXL.mem S2M DRS (marked as DRS.1) comprising Opcode(MemData), Tag(p.1.1), and Data(*Data.1*), and may send the first CXL.mem DRS to the first entity.

Similarly, the second entity may initiate a second CXL.mem M2S request (marked as Req.2) comprising MemOpcode(MemRdData), Tag(p.2.1), and Address(AS.2.1). The computer may translate the second CXL.mem M2S request to a fourth CXL.mem M2S request (marked as Req.4) comprising MemOpcode(MemRdTEE), Tag(p.4.1), and Address(AS.4.1), and may send the fourth CXL.mem M2S request to the third entity. Upon receiving one or more responses from the third entity, which may include a fourth CXL.mem S2M DRS (marked as DRS.4) comprising Opcode(MemDataTEE), Tag(p.4.1), and Data(*Data.2*), the computer may translate the fourth CXL.mem S2M DRS to a second CXL.mem S2M DRS (marked as DRS.2) comprising Opcode(MemData), Tag(p.2.1), and Data(*Data.2*), and may send the second CXL.mem DRS to the second entity. The computer may perform further translations, such as opcode translations, e.g., translating between CXL.mem M2S request comprising MemRdData, and CXL.mem M2S request comprising MemRdTEE, possibly enabling confidential computing and Trusted Execution Environment (TEE), such as by protecting data-at-rest via encryption. The computer may further perform other translations, such as Tag translations between CXL.mem messages, translations between reserved fields, and/or translations between reserved and non-reserved fields. In some examples, the computer may translate between CXL.mem conforming to different CXL revisions, such as translating between transactions of CXL.mem conforming to CXL 1.1, which may be utilized by the first entity, and transactions of CXL.mem conforming to CXL 4.0, which may be utilized by the third entity.

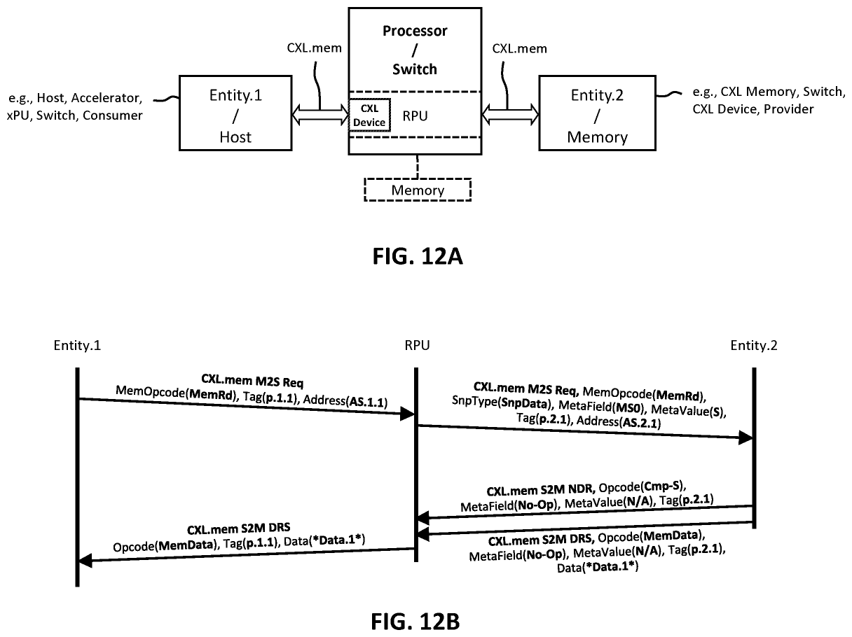

FIG. 12A illustrates an example of a system comprising a processor or a switch, which may include or may be coupled to memory, and may further include an RPU with a CXL device, such as a Global Fabric-Attached Memory (G-FAM) Device (GFD), or a Type-3/2/1 CXL device, enabling external entities to access resources coupled to the processor via the CXL device. The processor is coupled to a first entity (Entity.1), which may be a host, an accelerator, an xPU, or a second switch, wherein the processor may communicate with the first entity according to a first CXL.mem. The processor is further coupled to a second entity (Entity.2), which may be a CXL memory, a CXL device, or a third switch, wherein the processor may communicate with the second entity according to a second CXL.mem. In some examples, the first and second CXL.mem may be associated with first and second physical address spaces, respectively, wherein the RPU may perform address translations between addresses within the first and second physical address spaces, respectively. In other examples, the first and second CXL.mem may be associated with the same physical address space, wherein the RPU may perform address translations between addresses within the same physical address space.

The RPU may perform further translations, such as opcode translations, e.g., translating between MemRd opcodes in requests conforming to the first CXL.mem, to MemRdTEE opcodes in requests conforming to the second CXL.mem, enabling CXL memory accesses with the Trusted Execution Environment (TEE) attribute. The RPU may further perform other translations, such as translations between messages conforming to the first and second CXL.mem, such as Tag translations and traffic class (TC) translations. In some examples, the RPU may translate between protocols conforming to different CXL protocol revisions, such as translating between CXL.mem transactions conforming to CXL 1.1, which may be utilized by the first entity, and CXL.mem transactions conforming to CXL 2.0, which may be utilized by the second entity. In some examples, the RPU may translate between CXL.mem type-3 memory flows and CXL.mem type-2 memory flows, such as CXL.mem transactions that may include CXL.mem S2M NDR responses.

FIG. 12B illustrates an example of a TFD demonstrating translations performed by a processor, a switch, or by an RPU, between a first CXL.mem utilized for communicating with a first entity (Entity.1), such as a host, and a second CXL.mem utilized for communicating with a second entity (Entity.2), such as a CXL device or CXL memory. The first entity may initiate a first CXL.mem transaction that includes a first CXL.mem M2S request comprising MemOpcode(MemRd*), Tag(p.1.1), and Address(AS.1.1). The RPU may translate the first CXL.mem transaction to a second CXL.mem transaction that includes a second CXL.mem M2S request comprising MemOpcode(MemRd), SnpType(SnpData), MetaField(MS0), MetaValue(S), Tag(p.2.1), and Address(AS.2.1), wherein the RPU may send the second CXL.mem M2S request to the second entity. The second entity may respond to the second CXL.mem M2S request with a CXL.mem S2M NDR comprising Opcode(Cmp-S), MetaField(No-Op), MetaValue(NA), and Tag(p.2.1), and may further respond with a first CXL.mem S2M DRS comprising Opcode(MemData), MetaField(No-Op), MetaValue(NA), Tag(p.2.1), and Data(*Data.1*), wherein the RPU may translate the first CXL.mem S2M DRS to a second CXL.mem S2M DRS comprising Opcode(MemData), Tag(p.1.1), and Data(*Data.1*). Optionally, the RPU may act as a protocol endpoint and terminate the first CXL.mem transaction. The RPU may issue the second CXL.mem transaction, optionally acting as an independent protocol initiator, such as a CXL host, and may utilize translated fields from the first CXL.mem transaction for constructing the second CXL.mem transaction. In other examples, the RPU may maintain end-to-end transaction contexts of CXL.mem between the first entity and the second entity, without terminating the CXL.mem transactions, such as by preserving transaction-related identifications such as Tags, and optionally translating other fields such as address fields.

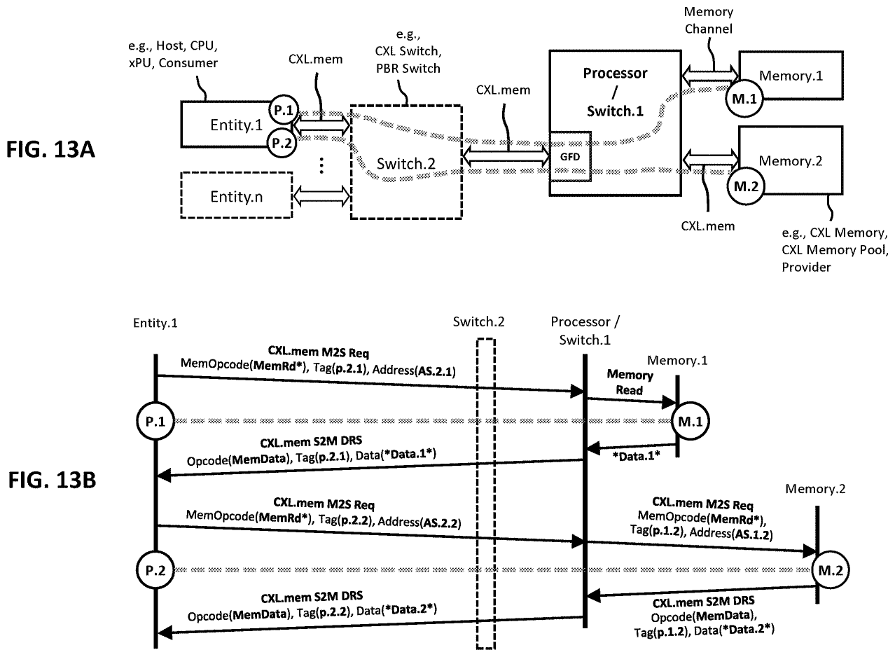

FIG. 13A illustrates an example of a system comprising a processor or a first switch (Switch.1), which may be coupled to a first memory (Memory.1), such as DRAM, via a memory channel, and may be further coupled to a second memory (Memory.2), such as CXL memory, a CXL memory pool, or a CXL-based provider. The processor may include a Global Fabric-Attached Memory (G-FAM) Device (GFD), which may be coupled to one or more entities, such as first entity (Entity.1), optionally via a second switch (Switch.2), such as a CXL switch or a PBR switch, enabling the one or more entities to access, via the GFD, resources coupled to the processor, such as via one or more of the two illustrated paths denoted as (P.1)-(M.1) and (P.2)-(M.2). In some examples, the number of entities, denoted by the parameter n of (Entity.n) may exceed 16. The processor may communicate with the first entity, which may be a host, a CPU, an xPU, or a consumer, according to a first CXL-based protocol, such as a first CXL.mem. The processor may communicate with the second memory, according to a second CXL-based protocol, such as a second CXL.mem.

In some examples, the first and second CXL.mem may be associated with first and second physical address spaces, respectively, such as first and second Host Physical Address (HPA) spaces, wherein the processor may perform address translations between addresses within the first and second physical address spaces, respectively. In other examples, the first and second CXL.mem may be associated with the same physical address space, wherein the processor may perform address translations between addresses within the same physical address space. The processor may perform further translations, such as opcode translations, e.g., translating between MemRd opcodes in requests conforming to the first CXL.mem, to MemRdTEE opcodes in requests conforming to the second CXL.mem, enabling CXL memory accesses with the Trusted Execution Environment (TEE) attribute. The processor may further perform other translations, such as translations between messages conforming to the first and second CXL.mem, traffic class (TC) translations, and/or Tag translations. The processor may maintain tracking between Tags associated with the first CXL.mem and Tags associated with the second CXL.mem, such as in order to associate responses with their corresponding requests. In some examples, the processor may translate between protocols conforming to different CXL protocol revisions, such as translating between CXL.mem transactions conforming to CXL 1.1, which may be utilized by the first entity, and CXL.mem transactions conforming to CXL 2.0, which may be utilized by the second memory.

FIG. 13B illustrates an example of a TFD demonstrating two CXL.mem transactions between a first entity (Entity.1), such as a host, and a processor, or a first switch (Switch.1), corresponding to two distinct memory read paths denoted as (P.1)-(M.1) and (P.2)-(M.2), each associated with a different physical address mapped to different memory resources. The drawing further illustrates translations performed by the processor (or by Switch.1), between a first CXL.mem utilized for communicating with the first entity, and a second CXL.mem utilized for communicating with a second memory (Memory.2), such as a CXL memory, wherein the communication between the processor and the first entity may be performed via a Global Fabric-Attached Memory (G-FAM) Device (GFD) and optionally via a second switch (Switch.2).

The first CXL.mem transaction received by the processor from the first entity includes a first CXL.mem M2S request comprising MemOpcode(MemRd*), Tag(p.2.1), and Address(AS.2.1), which the processor may translate and forward, optionally via an internal interconnect of the processor, via a memory controller, and via a memory channel, to a first memory (Memory.1), resulting in the retrieval of *Data.1*, that the processor sends to the first entity via a first CXL.mem S2M DRS comprising Opcode(MemData), Tag(p.2.1), and Data(*Data.1*).

The second CXL.mem transaction received by the processor from the first entity includes a second CXL.mem M2S request comprising MemOpcode(MemRd*), Tag(p.2.2), and Address(AS.2.2), which the processor may translate to a third CXL.mem transaction that may include a third CXL.mem M2S request comprising MemOpcode(MemRd*), Tag(p.1.2), and Address(AS.1.2), wherein the processor may send the third CXL.mem M2S request to the second memory. Upon receiving a response from the second memory, that may include a second CXL.mem S2M DRS comprising Opcode(MemData), Tag(p.1.2), and Data(*Data.2*), the processor may translate the second CXL.mem S2M DRS to a third CXL.mem S2M DRS comprising Opcode(MemData), Tag(p.2.2), and Data(*Data.2*). The processor may perform further translations, such as opcode translations, e.g., translating between MemRd opcodes in requests conforming to the first CXL.mem, and MemRdTEE opcodes in requests conforming to the second CXL.mem, enabling CXL memory accesses with the Trusted Execution Environment (TEE) attribute.

In some examples, the processor may act as a protocol endpoint and terminate the CXL.mem transactions received from the first entity. The processor may issue CXL.mem transactions to the second memory, optionally acting as an independent protocol initiator, such as a CXL host, and may utilize translated fields from the CXL.mem transactions received from the first entity for constructing the CXL.mem transactions sent to the second memory. In other examples, the processor may maintain end-to-end transaction contexts of the CXL.mem between the first entity and the second memory, without terminating the CXL.mem transactions, such as by preserving transaction-related identification fields such as Tags, and optionally translating other fields such as address.

In environments comprising hosts and devices that may utilize different CXL domains, while requiring coordinated access to shared resources, there may be scenarios where a first entity that communicates utilizing CXL.mem needs to access resources associated with a second entity that communicates utilizing CXL.io, wherein the first and second entities may operate with different address spaces. Translations between CXL.mem messages and CXL.io messages may facilitate memory reads, memory writes, and data transfers across different domains while enabling interoperability between entities that cannot communicate directly due to protocol limitations or semantic mismatches. Additionally, CXL.io UIO may provide enhanced capabilities for peer-to-peer communication and fabric-based topologies. UIO transactions may include CDLs that carry QoS telemetry, metadata, or other information that may be translated to DevLoad fields in CXL.mem messages, thereby enabling end-to-end propagation of telemetry information across domain boundaries.

In various implementations, a method for translating between Compute Express Link (CXL) messages, comprising: receiving, from a first entity via a first interface, a CXL.mem Master-to-Subordinate (M2S) request comprising a first opcode, a first Tag, and a first address; translating the CXL.mem M2S request to a CXL.io request comprising a second Tag and a second address; sending, via a second interface, the CXL.io request to a second entity; receiving, from the second entity via the second interface, a CXL.io completion comprising the second Tag and a data payload; translating the CXL.io completion to a CXL.mem Subordinate-to-Master Data Response (S2M DRS) comprising a second opcode, the first Tag, and the data payload; and sending, via the first interface, the CXL.mem S2M DRS to the first entity. The translation process may encompass various aspects of the protocol messages, including opcodes, addresses, Tags, and additional fields, thereby enabling communication between entities that operate according to different CXL protocols. The method may be implemented in hardware, firmware, software, or combinations thereof, and may be performed by various types of devices, such as semiconductor devices, switches, bridges, RPUs, Fabric Processing Units (FPUs), Fabric NICs, or other suitable intermediary components. The first interface may expose the computer, which operates as the translating device, as a CXL Type-2 or Type-3 device to the first entity, while the second interface may expose the computer as a CXL device or CXL host to the second entity, depending on system configuration. The elements may communicate through one or more intermediary components, such as a switch, a retimer, or other suitable entity that facilitates information transfer. The Tag translations may involve maintaining a bidirectional mapping between the CXL.mem-side and CXL.io-side transaction identifiers, wherein such mapping may be stored in a translation table, a tracker entry, or similar data structure to enable proper translations of responses with their corresponding requests. The first and second addresses may indicate the same address or indicate different addresses.

In some implementations of the method, the CXL.io request comprises a CXL.io Unordered Input/Output (UIO) Memory Read (UIOMRd) request, the CXL.io completion comprises a CXL.io Unordered Input/Output (UIO) Read Completion with Data (UIORdCplD) comprising a CXL DevLoad (CDL), and the CXL.mem S2M DRS comprises a DevLoad. CXL.io UIO may enable fabric-based topologies with multiple paths between source and destination. UIO may be utilized when the entire path from requester to completer uses Flit Mode, supports UIO, and has UIO enabled. The UIOMRd request type may be selected when the second entity supports UIO capabilities, or when the system topology benefits from the ordering flexibility provided by UIO semantics. The CDL in the UIORdCplD completion may carry information populated by the second entity or by intermediate components along the data path, and this information may be propagated to the first entity via the DevLoad in the CXL.mem S2M DRS message.

In some implementations of the method, translating the CXL.io completion to the CXL.mem S2M DRS comprises translating information carried in the CDL to the DevLoad. The translation of information from the CDL to the DevLoad may involve direct copying, format conversion, or semantic translation depending on the encoding schemes utilized by the CXL.io and CXL.mem. The CDL may utilize a multi-bit encoding that represents various categories of information, and the DevLoad may utilize a corresponding or different encoding scheme. The translation logic may apply mapping functions, lookup tables, or algorithmic transformations to convert between these encodings while preserving the meaning of the carried information.

In some implementations of the method, the information carried in the CDL comprises information selected from at least one of: Quality-of-Service (QoS) telemetry, metadata, or throttling information. The QoS telemetry information may include bandwidth utilization metrics, latency measurements, congestion indicators, or other performance-related data that may assist the first entity in making scheduling or resource allocation decisions. The metadata may include information about the data payload, the second entity, the traversed path, or other contextual information that may be useful for system management or optimization. The throttling information may indicate back-pressure conditions, credit availability, or flow control state that may cause the first entity to modulate its request rate. Additionally or alternatively, the computer may populate the DevLoad with telemetry information, metadata, or throttling information collected or generated by the computer itself, independent of the CDL content received from the second entity.

In some implementations of the method, the first address is associated with a first physical address space utilized by the first entity, the second address is associated with a second physical address space utilized by the second entity, and wherein the method further comprises translating the first address to the second address. The address translation may be implemented utilizing lookup tables, page tables, hash tables, base-and-offset calculations, range-based mapping, and/or programmable translation functions. The first and second address spaces may have different sizes, different base addresses, different memory layouts, or different granularities, and the translation may accommodate these differences while maintaining the meaning of the memory operations.

In some implementations of the method, the first entity comprises a first CXL host, the second entity comprises a second CXL host or a CXL device, the first opcode comprises MemRd*, the CXL.io request comprises a CXL.io Memory Read (MRd) request, and the CXL.io completion comprises a CXL.io Completion with Data (CplD). The standard CXL.io MRd and CplD transaction types may be utilized when the second entity does not support UIO, when UIO is not enabled along the path, or when standard CXL.io is preferred. The CplD completion may not include a CDL, and accordingly the computer may populate the DevLoad in the CXL.mem S2M DRS with locally generated information, or may set the DevLoad to a default or null value.

In some implementations, the method further comprises receiving, from the first entity via the first interface, a CXL.mem M2S request with data (RwD) comprising a third opcode, a third Tag, a third address, and write data; translating the CXL.mem M2S RwD to a CXL.io Memory Write request (MWr) comprising a fourth address and the write data; sending, via the second interface, the CXL.io MWr to the second entity; and sending, via the first interface to the first entity, a CXL.mem S2M No Data Response (NDR) comprising a completion opcode and the third Tag. The CXL.io MWr may be a posted write transaction that does not require a completion from the second entity, per the PCIe and CXL.io specifications. The computer may generate the CXL.mem S2M NDR completion locally without waiting for acknowledgment from the second entity, thereby potentially reducing write latency as observed by the first entity. The fourth address in the CXL.io MWr may be derived from the third address through address translation. The write data may be transferred from the CXL.mem domain to the CXL.io domain with optional format conversion, alignment adjustment, or byte enable manipulation as required by the respective protocol specifications.

In some implementations of the method, the third opcode comprises a MemWr*, the completion opcode comprises Cmp*, and sending the CXL.mem S2M NDR to the first entity occurs before sending the CXL.io MWr to the second entity. Sending the CXL.mem S2M NDR before sending the CXL.io MWr may enable the first entity to receive early acknowledgment of the write operation, potentially allowing the first entity to proceed with subsequent operations without waiting for the write data to reach the second entity. It may be beneficial in scenarios where write latency as observed by the first entity is more significant than end-to-end write completion guarantees. The computer may buffer the write data internally and may implement mechanisms to handle scenarios where the CXL.io MWr encounters errors or back-pressure from the second entity after the S2M NDR has already been sent to the first entity.

In some implementations of the method, the third opcode comprises a MemWr*, the completion opcode comprises Cmp*, and sending the CXL.mem S2M NDR to the first entity occurs in parallel with or after sending the CXL.io MWr to the second entity. Sending the CXL.mem S2M NDR in parallel with or after sending the CXL.io MWr may provide different trade-offs between latency, buffering, and ordering guarantees. When sent in parallel, the first entity may receive acknowledgment with minimal additional delay beyond the transmission time of the MWr. When sent after the MWr, the computer may wait until the write data has been accepted by the downstream interface or by the second entity before acknowledging to the first entity, potentially providing stronger ordering guarantees at the cost of increased latency and possibly added buffering for storing the context required for generating the CXL.mem S2M NDR. The selection between these timing options may be configurable through device registers, may be determined dynamically based on system conditions, or may be fixed by implementation.

In some implementations, the method further comprises receiving, from the first entity via the first interface, a CXL.mem M2S request with data (RwD) comprising a third opcode, a third Tag, a third address, and write data; translating the CXL.mem M2S RwD to a CXL.io Unordered Input/Output (UIO) Memory Write request (UIOMWr) comprising a fourth Tag, a fourth address, and the write data; sending, via the second interface, the CXL.io UIOMWr to the second entity; receiving, from the second entity via the second interface, a CXL.io Unordered Input/Output (UIO) Write Completion (UIOWrCpl) comprising the fourth Tag; and sending, via the first interface to the first entity, a CXL.mem S2M No Data Response (NDR) comprising a completion opcode and the third Tag. The UIOMWr may be a non-posted write transaction that receives a UIOWrCpl from the second entity, in contrast to standard CXL.io MWr transactions which are posted and do not receive completions. The non-posted nature of UIOMWr may provide end-to-end acknowledgment that the write data has been received by the second entity, which may be beneficial for maintaining ordering guarantees or for implementing synchronization mechanisms. The fourth Tag in the UIOMWr may be generated by the computer to track the outstanding write transaction, and may be different from the third Tag used in the CXL.mem domain.

In some implementations of the method, the CXL.io UIOWrCpl further comprises a CXL DevLoad (CDL), and the CXL.mem S2M NDR further comprises a DevLoad populated based on information carried in the CDL. The CDL in the UIOWrCpl may carry information populated by the second entity to indicate write completion status, QoS telemetry, or other metadata associated with the completed write operation. The computer may translate this information to the DevLoad in the CXL.mem S2M NDR, thereby propagating completion-related information back to the first entity. This end-to-end propagation of telemetry information may enable the first entity to make informed decisions about subsequent write operations, resource allocation, or flow control based on conditions observed at the second entity.

In some implementations, the method further comprises receiving, from a third entity via a third interface, a CXL.io request comprising a third Tag and a third address; translating the CXL.io request to a CXL.mem M2S request comprising a third opcode, a fourth Tag, and a fourth address; sending, via a fourth interface, the CXL.mem M2S request to a fourth entity; receiving, from the fourth entity via the fourth interface, a CXL.mem S2M DRS comprising the fourth Tag and a second data payload; translating the CXL.mem S2M DRS to a CXL.io completion comprising the third Tag and the second data payload; and sending, via the third interface, the CXL.io completion to the third entity. The bidirectional translation capability may enable the computer to serve as a multi-port bridge between CXL.mem and CXL.io domains, supporting transactions initiated from either protocol domain. In some examples, the third and fourth entities may be the same as or different from the first and second entities, depending on system topology and configuration. In some examples, the first interface may communicate with CXL.mem-capable entities, and the second interface may communicate with CXL.io-capable entities, wherein the computer may handle translations in both directions. The bidirectional capability may be particularly beneficial in fabric-attached memory architectures where devices and hosts with different protocol capabilities require mutual access to shared resources.

In computing systems utilizing CXL protocols, a computer may translate between CXL.mem and CXL.io to enable interoperability, such as between entities that communicate according to different CXL protocols, or between entities that may not be able to communicate according to CXL.mem due to protocol limitations (e.g., communication between two hosts). The computer may include translation logic, tracker entries, and interface circuitry configured to perform protocol translations while maintaining transaction integrity and proper Tag correlation. The computer may be implemented as a standalone device, as part of a switch, as part of a bridge, or as a component within a larger system-on-chip.

In various implementations, a system comprising: a computer coupled to a first interface and a second interface; wherein the first interface is configured to communicate with a first entity according to CXL.mem; wherein the second interface is configured to communicate with a second entity according to CXL.io; and wherein the computer is configured to: receive, via the first interface, a CXL.mem Master-to-Subordinate (M2S) request comprising a first opcode, a first Tag, and a first address; translate the CXL.mem M2S request to a CXL.io request comprising a second Tag and a second address; send, via the second interface, the CXL.io request to the second entity; receive, via the second interface, a CXL.io completion comprising the second Tag and a data payload; translate the CXL.io completion to a CXL.mem Subordinate-to-Master Data Response (S2M DRS) comprising a second opcode, the first Tag, and the data payload; and send, via the first interface, the CXL.mem S2M DRS to the first entity. The system may enable a first entity that utilizes CXL.mem for memory access to communicate with a second entity that utilizes CXL.io. The computer may function as a bridge, a switch component, an RPU, an FPU, or a dedicated translation unit that maintains the applicable state to translate incoming CXL.mem requests to outgoing CXL.io requests, and to translate returning CXL.io completions to the appropriate CXL.mem responses. The first interface may expose the computer as a CXL Type-2 or Type-3 device to the first entity, enabling the first entity to direct CXL.mem transactions to the computer. The second interface may expose the computer as a CXL device or CXL host to the second entity, depending on system requirements. Both interfaces may operate over CXL links, UCIe links, or other suitable interconnects that support the respective protocols.

In some implementations of the system, the CXL.io request comprises a CXL.io Unordered Input/Output (UIO) Memory Read (UIOMRd) request, the CXL.io completion comprises a CXL.io Unordered Input/Output (UIO) Read Completion with Data (UIORdCplD) comprising a CXL DevLoad (CDL), the CXL.mem S2M DRS comprises a DevLoad, and the computer is further configured to translate information carried in the CDL to the DevLoad. The CDL-to-DevLoad translation may propagate QoS telemetry, metadata, or throttling information from the CXL.io domain to the CXL.mem domain.

In some implementations of the system, the computer comprises tracker entries, each configured to store state information for a pending transaction including a mapping between the first Tag from the CXL.mem M2S request and the second Tag for the CXL.io request; and wherein the first interface exposes the computer as a CXL Type-2 device or a CXL Type-3 device to the first entity. The tracker entries may enable the computer to correlate incoming CXL.io completions with their corresponding CXL.mem M2S requests, enabling correct restoration of Tags when translating completions back to the CXL.mem domain. The tracker entries may support concurrent transactions, with each entry tracking a separate pending operation. Each tracker entry may additionally store address information, transaction type, expected completion size, and other state information utilized for proper translation and error handling. Moreover, exposing the computer as a CXL Type-2 or Type-3 device may enable the first entity to direct CXL.mem transactions to the computer utilizing standard device enumeration and addressing mechanisms. A CXL Type-2 device exposure may be utilized when the computer also supports CXL.cache transactions, while a CXL Type-3 device exposure may be utilized when the computer functions primarily as a memory expander or a memory pool from the perspective of the first entity.

In some implementations of the system, the computer is further configured to: receive, via the first interface, a CXL.mem M2S request with data (RwD) comprising a third opcode, a third Tag, a third address, and write data; translate the CXL.mem M2S RwD to a CXL.io Unordered Input/Output (UIO) Memory Write request (UIOMWr) comprising a fourth Tag, a fourth address, and the write data; send, via the second interface, the CXL.io UIOMWr to the second entity; receive, via the second interface, a CXL.io Unordered Input/Output (UIO) Write Completion (UIOWrCpl) comprising the fourth Tag and a CXL DevLoad (CDL); translate the CXL.io UIOWrCpl to a CXL.mem S2M No Data Response (NDR) comprising a completion opcode, the third Tag, and a DevLoad populated based on information carried in the CDL; and send, via the first interface, the CXL.mem S2M NDR to the first entity. The UIO write path may provide end-to-end acknowledgment and telemetry propagation for write transactions.

In heterogeneous computing systems, devices such as GPUs, NICs, DMA engines, and accelerators may initiate memory transactions based on CXL.io to access memory resources managed by other devices such as memory expanders, memory pools, or Global Fabric-Attached Memory Devices (GFDs) that communicate based on CXL.mem. Translations between CXL.io requests and CXL.mem requests may enable such device-to-device communication while accommodating differences in transaction granularity, ordering, and protocol capabilities. The translation from CXL.io to CXL.mem may involve splitting larger CXL.io transactions into cacheline-sized CXL.mem transactions, aggregating data from CXL.mem responses into CXL.io completions, or trimming data payloads to match requested lengths. Additionally, the computer may initiate speculative memory reads to data that the first entity is likely to request, thereby potentially reducing read latency and improving overall system throughput.

In various implementations, a method for translating between Compute Express Link (CXL) messages, comprising: receiving, from a first entity via a first interface, a CXL.io request comprising a first Tag and a first address; translating the CXL.io request to a CXL.mem Master-to-Subordinate (M2S) request comprising a second Tag and a second address; sending, via a second interface, the CXL.mem M2S request to a second entity; receiving, from the second entity via the second interface, a CXL.mem Subordinate-to-Master Data Response (S2M DRS) comprising the second Tag and data; translating the CXL.mem S2M DRS to a CXL.io completion comprising the first Tag and the data; and sending, via the first interface, the CXL.io completion to the first entity. The translation process may enable entities that utilize CXL.io for memory access to communicate with entities that expose memory resources utilizing CXL.mem. The computer may function as a bridge, a switch component, or a dedicated translation unit that maintains the applicable state to translate incoming CXL.io requests to outgoing CXL.mem requests, and to translate returning CXL.mem responses to the appropriate CXL.io completions. The first interface may communicate with the first entity based on CXL.io, while the second interface may communicate with the second entity based on CXL.mem, wherein both interfaces may operate over CXL links, UCIe links, or other suitable interconnects. The method may be implemented in hardware, firmware, software, or combinations thereof, and may be performed by various types of devices comprising a computer, such as CXL switches, bridges, or semiconductor devices incorporating translation logic. The Tag translations may involve maintaining a mapping between CXL.io Tags utilized by the first entity and CXL.mem Tags utilized for communication with the second entity.

In some implementations of the method, the CXL.io request comprises a CXL.io Unordered Input/Output (UIO) Memory Read (UIOMRd) request, and the CXL.io completion comprises a CXL.io Unordered Input/Output (UIO) Read Completion with Data (UIORdCplD). The UIO transaction types may be utilized when the first entity supports UIO capabilities and when the path between the first entity and the computer has UIO enabled. The UIOMRd request type may provide ordering flexibility that enables more efficient utilization of fabric bandwidth in topologies with multiple paths between source and destination. The UIORdCplD completion may include a CDL that the computer may populate with information collected from the CXL.mem domain, from the computer itself, or from intermediate components.

In some implementations, the method further comprises sending to the second entity, via the second interface, a CXL.mem M2S request comprising MemSpecRd. The speculative memory read may be initiated by the computer to facilitate the readiness of data from the second entity before, or without, the first entity explicitly requesting that data. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. MemSpecRd may indicate to the second entity that the request is speculative in nature, which may affect caching behavior, priority handling, and/or error reporting at the second entity. Additionally or alternatively, the computer may issue prefetch read targeting the second entity. Data returned in response to prefetch reads may be buffered by the computer and may be utilized to satisfy subsequent requests from the first entity, potentially reducing observed read latency.

In some implementations of the method, the first address is associated with a first physical address space utilized by the first entity, the second address is associated with a second physical address space utilized by the second entity, and wherein the method further comprises translating the first address to the second address. The address translation may accommodate scenarios where the first entity and the second entity utilize different physical address spaces. The translation may be implemented utilizing lookup tables, page tables, base-and-offset calculations, or programmable translation functions.

In some implementations of the method, the first entity comprises at least one of a GPU, a Network Interface Card (NIC), or a DMA engine; wherein the second entity comprises at least one of a CXL memory expander, a CXL memory pool, or a Global Fabric-Attached Memory Device (GFD); wherein the CXL.io request comprises a CXL.io Memory Read (MRd) request; and wherein the CXL.io completion comprises a CXL.io Completion with Data (CplD). GPUs may utilize CXL.io memory reads to access large memory pools for workloads such as graphics rendering, machine learning inference, or general-purpose GPU computing workloads. NICs may utilize CXL.io memory reads to access memory buffers for network packet processing, RDMA, or storage traffic handling. DMA engines may utilize CXL.io memory reads to transfer data between memory regions on behalf of other system components. The second entity may expose memory resources that are implemented using various memory technologies such as DDR5, DDR4, HBM, persistent memory, or combinations thereof. A GFD may provide fabric-attached memory resources that are accessible by multiple devices in the system.

In some implementations of the method, translating the CXL.io request to the CXL.mem M2S request comprises translating the CXL.io request to CXL.mem M2S requests, and wherein the method further comprises aggregating data from CXL.mem S2M DRS responses into the CXL.io completion. CXL.io transactions may request data payloads larger than the cacheline size supported by CXL.mem transactions. For example, a CXL.io request for a 256-byte data payload may be translated to four CXL.mem requests each carrying a 64-byte cacheline-sized payload. The computer may track the outstanding CXL.mem requests and may aggregate the returned data into a CXL.io completion, or into CXL.io completions as permitted by CXL.io. The aggregation may involve buffering data from multiple responses, ordering the data according to address sequence, and formatting the aggregated data according to CXL.io completion requirements.

In some implementations, the method further comprises receiving, from a third entity via a third interface, a CXL.mem M2S request comprising a first opcode, a third Tag, and a third address; translating the CXL.mem M2S request to a CXL.io request comprising a fourth Tag and a fourth address; sending, via a fourth interface, the CXL.io request to a fourth entity; receiving, from the fourth entity via the fourth interface, a CXL.io completion comprising the fourth Tag and a data payload; translating the CXL.io completion to a CXL.mem S2M DRS comprising a second opcode, the third Tag, and the data payload; and sending, via the third interface, the CXL.mem S2M DRS to the third entity. The bidirectional translation capability may enable the computer to serve as a multi-port bridge between CXL.io and CXL.mem domains, supporting transactions initiated from either protocol domain. In some examples, the third and fourth entities may be the same as or different from the first and second entities, depending on system topology and configuration. In some examples, the first interface may communicate with CXL.io-capable entities, and the second interface may communicate with CXL.mem-capable entities, wherein the computer may handle translations in both directions. The bidirectional capability may be particularly beneficial in fabric-attached memory architectures where devices and hosts with different protocol capabilities require mutual access to shared resources.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In computing systems utilizing CXL protocols, a computer may translate between CXL.io and CXL.mem to enable interoperability between entities that communicate according to different CXL protocols. The computer may include translation logic, tracker entries, aggregation logic, and interface circuitry configured to perform protocol translations while maintaining transaction integrity and proper Tag correlation. The computer may be implemented as a standalone device, as part of a switch, as part of a bridge, or as a component within a larger system-on-chip.

In various implementations, a system comprising: a computer coupled to a first interface and a second interface; wherein the first interface is configured to communicate with a first entity according to CXL.io; wherein the second interface is configured to communicate with a second entity according to CXL.mem; and wherein the computer is configured to: receive, via the first interface, a CXL.io request comprising a first Tag and a first address; translate the CXL.io request to a CXL.mem Master-to-Subordinate (M2S) request comprising a second Tag and a second address; send, via the second interface, the CXL.mem M2S request to the second entity; receive, via the second interface, a CXL.mem Subordinate-to-Master Data Response (S2M DRS) comprising the second Tag and data; translate the CXL.mem S2M DRS to a CXL.io completion comprising the first Tag and the data; and send, via the first interface, the CXL.io completion to the first entity. The system may enable a first entity that utilizes CXL.io for memory access to communicate with a second entity that exposes memory resources utilizing CXL.mem. The computer may function as a bridge, a switch component, an RPU, an FPU, or a dedicated translation unit that maintains the applicable state to translate incoming CXL.io requests to outgoing CXL.mem requests, and to translate returning CXL.mem responses to the appropriate CXL.io completions. The first interface may communicate with the first entity based on CXL.io, supporting standard MRd/CplD transactions or UIO transactions such as UIOMRd/UIORdCplD. The second interface may communicate with the second entity based on CXL.mem, supporting M2S requests and S2M DRS messages. Both interfaces may operate over CXL links, UCIe links, or other suitable interconnects that support the respective protocols. The computer may be included in a switch, a bridge, or a standalone translation device.

In some implementations of the system, the CXL.io request comprises a CXL.io Unordered Input/Output (UIO) Memory Read (UIOMRd) request, the CXL.io completion comprises a CXL.io Unordered Input/Output (UIO) Read Completion with Data (UIORdCplD) comprising a CXL DevLoad (CDL), the CXL.mem S2M DRS comprises a DevLoad, and the computer is further configured to translate information carried in the DevLoad to the CDL. The DevLoad-to-CDL translation may propagate QoS telemetry, metadata, or throttling information from the CXL.mem domain to the CXL.io domain.

In some implementations of the system, the second entity is coupled to a first memory comprising a first DDR version, wherein the first entity is coupled to a second memory comprising a second DDR version different from the first DDR version, and wherein the computer is configured to translate addresses between a first address space associated with the first entity and a second address space associated with the second entity. The system may enable memory tiering across different DDR generations, wherein a host coupled to a higher-performance memory tier may access a lower-performance memory tier through the translation provided by the computer. The address translation may map addresses within the first entity's address space to corresponding addresses within the second entity's address space, enabling transparent access to the tiered memory resources. The memory tiering may be utilized for capacity expansion, cost optimization, Total Cost of Ownership (TCO) reduction, or workload-specific memory allocation strategies. The computer may expose the second entity's memory resources as an additional memory tier accessible by the first entity, potentially extending the total addressable memory capacity available to the first entity without requiring direct support for the second DDR version.

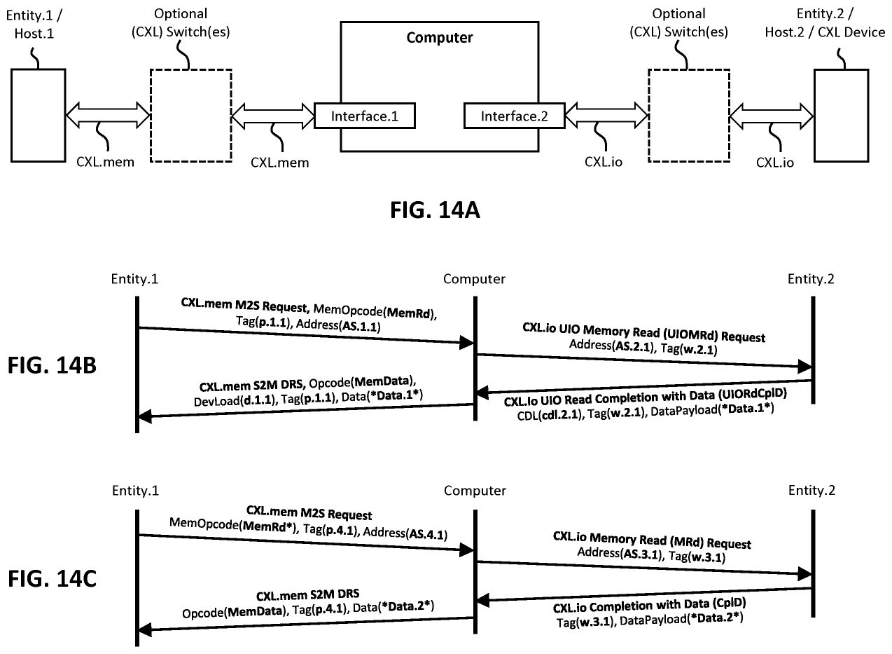

FIG. 14A illustrates an example of a system comprising a computer coupled between first and second interfaces. The first interface (Interface.1) may expose a CXL device, such as a CXL type-2 device or a CXL type-3 device, and communicate according to CXL.mem with a first entity (Entity.1), such as a first host (Host.1). The second interface may expose a CXL device, such as a CXL type-1/2/3 device, and communicate according to CXL.io with a second entity (Entity.2), such as a second host (Host.2). Alternatively, the second interface may expose a CXL host, and may further communicate according to CXL.io with a CXL device. The computer may extract physical addresses within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and/or between the second interface and the second entity.

FIG. 14B illustrates an example of a TFD demonstrating translations, optionally performed by a computer, between CXL.mem requests received from a first entity (Entity.1), such as a first host (Host.1), and CXL.io requests sent to a second entity (Entity.2), such as a second host (Host.2) or a CXL device, possibly enabling the first entity to access resources mapped to an address space utilized by the second entity. The translations may further include address translations between physical addresses carried in the CXL.mem requests received from the first entity and physical addresses carried in the CXL.io requests sent to the second entity. The first entity may initiate a CXL.mem transaction, which may include a CXL.mem M2S request comprising MemOpcode(MemRd), Tag(p.1.1), and Address(AS.1.1). The computer may translate the CXL.mem transaction to a CXL.io transaction, which may include a CXL.io Unordered Input/Output Memory Read (UIOMRd) request comprising Address(AS.2.1) and Tag(w.2.1), and may send the CXL.io UIOMRd to the second entity. Upon receiving a response or completion from the second entity, which may include a CXL.io UIO Read Completion with Data (UIORdCplD) comprising CDL(cdl.2.1), Tag(w.2.1), and DataPayload(*Data.1*), the computer may translate the CXL.io UIORdCplD to a CXL.mem S2M DRS comprising Opcode(MemData), DevLoad(d.1.1), Tag(p.1.1), and Data(*Data.1*) and may send the CXL.mem S2M DRS to the first entity. The CDL in the CXL.io UIORdCplD may be populated, by the second entity, with information related to QoS, such as QoS telemetry value or values. The computer may translate the information carried in the CDL of the UIORdCplD completion received from the second entity, and populate the translated information in the DevLoad of the CXL.mem S2M DRS message sent to the first entity. Additionally or alternatively, the computer may populate DevLoad of CXL.mem S2M messages with telemetry information, metadata, or other types of information collected by the computer, or may utilize the DevLoad of CXL.mem S2M messages to throttle CXL.mem requests from the first entity. The computer may perform further translations, such as protocol translations, opcode translations, command translations, TLP type translations, or field translations, such as Tag translations, between messages conforming to CXL.mem and TLPs conforming to CXL.io.

FIG. 14C illustrates an example of a TFD demonstrating translations between CXL.mem requests received from a first entity (Entity.1), such as a first host (Host.1), and CXL.io requests sent to a second entity (Entity.2), such as a second host (Host.2) or a CXL device. The translations may enable the first entity to access resources mapped to an address space utilized by the second entity. The translations may further include address translations between physical addresses carried in the CXL.mem requests received from the first entity and physical addresses carried in the CXL.io requests sent to the second entity. The first entity may initiate a CXL.mem transaction that includes a CXL.mem M2S request comprising MemOpcode(MemRd*), Tag(p.4.1), and Address(AS.4.1). The computer may translate the CXL.mem transaction to a CXL.io transaction, which may include a CXL.io Memory Read (MRd) request comprising Address(AS.3.1) and Tag(w.3.1), and may send the CXL.io MRd to the second entity. Upon receiving a response or completion from the second entity, which may include a CXL.io Completion with Data (CplD) comprising Tag(w.3.1) and DataPayload(*Data.2*), the computer may translate the CXL.io CplD to a CXL.mem S2M DRS comprising Opcode(MemData), Tag(p.4.1), and Data(*Data.2*), and may send the CXL.mem S2M DRS to the first entity. The computer may perform further translations, such as protocol translations, opcode translations, command translations, TLP type translations, or field translations, such as Tag translations, between messages conforming to CXL.mem and TLPs conforming to CXL.io.

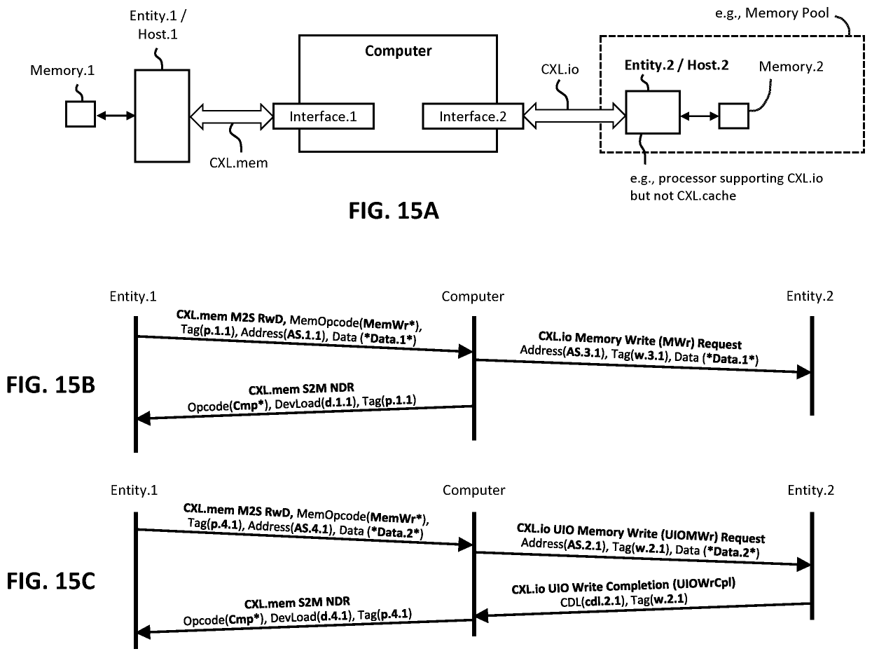

FIG. 15A illustrates an example of a system comprising a computer coupled between a first interface (Interface.1) and a second interface (Interface.2). The first interface may expose a CXL device, such as a CXL type-2 device or a CXL type-3 device, and may further communicate according to CXL.mem with a first entity (Entity.1), such as a first host (Host.1). The second interface may expose a CXL device, and may further communicate according to CXL.io with a second entity (Entity.2), such as a second host (Host.2). The computer may extract physical addresses carried within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification.

The system may further include a memory pool comprising the second entity and a second memory, wherein the computer may utilize the memory pool to expose the second memory to the first entity which may be coupled to a first memory. In some examples, the second entity may not support CXL.cache, or may be configured not to support CXL.cache, potentially preventing the computer from utilizing CXL.cache for accessing the second memory. In some examples, the second entity may include a CXL-enabled processor that does not support CXL.cache, such as an early-generation processor configured to support a subset of CXL protocols such as CXL.io and CXL.mem, but not CXL.cache, wherein the CXL-enabled processor may enable the computer to access the second memory by utilizing CXL.io.

FIG. 15B illustrates an example of a TFD demonstrating translations between CXL.mem requests received from a first entity (Entity.1), such as a first host (Host.1), and CXL.io requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the CXL.io requests sent to the second entity. The first entity may initiate a CXL.mem transaction, which may include a CXL.mem M2S request with data (RwD) comprising MemOpcode(MemWr*), Tag(p.1.1), Address(AS.1.1), and Data (*Data.1*). The computer may translate the CXL.mem M2S RwD transaction to a CXL.io transaction, which may include a CXL.io Memory Write request (MWr) comprising Address(AS.3.1), Tag(w.3.1), and Data (*Data.1*), and may send the CXL.io MWr to the second entity. In some examples, the CXL.io MWr may be a posted write that may not be followed by a response or completion from the second entity.

The computer may respond to the CXL.mem M2S RwD received from the first entity with a CXL.mem S2M NDR comprising Opcode(Cmp*), DevLoad(d.1.1), and Tag(p.1.1), wherein the computer may send the CXL.mem S2M NDR to the first entity before sending the CXL.io MWr to the second entity. Alternatively, the computer may send the CXL.mem S2M NDR to the first entity in parallel to sending the CXL.io MWr to the second entity, or the computer may send the CXL.mem S2M NDR to the first entity after sending the CXL.io MWr to the second entity. The computer may further populate the DevLoad of the CXL.mem S2M NDR with telemetry information, metadata, or other types of information collected or generated by the computer, or may utilize the DevLoad of the CXL.mem S2M NDR to throttle CXL.mem requests from the first entity. The computer may perform further translations, such as protocol translations, opcode translations, command translations, TLP type translations, or field translations, such as Tag translations, between messages conforming to CXL.mem and TLPs conforming to CXL.io.

FIG. 15C illustrates an example of a TFD demonstrating translations between CXL.mem requests received from a first entity (Entity.1), such as a first host (Host.1), and CXL.io UIO requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the CXL.io UIO requests sent to the second entity. The first entity may initiate a CXL.mem transaction that may include a CXL.mem M2S request with Data (M2S RwD) comprising MemOpcode(MemWr*), Tag(p.4.1), Address(AS.4.1), and Data (*Data.2*). The computer may translate the CXL.mem M2S RwD transaction to a CXL.io transaction, which may include a CXL.io UIO Memory Write request (UIOMWr) comprising Address(AS.2.1), Tag(w.2.1), and Data (*Data.2*). The computer may send the CXL.io UIO UIOMWr to the second entity. Upon receiving a response or completion from the second entity, which may include a CXL.io UIO Write Completion (UIOWrCpl) comprising CDL(cdl.2.1) and Tag(w.2.1), the computer may translate the CXL.io UIO UIOWrCpl to a CXL.mem S2M No Data Response (S2M NDR) comprising Opcode(Cmp*), DevLoad(d.4.1), and Tag(p.4.1), and may send the CXL.mem S2M NDR to the first entity.

The CDL in the CXL.io UIO UIOWrCpl may be populated by the second entity with information such as QoS telemetry. The computer may translate the information carried in the CDL of the CXL.io UIOWrCpl received from the second entity, and populate the translated information in the DevLoad of the CXL.mem S2M NDR sent to the first entity. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity.

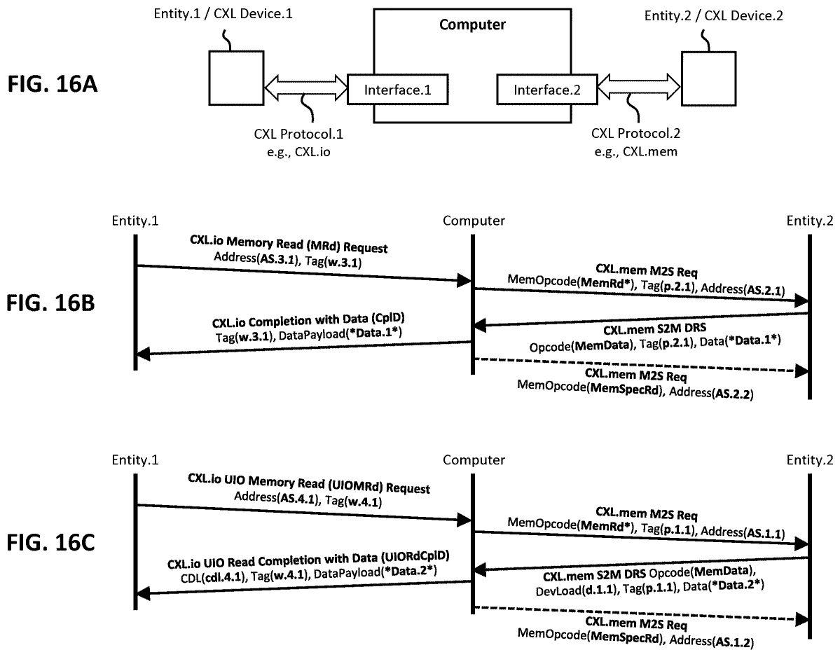

FIG. 16A illustrates an example of a system comprising a computer coupled between a first interface (Interface.1) and a second interface (Interface.2). The first interface may communicate according to a first CXL protocol, such as CXL.io, with a first entity (Entity.1), such as a first CXL device (Device.1) which may be a GPU, an RDMA NIC, an NVMe storage device, or a CXL device that may utilize DMA transfers larger than a cacheline over CXL.io. The second interface may communicate according to a second CXL protocol, such as CXL.mem, with a second entity (Entity.2), such as a second CXL device (Device.2), which may be a CXL memory expander, a CXL memory pool, a GFD, or a CXL device that may utilize cacheline-sized memory transfers over CXL.mem. The computer may be included in a switch (such as a CXL switch) or a bridge. The computer may extract physical addresses from messages received via the first interface, wherein these addresses may refer to a first Physical Address (PA) space utilized by the first entity; translate these addresses; and generate messages carrying the translated physical addresses for transmission via the second interface; wherein these translated addresses may refer to a second PA space utilized by the second entity. In some examples, the first PA space and the second PA space may be the same PA space, wherein the computer may perform address translations between addresses within the same PA space. The computer may perform further translations between the first CXL domain and the second CXL domain, such as translating between CXL.io TLP types (e.g., MRd, UIOMRd) and CXL.mem opcodes (e.g., MemRd, MemRdData, MemRdTEE). The computer may be implemented as a monolithic die, as one or more chiplets within an IC package, or as one or more components on a board. In some examples, the computer, and at least one of the first or second entities may be included within the same IC package, optionally coupled by one or more UCIe links.

FIG. 16B illustrates an example of a TFD demonstrating translations, performed by a computer, between CXL.io TLPs that may be utilized for communicating with a first entity (Entity.1), and CXL.mem messages that may be utilized for communicating with a second entity (Entity.2), possibly enabling the first entity to access resources mapped to an address space utilized by the second entity. The first entity, such as a first CXL device (Device.1) which may be a GPU, may initiate a CXL.io transaction that may include a CXL.io Memory Read (MRd) request comprising Address(AS.3.1) and Tag(w.3.1). The computer may translate the CXL.io transaction to a CXL.mem transactions that may include a CXL.mem M2S request comprising MemOpcode(MemRd*), Tag(p.2.1), and Address(AS.2.1), and may send the CXL.mem M2S request to the second entity, such as a second CXL device (Device.2) which may be a CXL memory expander. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to a CXL.io Completion with Data (CplD) comprising Tag(w.3.1) and DataPayload(*Data.1*), and send the CXL.io CplD to the first entity.

In some examples, depending on the length of the requested data payload in the CXL.io transaction, the computer may translate the CXL.io transaction to one or more CXL.mem transactions that each may carry a cacheline-sized data payload, wherein the computer may aggregate data from CXL.mem responses into one or more CXL.io completions, or may trim data carried in CXL.mem responses to match the CXL.io request. Thus, for example, the computer may translate a CXL.io transaction requesting a 256 B data payload to four CXL.mem transactions each carrying a 64 B payload, wherein the computer may aggregate the four 64 B responses into a CXL.io completion carrying 256 B. In another example, the computer may translate a CXL.io transaction requesting a data payload smaller than a cacheline size (e.g., 1 B), to a single CXL.mem transaction, and may trim the data payload returned by the CXL.mem response to the requested length in the CXL.io request, optionally aligning the data to native boundaries required by the specifications, such as aligning to DW boundaries.

Furthermore, the computer may perform translations, such as protocol translations, opcode translations, command translations, TLP translations, or PDU translations, e.g., translating between CXL.io TLPs and CXL.mem messages, wherein these translations may include field translations, such as translating between CXL.io Tags and CXL.mem Tags, translating between reserved fields, and translating between reserved and non-reserved fields. The computer may further initiate speculative memory reads targeting the second entity, wherein the speculative memory reads may include a CXL.mem M2S Req comprising MemOpcode(MemSpecRd) and Address(AS.2.2), and wherein the computer may utilize the speculative memory reads, optionally on behalf of the first entity, to facilitate data prefetches and potentially reduce read latency from the second entity.

FIG. 16C illustrates an example of a TFD demonstrating translations between CXL.io UIO TLPs that may be utilized for communicating with a first entity (Entity.1), and CXL.mem messages that may be utilized for communicating with a second entity (Entity.2), possibly enabling the first entity to access resources mapped to an address space utilized by the second entity. The first entity, such as a first CXL device (Device.1) which may be a GPU, a Network Interface Card (NIC), or a DMA engine, may initiate a CXL.io UIO transaction that may include a CXL.io UIO Memory Read (UIOMRd) request comprising Address(AS.4.1) and Tag(w.4.1). The computer may translate the CXL.io UIO transaction to a CXL.mem transaction that may include a CXL.mem M2S request comprising MemOpcode(MemRd*), Tag(p.1.1), and Address(AS.1.1), and may send the CXL.mem M2S request to the second entity, such as a second CXL device (Device.2) which may be a CXL memory expander, a memory pool, a GFD, or a CXL accelerator. Upon receiving one or more responses from the second entity, which may include a CXL.mem S2M DRS comprising Opcode(MemData), DevLoad(d.1.1), Tag(p.1.1), and Data(*Data.2*), the computer may translate the one or more responses, such as translating the CXL.mem S2M DRS to a CXL.io UIO Read Completion with Data (UIORdCplD) comprising CDL(cdl.4.1), Tag(w.4.1) and DataPayload(*Data.2*), and send the CXL.io UIORdCplD to the first entity.

The second entity may populate DevLoad of CXL.mem S2M messages, such as CXL.mem S2M DRS messages, with telemetry information, metadata, or other types of information collected or generated by the second entity, or may utilize the DevLoad of CXL.mem S2M messages to throttle CXL.mem requests from the computer, possibly enabling the second entity to control, limit, shape, or throttle the rate of data communications between the computer and the second entity. The computer may translate the information carried in DevLoad of CXL.mem S2M messages received from the second entity, and may populate the translated information in the CDL of the CXL.io UIORdCplD sent to the first entity. Additionally or alternatively, the computer may populate the CDL of the CXL.io UIORdCplD with telemetry information, metadata, or other types of information collected or generated by the computer, or may utilize the CDL to throttle requests from the first entity.

In some examples, depending on the length of the requested data payload in the CXL.io UIO transaction, the computer may translate the CXL.io UIO transaction to one or more CXL.mem transactions that each may carry a cacheline-sized data payload, wherein the computer may aggregate data from multiple CXL.mem responses into one or more CXL.io UIO completions, or may trim data carried in CXL.mem responses to match the CXL.io UIO request. Thus, for example, the computer may translate a CXL.io UIO transaction requesting a 256 B data payload to four CXL.mem transactions each carrying a 64 B payload, wherein the computer may aggregate four 64 B responses into a CXL.io UIO completion carrying 256 B. In another example, the computer may translate a CXL.io UIO transaction requesting a data payload smaller than a cacheline size (e.g., 1 B), to a single CXL.mem transaction, and may trim the data payload returned by the CXL.mem response to the requested length in the CXL.io UIO request, optionally aligning the data to native boundaries required by the specifications, such as aligning to DW boundaries. The computer may perform further translations, such as protocol translations, opcode translations, command translations, TLP translations, or PDU translations, e.g., translating between CXL.io UIO TLPs and CXL.mem messages, wherein these translations may include field translations. The computer may further initiate speculative memory reads targeting the second entity, wherein the speculative memory reads may include a CXL.mem M2S Req comprising MemOpcode(MemSpecRd) and Address(AS.1.2), and wherein the computer may utilize the speculative memory reads, optionally on behalf of the first entity, to facilitate data prefetches and potentially reduce read latency from the second entity.

Heterogeneous computing architectures may incorporate systems wherein entities utilize different protocols while requiring coordinated access to shared resources. In such environments, a first entity operating with CXL.mem may need to access resources coupled to a second entity operating with PCIe. For example, a newer generation server may utilize CXL.mem to access data on a non-CXL server populated with DDR4, where translations between CXL.mem and PCIe enable utilizing the non-CXL server as a memory pool. Translations between CXL.mem messages and PCIe TLPs may facilitate memory operations, data transfers, and resource sharing across different domains while maintaining the requirements of each protocol. Such translations may be performed by a computer, an apparatus, a cable, or other suitable devices positioned between the first entity and the second entity.

In various implementations, a method for translating between Compute Express Link (CXL) messages and Peripheral Component Interconnect Express (PCIe) Transaction Layer Packets (TLPs), comprising: receiving, by a computer from a first entity, a CXL.mem Master-to-Subordinate (M2S) request; translating, by the computer, the CXL.mem M2S request to a PCIe memory request; sending, by the computer to a second entity, the PCIe memory request; receiving, by the computer from the second entity, a PCIe Completion corresponding to the PCIe memory request; translating, by the computer, the PCIe Completion to a CXL.mem Subordinate-to-Master (S2M) response; and sending, by the computer to the first entity, the CXL.mem S2M response. The translation process may encompass various aspects of the protocol messages, including opcodes, addresses, and transaction identifiers, thereby enabling communication between entities that utilize different protocols. The method may be implemented in hardware, firmware, software, or combinations thereof, and may be performed by various types of devices, such as semiconductor devices, RPUs, Fabric Processing Units (FPUs), Fabric NICs, switches, or active cables. The computer may maintain state information, such as pending transaction tables or tracker entries, to correlate incoming PCIe Completions with previously transmitted PCIe memory requests and with pending CXL.mem transactions. Additionally, the elements may communicate through one or more intermediary components, such as a switch, a retimer, or other suitable entity that facilitates information transfer.

In some implementations of the method, the CXL.mem M2S request comprises a first physical address belonging to a first physical address space utilized by the first entity, and wherein translating the CXL.mem M2S request to the PCIe memory request comprises generating the PCIe memory request comprising a second physical address belonging to a second physical address space utilized by the second entity. The address translation may be implemented utilizing lookup tables, page tables, hash tables, base-and-offset calculations, and/or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations of the method, the CXL.mem M2S request comprises MemRd* and a first Tag, the PCIe memory request comprises a non-UIO Memory Read request comprising a second Tag, the PCIe Completion comprises a Completion with Data (CplD) comprising Data, and the CXL.mem S2M response comprises an S2M Data Response (S2M DRS) comprising MemData, the Data, and the first Tag. The computer may maintain a mapping between the first Tag associated with the CXL.mem transaction and the second Tag associated with the PCIe transaction, wherein this mapping may be stored in a tracker entry, a translation table, or similar data structure. Upon receiving the CplD from the second entity, the computer may utilize the second Tag to identify the corresponding pending transaction and retrieve the first Tag for inclusion in the S2M DRS. The non-UIO Memory Read request may conform to non-UIO PCIe memory read semantics as defined in applicable PCIe specifications.

In some implementations, the method further comprises receiving, by the computer from the first entity, a CXL.mem M2S request with Data (M2S RwD) comprising a MemWr* and write data; translating the CXL.mem M2S RwD to a PCIe non-UIO Memory Write request comprising the write data; sending the PCIe non-UIO Memory Write request to the second entity; and sending a CXL.mem S2M No Data Response (S2M NDR) to the first entity. The PCIe non-UIO Memory Write request may be a posted write that may not require a completion from the second entity. The S2M NDR may include Cmp* indicating successful acceptance of the write request by the computer. The computer may include a DevLoad in the S2M NDR to provide telemetry information or to throttle subsequent requests from the first entity.

In some implementations of the method, the computer sends the CXL.mem S2M NDR to the first entity before sending the non-UIO Memory Write request to the second entity. Sending the S2M NDR before the PCIe Memory Write request may reduce latency observed by the first entity and may allow the first entity to proceed with subsequent operations without waiting for the write to propagate to the second entity. The computer may buffer the write data and transmit the PCIe Memory Write request asynchronously, optionally implementing flow control or ordering mechanisms to maintain consistency guarantees.

In some implementations, the method further comprises receiving, by the computer from the first entity, a CXL.mem M2S request with Data (M2S RwD) comprising a MemWr* and write data; translating the CXL.mem M2S RwD to a PCIe UIO Memory Write request (UIOMWr) comprising the write data; sending the PCIe (UIOMWr) to the second entity; receiving, from the second entity, a PCIe UIO Write Completion (UIOWrCpl); and sending a CXL.mem S2M No Data Response (S2M NDR) comprising Cmp* to the first entity. PCIe UIO may provide enhanced capabilities compared to non-UIO PCIe, including support for non-posted writes that return completions. The UIOWrCpl may indicate successful completion of the write operation by the second entity and may carry additional information.

In some implementations of the method, the CXL.mem S2M NDR comprises a DevLoad, and wherein the computer populates the DevLoad with information derived from at least one of the PCIe UIOWrCpl, or telemetry information. In some revisions of the CXL specification, CXL.mem S2M NDR messages may include a DevLoad. The computer may populate the DevLoad of the CXL.mem S2M NDR with information derived from the UIOWrCpl or with telemetry information generated by the computer.

In some implementations of the method, the PCIe UIOWrCpl comprises a CXL DevLoad (CDL) comprising Quality-of-Service (QoS) telemetry, and wherein the computer translates the QoS telemetry carried in the CDL of the PCIe UIOWrCpl to a DevLoad of the CXL.mem S2M NDR, enabling the first entity to receive QoS information originating from the second entity. The CDL may carry telemetry information, such as device load indicators, queue depth information, or latency metrics generated by the second entity. By translating the CDL to the DevLoad, the computer may propagate QoS telemetry across the protocol boundary, enabling the first entity to make informed decisions regarding request pacing, load balancing, or resource allocation based on conditions at the second entity. The translation may involve copying, scaling, adjusting, or mapping of the telemetry values between the CDL and DevLoad field formats.

In some implementations of the method, the CXL.mem M2S request comprises MemRd* and a first Tag, the PCIe memory request comprises a UIO Memory Read (UIOMRd) request comprising a second Tag, the PCIe Completion comprises a UIO Read Completion with Data (UIORdCplD) comprising Data, and the CXL.mem S2M response comprises an S2M Data Response (S2M DRS) comprising MemData, the Data, and the first Tag. The UIOMRd may provide enhanced semantics compared to non-UIO PCIe memory read operations, such as support for out-of-order completions or additional metadata fields. The UIORdCplD may carry the requested data along with status information or telemetry. The computer may extract the data from the UIORdCplD and format it according to CXL.mem S2M DRS requirements for delivery to the first entity.

In some implementations of the method, the CXL.mem S2M response comprises a DevLoad, wherein the computer populates the DevLoad with telemetry information or utilizes the DevLoad to throttle CXL.mem M2S requests from the first entity, wherein the first entity comprises a first host, and wherein the second entity comprises a second host or a PCIe device. The DevLoad may enable the computer to communicate backpressure, congestion indicators, or performance metrics to the first host. The first host may utilize this information to adjust its request rate, implement adaptive flow control, or make scheduling decisions. The second entity may include various types of devices, such as a server, a memory expander, a GPU, a NIC, a storage device, or other PCIe-attached resources.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a first interface configured to communicate with a first entity based on CXL.mem, wherein CXL denotes Compute Express Link; a second interface configured to communicate with a second entity based on Peripheral Component Interconnect Express (PCIe); a computer coupled to the first interface and the second interface, the computer configured to: receive, via the first interface, a CXL.mem Master-to-Subordinate (M2S) request comprising a first physical address belonging to a first physical address space utilized by the first entity; translate the CXL.mem M2S request to a PCIe memory request comprising a second physical address belonging to a second physical address space utilized by the second entity; and send, via the second interface, the PCIe memory request to the second entity. The apparatus may be implemented as a semiconductor device, a card, a module, an active cable, or other suitable form factor. The first interface may expose the apparatus to the first entity as a CXL switch, or as a CXL device, such as a CXL Type-2 device or a CXL Type-3 device. The second interface may expose the apparatus to the second entity as a PCIe switch, as a PCIe device, or as a host via a root port. The computer may include logic for address translation, Tag management, protocol conversion, and transaction tracking. Optionally, the apparatus may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and optional PCIe switch(es) may be positioned between the second interface and the second entity.

In some implementations of the apparatus, the computer is further configured to: receive, via the second interface, a PCIe Completion corresponding to the PCIe memory request; translate the PCIe Completion to a CXL.mem Subordinate-to-Master (S2M) response; and send, via the first interface, the CXL.mem S2M response to the first entity; wherein the first interface exposes to the first entity one of the following: a CXL switch, a CXL Type-2 device, or a CXL Type-3 device; and wherein the second interface exposes to the second entity one of the following: a PCIe switch, a PCIe device, or a root port. When the second interface exposes a root port, the apparatus may function as a host toward the second entity, enabling the apparatus to initiate PCIe transactions to downstream PCIe devices. When the second interface exposes a PCIe device, the apparatus may function as an endpoint toward the second entity, such as when coupled to another host.

In some implementations of the apparatus, the first physical address space comprises the second physical address space. The second physical address space may be a PCIe Memory Address Space, a DMA address space, an IO virtual address (IOVA) space, or a system address space, and may further be a subset of the first physical address space or identical to the first physical address space.

In some implementations of the apparatus, the apparatus comprises a cable including a first module coupled to the first interface, a second module coupled to the second interface, and a physical medium coupling the first module and the second module. The cable may be an active cable that includes the computer for performing protocol and address translations. The first module may include electrical or optical components for communicating with the first entity, and the second module may include electrical or optical components for communicating with the second entity. The cable may conform to various industry standards or specifications, such as those defined by the Optical Internetworking Forum (OIF), the Small Form Factor Committee (SFF), or the IEEE.

In some implementations of the apparatus, the physical medium comprises a twinaxial cable, a multimode fiber (MMF), or a single-mode fiber (SMF); and wherein the cable is configured to couple to the first entity or the second entity via a connector selected from Octal Small Form Factor Pluggable Module (OSFP), Octal Small Form Factor eXtra Dense Pluggable Module (OSFP-XD), Quad Small Form-Factor Pluggable (QSFP), or Quad Small Form-Factor Pluggable Double Density (QSFP-DD). The twinaxial cable may be suitable for shorter reach applications within a rack or between adjacent racks, while fiber options may enable longer reach connectivity. The MMF may be utilized for distances up to several hundred meters, while SMF may be utilized for longer distances. The connector type may be selected based on bandwidth requirements, density considerations, and deployment environment. The cable may be implemented as an Active Optical Cable (AOC) or an Active Copper Cable (ACC) depending on the physical medium utilized.

In various implementations, a system comprising: a first entity coupled to a first memory; a second entity coupled to a second memory, wherein the second entity comprises a Central Processing Unit (CPU) configured to support Peripheral Component Interconnect Express (PCIe) but not Compute Express Link (CXL); and a computer coupled between the first entity and the second entity, the computer configured to: receive, from the first entity, a CXL.mem Master-to-Subordinate (M2S) request; translate the CXL.mem M2S request to a PCIe memory request; send, to the second entity, the PCIe memory request to access the second memory; receive, from the second entity, a PCIe Completion; and send, to the first entity, a CXL.mem Subordinate-to-Master (S2M) response corresponding to the PCIe Completion. The system may enable the first entity to access memory resources coupled to CPUs that do not support CXL, thereby extending the reach of CXL-based memory pooling to include legacy and/or non-CXL infrastructure. The CPU of the second entity may be a processor from a generation that predates CXL support, or may be a processor that uses its CXL capabilities for other purposes. The second memory may be attached to the second entity via memory controllers integrated in the CPU, and the computer may enable the first entity to access this memory utilizing PCIe transactions that the CPU can process.

In some implementations of the system, the second entity and the second memory form a memory pool, and wherein the computer is configured to expose the memory pool to the first entity. The memory pool may appear to the first entity as CXL-attached memory, even though the underlying memory is coupled to a non-CXL CPU. The computer may expose the memory pool by responding to CXL.mem initialization and configuration operations from the first entity and by translating subsequent memory access requests to PCIe transactions directed to the second entity. Multiple second entities and their associated memories may be aggregated into a larger memory pool that the computer exposes to one or more first entities.

In some implementations of the system, the second memory comprises DDR4 memory, and wherein the first memory comprises DDR5 memory. The system may enable tiered memory architectures wherein the first entity utilizes higher-performance memory technologies, such as DDR5, for latency-sensitive operations, while utilizing DDR4 memory coupled to the second entity for capacity-oriented workloads. The computer may enable the first entity to transparently access the DDR4 memory tier utilizing CXL.mem, and memory management software executing on the first entity may place data across tiers based on access patterns, SLA requirements, tenant identities, temperature thresholds, or other policies.

In some implementations of the system, The system of claim 20 wherein the CPU comprises a pre-CXL generation CPU, and the pre-CXL generation CPU is installed in a datacenter server. The pre-CXL generation CPU may include processors that were manufactured or designed before CXL became available, or processors that do not include CXL capability. The datacenter server may be a server that has been decommissioned from primary compute duties but retains functional memory and PCIe connectivity. The system may enable repurposing of such servers as memory pool contributors, thereby extending the useful life of datacenter infrastructure and reducing electronic waste while providing additional memory capacity to CXL-enabled first entities.

In multi-host environments, there may be scenarios where first entities operating with CXL.mem need to access memory or other resources coupled to a second entity operating with PCIe. For example, newer generation servers may utilize CXL.mem to access data on a non-CXL server, where translations between CXL.mem and PCIe enable utilizing the non-CXL server as a shared memory pool. Translations between CXL.mem messages and PCIe TLPs may facilitate memory operations, data transfers, and resource sharing across different protocol domains while maintaining the requirements of each protocol and routing responses to the appropriate requesting entities.

In various implementations, a method for translating between Compute Express Link (CXL) messages and Peripheral Component Interconnect Express (PCIe) Transaction Layer Packets (TLPs), comprising: receiving, by a computer, CXL.mem Master-to-Subordinate (M2S) requests from first entities; translating, by the computer, the CXL.mem M2S requests to PCIe memory requests; sending, by the computer to a second entity, the PCIe memory requests; receiving, by the computer from the second entity, PCIe Completions corresponding to the PCIe memory requests; translating, by the computer, the PCIe Completions to CXL.mem Subordinate-to-Master (S2M) responses; and sending, by the computer, each of the CXL.mem S2M responses to a corresponding one of the first entities. The translation process may encompass various aspects of the protocol messages, including opcodes, addresses, and transaction identifiers, thereby enabling communication between CXL.mem-capable entities and a PCIe-capable entity. The method may be implemented in hardware, firmware, software, or combinations thereof, and may be performed by various types of devices, such as semiconductor devices, RPUs, Fabric Processing Units (FPUs), Fabric NICs, switches, or active cables. The computer may maintain state information to correlate incoming PCIe Completions with previously transmitted PCIe memory requests and with the originating first entities, enabling responses to be routed to the correct requester. The first entities may include hosts, accelerators, GPUs, NICs, or other CXL-capable devices that share access to resources coupled to the second entity. Additionally, the elements may communicate through one or more intermediary components, such as a switch, a retimer, or other suitable entity that facilitates information transfer.

In some implementations of the method, the computer maintains separate tracking structures for each of the first entities, and wherein the computer processes CXL.mem M2S requests received from different ones of the first entities in parallel, by storing transaction information in the respective separate tracking structures. The separate tracking structures may enable the computer to manage outstanding transactions from different first entities without interference. Each tracking structure may store information such as CXL.mem Tags, addresses, opcodes, and timestamps associated with transactions from the corresponding first entity. By maintaining separate structures, the computer may support concurrent processing wherein a CXL.mem M2S request from one first entity may be translated and sent while awaiting a PCIe Completion for a request from another first entity. The tracking structures may be implemented as tables, queues, linked lists, content-addressable memories, or other data structures suitable to associate PCIe Completions with their originating CXL.mem transactions and first entities.

In some implementations of the method, the computer sequentially processes the CXL.mem M2S requests received from the first entities by queuing the CXL.mem M2S requests and translating each queued CXL.mem M2S request in order, wherein the computer completes sending one of the PCIe memory requests before translating a subsequent one of the CXL.mem M2S requests. Sequential processing may be utilized in implementations where simplicity, determinism, and/or resource constraints favor processing one request at a time. The computer may queue incoming CXL.mem M2S requests in a first-in-first-out (FIFO) buffer or other queuing structure and may process each request to completion before beginning the next, which may reduce the complexity of tracking concurrent transactions and may provide predictable ordering of memory operations. Sequential processing may be suitable for scenarios where the first entities have relatively low aggregate request rates or where strict ordering guarantees are desired.

In some implementations of the method, a first one of the first entities utilizes a first Host Physical Address (HPA) space, wherein a second one of the first entities utilizes a second HPA space different from the first HPA space, and wherein translating the CXL.mem M2S requests to the PCIe memory requests comprises translating addresses from the first HPA space and addresses from the second HPA space to corresponding addresses in a physical address space utilized by the second entity. The address translation may accommodate scenarios where different first entities operate with independent HPA spaces that may have overlapping address ranges. The computer may maintain separate translation tables or functions for each first entity, mapping addresses from each first entity's HPA space to non-overlapping regions of the second entity's physical address space. Alternatively, the computer may utilize a unified translation mechanism that incorporates first entity identifiers as part of the address mapping. The second entity's physical address space may be a PCIe Memory Address Space, a system address space, or a DMA address space. The translation may involve base-and-offset calculations, page table lookups, or programmable translation functions.

In some implementations of the method, the computer allocates PCIe Tags for the PCIe memory requests, wherein the computer associates the PCIe Tags with identifiers of the corresponding ones of the first entities, and wherein the computer utilizes the PCIe Tags in the PCIe Completions to identify the corresponding ones of the first entities. PCIe Tags serve as transaction identifiers that enable completers to associate completions with their originating requests. The computer may allocate PCIe Tags from a pool and may record, for each allocated Tag, the identifier of the first entity that originated the corresponding CXL.mem M2S request. When a PCIe Completion arrives, the computer may extract the Tag from the completion, look up the associated first entity identifier, and route the translated CXL.mem S2M response to that first entity. The computer may also maintain a mapping between PCIe Tags and CXL.mem Tags to populate the correct Tag in the S2M response.

In some implementations of the method, the computer detects a timeout condition when a PCIe Completion corresponding to one of the PCIe memory requests is not received within a threshold duration, and wherein responsive to detecting the timeout condition, the computer sends a CXL.mem S2M response comprising an error indication to the corresponding one of the first entities. The timeout detection may provide a mechanism for handling non-responsive or failed transactions, preventing indefinite waiting by the first entities. The computer may associate a timestamp or timer with each outstanding PCIe memory request and may periodically check whether any pending transactions have exceeded the threshold duration. The threshold duration may be configurable and may be selected based on expected latencies, system policies, or protocol requirements. Upon detecting a timeout, the computer may release resources associated with the timed-out transaction, such as allocated Tags or tracking structure entries, and may generate an S2M response with an error opcode to notify the first entity of the failure. The timeout mechanism may also trigger logging, alerting, or error recovery procedures.

In some implementations of the method, at least one of the PCIe Completions comprises an error status indicating an Unsupported Request (UR) or a Completer Abort (CA), and wherein the computer translates the error status to an error indication in a corresponding one of the CXL.mem S2M responses. PCIe defines completion status values that indicate error conditions encountered by the completer. An Unsupported Request (UR) status indicates that the completer does not support the request type or that the request targeted an invalid address range. A Completer Abort (CA) status indicates that the completer encountered an error that prevented completion of the request. Other PCIe completion statuses, such as Configuration Request Retry Status (CRS), may also be translated to appropriate CXL.mem error indications. The computer may map these PCIe error statuses to CXL.mem S2M NDR messages with error opcodes or to S2M DRS messages with poison indicators, depending on the nature of the original request and the error encountered. The translation may preserve error semantics to enable the first entity to take appropriate recovery actions.

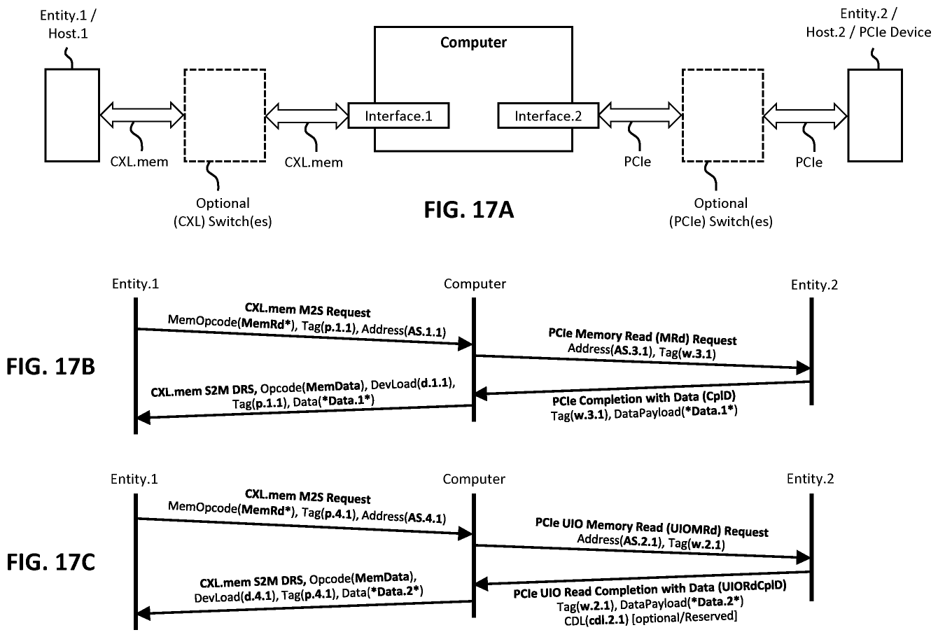

FIG. 17A illustrates an example of a system comprising a computer coupled between a first interface (Interface.1) and a second interface (Interface.2). The first interface may expose a CXL device, such as a CXL type-2 device or a CXL type-3 device, and may communicate according to CXL.mem with a first entity (Entity.1), such as a first host (Host.1). In some examples, the second interface may expose a PCIe device, and may communicate according to PCIe with a second entity (Entity.2), such as a second host (Host.2) or another PCIe device. In other examples, the second interface may expose a root port (RP) and may communicate according to PCIe with a PCIe device. The computer may extract physical addresses within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity. Similarly, optional PCIe switch(es) may be positioned between the second interface and the second entity.

FIG. 17B illustrates an example of a transaction flow diagram (TFD) demonstrating translations, performed by a computer, between CXL.mem requests received from a first entity (Entity.1), such as a first host (Host.1), and PCIe requests sent to a second entity (Entity.2), such as a second host (Host.2) or a PCIe device, possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction that includes a CXL.mem M2S request comprising MemOpcode(MemRd*), Tag(p.1.1), and Address(AS.1.1). The computer may translate the CXL.mem transaction to a PCIe transaction, which may include a PCIe Memory Read (MRd) request comprising Address(AS.3.1) and Tag(w.3.1), and may send the PCIe MRd to the second entity. Upon receiving a response or completion from the second entity, which may include a PCIe Completion with Data (CplD) comprising Tag(w.3.1) and DataPayload(*Data.1*), the computer may translate the PCIe CplD to a CXL.mem S2M DRS comprising Opcode(MemData), DevLoad(d.1.1), Tag(p.1.1), and Data(*Data.1*), and may send the CXL.mem S2M DRS to the first entity. The computer may perform further translations, such as protocol translations, opcode translations, command translations, TLP type translations, or field translations, such as Tag translations, between messages conforming to CXL.mem and TLPs conforming to PCIe. The computer may populate the DevLoad of CXL.mem S2M messages with telemetry information, metadata, or other types of information collected or generated by the computer, or may utilize the DevLoad of CXL.mem S2M messages to throttle CXL.mem requests from the first entity. DevLoad in CXL messages may be optional and may not exist in some revisions of the CXL specification.

FIG. 17C illustrates an example of a TFD demonstrating translations between CXL.mem requests received from a first entity (Entity.1), such as a first host (Host.1), and PCIe requests sent to a second entity (Entity.2), such as a second host (Host.2) or a PCIe device, possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction, which may include a CXL.mem M2S request comprising MemOpcode(MemRd*), Tag(p.4.1), and Address(AS.4.1). The computer may translate the CXL.mem transaction to a PCIe transaction, which may include a PCIe UIO Memory Read (UIOMRd) request comprising Address(AS.2.1) and Tag(w.2.1), and may send the PCIe UIOMRd to the second entity. Upon receiving a response or completion from the second entity, which may include a PCIe UIO Read Completion with Data (UIORdCplD) comprising Tag(w.2.1), DataPayload(*Data.2*), and optionally CDL(cdl.2.1), the computer may translate the PCIe UIORdCplD to a CXL.mem S2M DRS comprising Opcode(MemData), DevLoad(d.4.1), Tag(p.4.1), and Data(*Data.2*) and may send the CXL.mem S2M DRS to the first entity. The optional CDL in the PCIe UIORdCplD, when not reserved, may be populated by the second entity with information such as QoS telemetry. The computer may translate the information carried in the optional CDL of the PCIe UIORdCplD received from the second entity, and populate the translated information in the DevLoad of the CXL.mem S2M DRS sent to the first entity. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity. DevLoad in CXL messages may be optional and may not exist in some revisions of the CXL specification. The computer may perform further translations, such as protocol translations, opcode translations, command translations, TLP type translations, or field translations, such as Tag translations, between messages conforming to CXL.mem and TLPs conforming to PCIe.

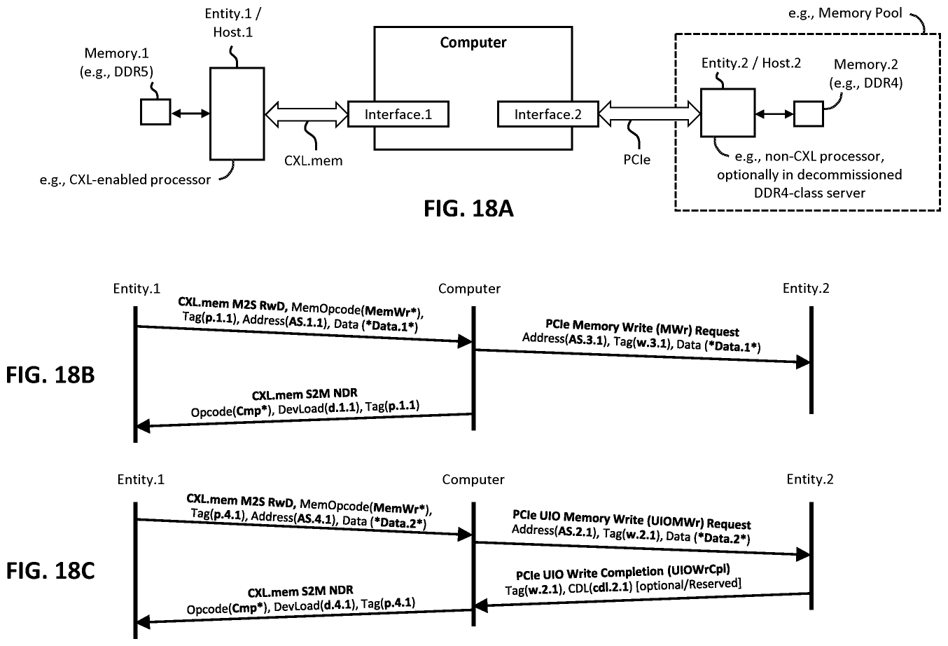

FIG. 18A illustrates an example of a system comprising a computer coupled between a first interface (Interface.1) and a second interface (Interface.2). The first interface may expose a CXL device, such as a CXL type-2 device or a CXL type-3 device, and may communicate according to CXL.mem with a first entity (Entity.1), such as a first host (Host.1). The second interface may expose a PCIe device, and may communicate according to PCIe with a second entity (Entity.2), such as a second host (Host.2). The computer may extract physical addresses carried within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification.

The system may further include a memory pool comprising the second entity and a second memory, such as DDR4, wherein the computer may utilize the memory pool to expose a DDR4 memory tier to the first entity which may be coupled to a first memory, such as DDR5. In some examples, the second entity may not support CXL, or may be configured not to support CXL, potentially preventing the computer from utilizing CXL for accessing the second memory. In some examples, the second entity may include a server, such as a DDR4-class datacenter server, wherein the server may include a non-CXL processor that may not support CXL, such as a pre-CXL generation processor configured to support PCIe but not CXL, and wherein the non-CXL processor may enable the computer to access the second memory by utilizing PCIe.

FIG. 18B illustrates an example of a TFD demonstrating translations, optionally performed by a computer, between CXL.mem requests received from a first entity (Entity.1), such as a first host (Host.1), and PCIe requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction, which may include a CXL.mem M2S request with data (RwD) comprising MemOpcode(MemWr*), Tag(p.1.1), Address(AS.1.1), and Data (*Data.1*). The computer may translate the CXL.mem M2S RwD transaction to a PCIe transaction, which may include a PCIe Memory Write request (MWr) comprising Address(AS.3.1), Tag(w.3.1), and Data (*Data.1*), and may send the PCIe MWr to the second entity. In some examples, the PCIe MWr may be a posted write that may not be followed by a response or completion from the second entity. The computer may respond to the CXL.mem M2S RwD received from the first entity with a CXL.mem S2M NDR comprising Opcode(Cmp*), DevLoad(d.1.1), and Tag(p.1.1), wherein the computer may send the CXL.mem S2M NDR to the first entity before sending the PCIe MWr to the second entity. Alternatively, the computer may send the CXL.mem S2M NDR to the first entity in parallel to sending the PCIe MWr to the second entity, or the computer may send the CXL.mem S2M NDR to the first entity after sending the PCIe MWr to the second entity. The computer may further populate the DevLoad of the CXL.mem S2M NDR with telemetry information, metadata, or other types of information collected or generated by the computer, or may utilize the DevLoad of the CXL.mem S2M NDR to throttle CXL.mem requests from the first entity. DevLoad in CXL messages may be optional and may not exist in some revisions of the CXL specification. The computer may perform further translations, such as protocol translations, opcode translations, command translations, TLP type translations, or field translations, such as Tag translations, between messages conforming to CXL.mem and TLPs conforming to PCIe.

FIG. 18C illustrates an example of a TFD demonstrating translations between CXL.mem requests received from a first entity (Entity.1), such as a first host (Host.1), and PCIe UIO requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe UIO requests sent to the second entity. The first entity may initiate a CXL.mem transaction that may include a CXL.mem M2S request with Data (M2S RwD) comprising MemOpcode(MemWr*), Tag(p.4.1), Address(AS.4.1), and Data (*Data.2*). A computer may translate the CXL.mem M2S RwD transaction to a PCIe transaction, which may include a PCIe UIO Memory Write request (UIOMWr) comprising Address(AS.2.1), Tag(w.2.1), and Data (*Data.2*), and may send the PCIe UIOMWr to the second entity. Upon receiving a response or completion from the second entity, which may include a PCIe UIO Write Completion (UIOWrCpl) comprising Tag(w.2.1) and optionally CDL(cdl.2.1), the computer may translate the PCIe UIOWrCpl to a CXL.mem S2M No Data Response (S2M NDR) comprising Opcode(Cmp*), DevLoad(d.4.1), and Tag(p.4.1), and may send the CXL.mem S2M NDR to the first entity.

The optional CDL in the PCIe UIOWrCpl, when not reserved, may be populated by the second entity with information such as QoS telemetry. The computer may translate the information carried in the optional CDL of the PCIe UIOWrCpl received from the second entity, and populate the translated information in the DevLoad of the CXL.mem S2M NDR sent to the first entity. DevLoad in CXL messages may be optional and may not exist in some revisions of the CXL specification. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity. The computer may perform further translations, such as protocol translations, opcode translations, command translations, TLP type translations, or field translations, such as Tag translations, between messages conforming to CXL.mem and TLPs conforming to PCIe.

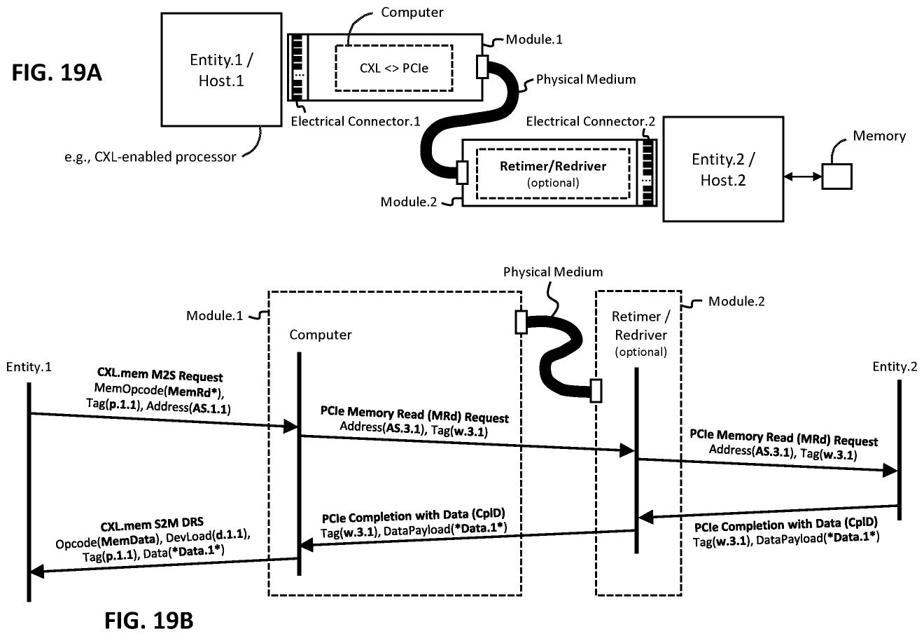

FIG. 19A illustrates an example of a system comprising a cable, such as an active cable, that may include a first module (Module.1), a second module (Module.2), and a physical medium coupling the first module and the second module. The physical medium may include a twinaxial cabling (also known as twinax cable), a multimode fiber (MMF), or a single-mode fiber (SMF). The cable may further include a computer that translates between CXL-based traffic, such as CXL.mem traffic, and a PCIe-based traffic, such as a PCIe or a PCIe-over-Ethernet traffic. The cable may enable a first entity (Entity.1) to access resources coupled to a second entity (Entity.2), such as a second host (Host.2). The first entity (Entity.1), which may be a first host (Host.1), may include a CXL-enabled processor. The access may be via the first module, the physical medium, and the second module. The resources may be memory coupled to the second entity, and the second entity may be a second host that may include a server, such as a DDR4-class datacenter server that may include a non-CXL processor that does not support CXL, such as a pre-CXL generation processor configured to support PCIe.

The cable may communicate with the first entity according to a CXL-based protocol, such as CXL.mem, and may communicate with the second entity according to a PCIe-based protocol. In some examples, messages conforming to the CXL-based protocol, such as CXL.mem, may be associated with a first address space, such as a first Host Physical Address (HPA) space; and messages conforming to the PCIe-based protocol may be associated with a second address space, such as a PCIe Memory Address Space, a DMA address space, an IO virtual address (IOVA) space, a system address space, or a second HPA space; wherein the cable may perform address translations between addresses within the first and second address spaces, respectively, such as between addresses within the first HPA space and addresses within the second HPA space. In other examples, messages conforming to the CXL-based protocol and messages conforming to the PCIe-based protocol may be associated with the same address space, wherein the cable may perform address translations between addresses within the same address space. Additionally, or alternatively, the system may perform further address translations, such as by an I/O Memory Management Unit (IOMMU), a System Memory Management Unit (SMMU), or a DMA address translation. The cable may perform further translations, such as protocol translations, opcode translations, command translations, TLP translations, or field translations between the CXL-based domain and the PCIe-based domain, such as translations of Tags and translations of error indications (e.g. data corruption indications such as poison).

The cable may further include a redriver or a retimer, such as a PCIe retimer, a CXL retimer, a dual-protocol CXL/PCIe retimer, a PAM4 retimer, or a retimer PHY. The cable, such as an OSFP copper cable, an OSFP-XD copper cable, an OSFP Active Optical Cable (AOC), or an OSFP-XD AOC cable, may conform to a standard specification, an industry standard, an implementation agreement (IA), or a multi-source agreement (MSA), such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard (such as SFF-8665), an Optical Internetworking Forum (OIF) implementation agreement, or an Institute of Electrical and Electronics Engineers (IEEE) standard. In some examples, the cable may be coupled to the first entity via a first electrical connector (Connector.1) and may be further coupled to the second entity via a second electrical connector (Connector.2), whereas in other examples, the cable may be coupled to the first entity and/or to the second entity via optical connectors.

FIG. 19B illustrates an example of a TFD demonstrating translations performed by a cable, such as an active cable comprising a computer and optionally a retimer or a redriver. The cable may include a first module (Module.1), a second module (Module.2), and a physical medium coupling the first module and the second module. The translations may be between CXL.mem requests received from a first entity (Entity.1), such as a first host (Host.1), and PCIe requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction that may include a CXL.mem M2S request comprising MemOpcode(MemRd*), Tag(p.1.1), and Address(AS.1.1). The computer included in the cable may translate the CXL.mem transaction to a PCIe transaction, which may include a PCIe Memory Read (MRd) request comprising Address(AS.3.1) and Tag(w.3.1). The computer may send the PCIe MRd to the second entity, optionally via the second module that may include a retimer or a redriver. Upon receiving a response or completion from the second entity, which may include a PCIe Completion with Data (CplD) comprising Tag(w.3.1) and DataPayload(*Data.1*), the computer may translate the PCIe CplD to a CXL.mem S2M DRS comprising Opcode(MemData), DevLoad(d.1.1), Tag(p.1.1), and Data(*Data.1*). The computer may send the CXL.mem S2M DRS to the first entity. The computer may populate DevLoad of CXL.mem S2M messages with telemetry information, metadata, or other types of information collected or generated by the cable, or may utilize the DevLoad of CXL.mem S2M messages to throttle CXL.mem requests from the first entity, enabling the cable to control, limit, shape, or throttle the rate of data communications between the first entity and the second entity. The computer may perform further translations, such as protocol translations, opcode translations, command translations, TLP type translations, or field translations, such as Tag translations, between messages conforming to CXL.mem and TLPs conforming to PCIe.

In environments where entities may utilize different protocols while requiring coordinated access to shared resources, there may be scenarios where a first entity communicating based on PCIe, such as a GPU, needs to access memory resources coupled to a second entity communicating based on CXL.mem, such as a CXL memory expander or a CXL memory pool. Translations between PCIe TLPs and CXL.mem messages may facilitate memory operations, data transfers, and resource sharing across different domains while maintaining the requirements of each protocol. Such translations may be performed by a computer, an apparatus, a cable, a Fabric Processing Unit (FPU), a Fabric NIC, or other suitable devices positioned between the first entity and the second entity. This translation may enable PCIe devices that do not natively support CXL protocols to access large-capacity CXL-attached memory resources. For example, GPUs designed with PCIe interfaces may access CXL memory pools that provide memory capacity exceeding the HBM integrated within the GPUs, thereby extending the effective memory available for AI/ML workloads, graphics rendering, or general-purpose GPU computing possibly without requiring hardware modifications to existing GPU designs. The computer may perform address translations between different physical address spaces, opcode translations between PCIe and CXL.mem, and Tag translations between PCIe Tag formats and CXL.mem Tag formats.

In various implementations, a method for translating between Peripheral Component Interconnect Express (PCIe) Transaction Layer Packets (TLPs) and Compute Express Link (CXL) messages, comprising: receiving a PCIe memory request by a computer from a first entity; translating, by the computer, the PCIe memory request to a CXL.mem Master-to-Subordinate (M2S) request; sending, by the computer to a second entity, the CXL.mem M2S request; receiving, by the computer from the second entity, a CXL.mem Subordinate-to-Master Data Response (S2M DRS) corresponding to the CXL.mem M2S request; translating, by the computer, the CXL.mem S2M DRS to a PCIe Completion; and sending the PCIe Completion by the computer to the first entity. The translation may encompass various aspects of the protocol messages, including opcodes, addresses, and transaction identifiers, thereby enabling communication between entities that utilize different protocols. The method may be implemented in hardware, firmware, software, or combinations thereof, and may be performed by various types of devices, such as semiconductor devices, switches, bridges, or active cables. The computer may maintain state information, such as pending transaction tables or tracker entries, to correlate CXL.mem S2M DRS responses with previously transmitted CXL.mem M2S requests and with pending PCIe transactions. Additionally, the elements may communicate through one or more intermediary components, such as a switch, a retimer, or other suitable entity that facilitates information transfer. The first entity may include devices such as GPUs, NICs, DMA engines, accelerators, or other PCIe endpoints, while the second entity may include CXL memory expanders, CXL memory pools, GFDs, or other CXL.mem-capable devices.

In some implementations of the method, the PCIe memory request comprises a first physical address belonging to a first physical address space utilized by the first entity, and wherein translating the PCIe memory request to the CXL.mem M2S request comprises generating the CXL.mem M2S request comprising a second physical address belonging to a second physical address space utilized by the second entity. The address translation may be implemented utilizing lookup tables, page tables, hash tables, base-and-offset calculations, and/or programmable translation functions. The first and second physical address spaces may have different sizes, different base addresses, or different memory layouts, and the translation may accommodate these differences while maintaining the meaning of the memory operations. In some examples, the first physical address space may include an address space utilized by the first entity for PCIe memory-mapped I/O (MMIO) operations, and the second physical address space may include a Host Physical Address (HPA) space utilized by a CXL host coupled to a CXL device of the second entity. The computer may maintain translation tables that map regions of the first physical address space to corresponding regions of the second physical address space, enabling the first entity to access CXL-attached memory resources using addresses within its native address space.

In some implementations of the method, the first entity comprises a GPU that does not support CXL.mem, wherein the second entity comprises a CXL memory pool, and wherein the computer exposes memory resources of the CXL memory pool to the GPU via a PCIe memory address space. The computer may expose the CXL memory pool to the GPU by configuring Base Address Registers (BARs) or other PCIe mechanisms to advertise a memory region that the GPU can access using standard PCIe memory read and write operations. The GPU may utilize this exposed memory region for various purposes, such as storing intermediate computation results, model parameters for AI/ML inference, texture data for graphics rendering, or working data sets that exceed the GPU's local HBM capacity. The computer may handle the translation transparently, such that the GPU may operate without awareness that the underlying memory is accessed utilizing CXL.mem rather than standard PCIe memory, which may enable existing GPU designs with PCIe interfaces to benefit from CXL-attached memory resources.

In some implementations of the method, the computer communicates with GPUs via interfaces, and wherein the computer translates PCIe memory requests from the GPUs to CXL.mem M2S requests targeting a shared memory resource of the CXL memory pool. The shared memory region of the CXL memory pool may be accessible by multiple GPUs, enabling data sharing, inter-GPU communication, or load balancing across the GPUs. The computer may implement arbitration logic to manage concurrent memory requests from the GPUs, and may utilize QoS mechanisms to allocate bandwidth or prioritize requests from different GPUs. The shared memory architecture may be beneficial in multi-GPU computing environments, such as AI/ML training clusters, where GPUs may need to access common datasets, model parameters, or intermediate results. The interfaces may include separate PCIe links, lanes within a shared PCIe link, or virtual channels within a PCIe fabric.

In some implementations of the method, the computer maintains memory allocation information associating portions of the CXL memory pool with certain respective GPUs of the GPUs, and wherein translating the PCIe memory request comprises selecting a portion of the CXL memory pool based on an identity of a requesting GPU. The memory allocation information may include address range tables, partition descriptors, or access control lists that define which portions of the CXL memory pool are accessible by each GPU. The computer may identify the requesting GPU based on the Requester ID in the PCIe memory request, a source port identifier, or other identification mechanisms. The partitioning may enable isolation between GPUs for security or fault containment purposes, or may enable dynamic memory allocation wherein portions of the CXL memory pool are assigned to GPUs based on workload requirements. The computer may support exclusive partitions (accessible by a single GPU) and/or shared regions (accessible by multiple GPUs) within the CXL memory pool.

In some implementations of the method, the first entity comprises at least one of a GPU, a Network Interface Card (NIC), or a Direct Memory Access (DMA) engine; wherein the second entity comprises at least one of a CXL memory expander, a CXL memory pool, or a Global Fabric-Attached Memory device (GFD); wherein the PCIe memory request comprises a PCIe Memory Read (MRd) request comprising a first Tag; wherein the CXL.mem M2S request comprises MemRd* and a second Tag; wherein the CXL.mem S2M DRS comprises MemData and data; wherein the PCIe Completion comprises a Completion with Data (CplD) comprising the data and the first Tag; and wherein the computer maintains a mapping between the first Tag and the second Tag. The computer may maintain the mapping between the first Tag and the second Tag in a tracker entry, a translation table, or another relevant data structure. Upon receiving the CXL.mem S2M DRS from the second entity, the computer may utilize the second Tag to identify the corresponding pending transaction and retrieve the first Tag for inclusion in the PCIe CplD. GPUs may utilize PCIe memory reads to access large memory pools for workloads such as graphics rendering, machine learning inference, or general-purpose GPU computing workloads. NICs may utilize PCIe memory reads to access memory buffers for network packet processing, RDMA, or storage traffic handling. DMA engines may utilize PCIe memory reads to transfer data between memory regions on behalf of other system components. The second entity may expose memory resources that are implemented using various memory technologies such as DDR5, DDR4, HBM, persistent memory, or combinations thereof.

In some implementations, the method further comprises receiving, by the computer from the first entity, a PCIe Memory Write request (MWr) comprising write data; translating the PCIe MWr to a CXL.mem M2S request with Data (M2S RwD) comprising a MemWr* and the write data; sending the CXL.mem M2S RwD to the second entity; and receiving, from the second entity, a CXL.mem S2M No Data Response (S2M NDR) comprising Cmp*. The PCIe MWr may be a posted write that does not require a completion to be returned to the first entity. However, CXL.mem may return an S2M NDR with Cmp* to acknowledge receipt of the write data by the second entity. The computer may absorb the S2M NDR without forwarding the acknowledgment to the first entity, or may utilize the S2M NDR to update internal state or flow control mechanisms. The write data may be transferred from the PCIe domain to the CXL.mem domain with optional format conversion, alignment adjustment, or byte enable manipulation as appropriate for the respective protocol specifications. The computer may buffer the write data internally and may implement mechanisms to handle scenarios where the CXL.mem M2S RwD encounters errors or back-pressure from the second entity.

In some implementations of the method, the computer is included in a switch, and wherein the PCIe memory request is selected from: a UIO Memory Read (UIOMRd) request, a UIO Memory Write request (UIOMWr), a Memory Read (MRd) request, or a Memory Write request (MWr). The selection among UIOMRd, UIOMWr, MRd, or MWr may depend on the capabilities of the first entity and the configuration of the path between the first entity and the computer.

In some implementations of the method, the PCIe memory request comprises a PCIe Unordered Input/Output (UIO) Memory Read (UIOMRd) request, and wherein the PCIe Completion comprises a PCIe UIO Read Completion with Data (UIORdCplD). The UIO transaction types may be utilized when the first entity supports UIO capabilities and when the path between the first entity and the computer has UIO enabled. The UIOMRd request type may provide ordering flexibility that enables more efficient utilization of fabric bandwidth in topologies with multiple paths between source and destination. UIO transactions may allow out-of-order completion delivery, which may reduce head-of-line blocking and improve overall system throughput in heavily loaded systems. The UIORdCplD completion may include a CDL that the computer may populate with information collected from the CXL.mem domain, from the computer itself, or from intermediate components.

In some implementations, the method further comprises receiving, by the computer from the first entity, a PCIe UIO Memory Write request (UIOMWr) comprising write data; translating the PCIe UIOMWr to a CXL.mem M2S request with Data (M2S RwD) comprising a MemWr* and the write data; sending the CXL.mem M2S RwD to the second entity; receiving, from the second entity, a CXL.mem S2M No Data Response (S2M NDR); translating the CXL.mem S2M NDR to a PCIe UIO Write Completion (UIOWrCpl); and sending the PCIe UIOWrCpl to the first entity. The UIO Memory Write request may be a non-posted transaction for which the first entity expects a UIOWrCpl, and the computer may translate the CXL.mem S2M NDR to the PCIe UIOWrCpl, thereby providing end-to-end acknowledgment that the write data has been received by the second entity. This non-posted write may be beneficial for maintaining ordering guarantees or for implementing synchronization mechanisms. The UIOWrCpl may include a CDL that the computer may populate based on the DevLoad from the CXL.mem S2M NDR or based on locally generated information.

In some implementations of the method, the CXL.mem S2M DRS comprises a DevLoad, and wherein the PCIe Completion comprises a CXL DevLoad (CDL) populated based on the DevLoad. The DevLoad in the CXL.mem S2M DRS may carry QoS telemetry information indicating the loading or congestion state of the second entity or intermediate components in the CXL.mem path. The computer may translate this telemetry information to the CDL in the PCIe UIORdCplD, thereby propagating QoS information back to the first entity. The first entity may utilize this information to make informed decisions about subsequent memory operations, such as throttling request rates, adjusting request priorities, or selecting alternative memory resources based on observed loading conditions. This end-to-end propagation of telemetry information may enable more efficient resource utilization in heterogeneous computing systems.

In some implementations, the method further comprises sending, by the computer to the second entity, a CXL.mem M2S request comprising MemSpecRd. The speculative memory read may be initiated by the computer to fetch data from the second entity in advance of, or without, the first entity explicitly requesting that data. The CXL.mem MemSpecRd opcode provides a mechanism for speculative memory access that does not have a direct equivalent in PCIe, enabling the computer to leverage CXL.mem-specific capabilities to improve performance for PCIe devices. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. Data returned in response to speculative reads may be buffered by the computer and may be utilized to satisfy subsequent requests from the first entity, potentially reducing observed read latency.

In some implementations, the method further comprises receiving, by the computer from the second entity, a CXL.mem S2M DRS comprising data responsive to the CXL.mem M2S request comprising MemSpecRd; buffering, by the computer, the data; receiving a subsequent PCIe memory request from the first entity targeting an address corresponding to the buffered data; and populating a subsequent PCIe Completion with at least some of the buffered data responsive to the subsequent PCIe memory request. The computer may maintain a prefetch buffer or cache structure to store data received in response to speculative read requests. When a subsequent PCIe memory request from the first entity targets an address for which speculative data has been buffered, the computer may service the request from the buffer without initiating a new CXL.mem transaction, thereby reducing the observed read latency. The buffered data may be invalidated or refreshed based on coherency requirements, timeout policies, or subsequent write operations to the same address. The computer may implement address matching logic to determine whether incoming PCIe memory requests can be satisfied from buffered speculative data.

In some implementations, the method further comprises detecting sequential access patterns in physical addresses of prior PCIe memory requests received from the first entity, and initiating the CXL.mem M2S request comprising MemSpecRd targeting a next sequential physical address. The computer may track physical addresses from consecutive PCIe memory requests received from the first entity to identify sequential access patterns indicative of linear memory traversal. Upon detecting that the first entity has accessed certain addresses in sequence, the computer may speculatively facilitate the readiness of the data from subsequent addresses before the first entity explicitly requests them. The sequential pattern detection may account for cacheline boundaries, page boundaries, or other memory organization units to optimize prefetch granularity.

In some implementations, the method further comprises detecting strided access patterns in physical addresses of prior PCIe memory requests received from the first entity, calculating a stride distance between accessed addresses, and initiating the CXL.mem M2S request comprising MemSpecRd targeting a physical address offset by the stride distance. The computer may identify non-sequential but regular access patterns wherein the first entity accesses memory locations separated by a consistent stride distance, such as when processing array elements or matrix columns. For example, if the computer observes accesses to addresses A, A+S, A+2S, where S represents the stride, it may speculatively prefetch from address A+3S. The stride detection algorithm may maintain a history buffer of recent addresses and compute stride patterns using difference calculations or pattern matching algorithms.

In some implementations of the method, the PCIe memory request comprises a first Tag having a first bit width selected from 5 bits, 8 bits, 10 bits, or 14 bits; wherein the CXL.mem M2S request comprises a second Tag having a 16-bit width; and wherein the computer translates between the first Tag and the second Tag. PCIe supports variable Tag widths depending on device capabilities and negotiated settings, including 5-bit Tags (default), 8-bit extended Tags, 10-bit Tags (for high-speed links), and 14-bit Tags (for flit mode and UIO). CXL.mem utilizes a fixed 16-bit Tag for transaction identification. The computer may translate between these different Tag formats by allocating CXL.mem Tags from a Tag pool, maintaining a mapping table between PCIe Tags and CXL.mem Tags, or implementing algorithmic Tag generation based on the PCIe Tag and additional context. The translation may also accommodate scenarios where the computer needs to maintain more outstanding CXL.mem transactions than the PCIe Tag space allows (for example, when issuing speculative CXL.mem reads independently of PCIe demand requests) by drawing from the larger CXL.mem Tag space for those additional transactions.

In some implementations of the method, the PCIe memory request specifies a requested data length larger than a cacheline size, wherein translating the PCIe memory request comprises generating CXL.mem M2S requests each targeting a cacheline-sized data portion, and wherein the method further comprises: receiving CXL.mem S2M DRS responses from the second entity, and aggregating data from the CXL.mem S2M DRS responses into the PCIe Completion. CXL.mem transactions are typically cacheline-sized (64 bytes), while PCIe memory requests may specify data lengths up to 4 KB using the Length field and byte enables. When a PCIe memory request specifies a data length exceeding the cacheline size, the computer may split the request into CXL.mem M2S requests, each targeting a 64-byte cacheline. The computer may track the outstanding CXL.mem requests and may aggregate the returned data into a single PCIe Completion or into multiple PCIe Completions as permitted by PCIe. The aggregation may involve buffering data from responses, ordering the data according to address sequence, and formatting the aggregated data according to PCIe Completion requirements.

In some implementations of the method, the PCIe memory request specifies a requested data length smaller than a cacheline size, wherein the CXL.mem S2M DRS comprises cacheline-sized data, and wherein the method further comprises trimming the cacheline-sized data to match the requested data length prior to populating the PCIe Completion. PCIe memory requests may specify data lengths smaller than a cacheline using byte enables, requesting as little as a single doubleword (4 bytes) or even individual bytes. CXL.mem responses return cacheline-sized data regardless of the requested length. The computer may trim the returned data to the bytes requested by the first entity, aligning the data to native boundaries such as doubleword boundaries as specified by the PCIe specifications. The trimming operation may reduce the data payload size in the PCIe Completion, potentially improving bandwidth efficiency on the path between the computer and the first entity.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus for translating between Peripheral Component Interconnect Express (PCIe) Transaction Layer Packets (TLPs) and Compute Express Link (CXL) messages, comprising: a first interface configured to communicate with a first entity based on PCIe; a second interface configured to communicate with a second entity based on CXL.mem; and a computer coupled to the first interface and the second interface, wherein the computer is configured to: receive a PCIe memory request from the first entity via the first interface; translate the PCIe memory request to a CXL.mem Master-to-Subordinate (M2S) request; send, to the second entity via the second interface, the CXL.mem M2S request; receive, from the second entity via the second interface, a CXL.mem Subordinate-to-Master Data Response (S2M DRS) corresponding to the CXL.mem M2S request; translate the CXL.mem S2M DRS to a PCIe Completion; and send the PCIe Completion to the first entity via the first interface. The apparatus may be implemented as a switch, a bridge, a semiconductor device, a chiplet within an IC package, or other suitable form factor. The first interface may include PCIe physical layer components, link layer components, and transaction layer logic configured to communicate according to PCIe specifications. The second interface may include CXL physical layer components (which may share physical layer characteristics with PCIe), link layer components, and CXL.mem transaction layer logic. The computer may include translation logic, address translation tables, Tag mapping structures, and pending transaction trackers. In some examples, the apparatus and at least one of the first entity or the second entity may be included within the same IC package, optionally coupled by UCIe links or other die-to-die interconnects.

In some implementations of the apparatus, the PCIe memory request comprises a first physical address belonging to a first physical address space, the CXL.mem M2S request comprises a second physical address belonging to a second physical address space, and wherein the computer is further configured to translate between the first physical address and the second physical address. The apparatus may include address translation logic, which may be implemented using lookup tables, content-addressable memory (CAM), translation lookaside buffers (TLBs), or programmable translation functions. The translation may enable the first entity to access CXL-attached memory using addresses within its native address space while the second entity operates within its own address space. The address translation may be configured by system software, firmware, or hardware during system initialization or dynamically during operation.

In some implementations of the apparatus, the first entity comprises a GPU that does not support CXL.mem, the second entity comprises a CXL memory pool, and wherein the computer is configured to expose memory resources of the CXL memory pool to the GPU as a PCIe memory-mapped region. The apparatus may function as a bridge enabling GPUs designed with PCIe interfaces to access CXL-attached memory resources. The apparatus may expose the CXL memory pool as one or more PCIe BARs that the GPU can access using PCIe memory transactions, which may enable GPU-based AI/ML workloads to utilize memory capacities exceeding the HBM integrated within the GPU.

In some implementations of the apparatus, the computer is further configured to send, to the second entity via the second interface, a CXL.mem M2S request comprising MemSpecRd. The apparatus may include logic configured to initiate speculative memory reads to the second entity based on observed access patterns from the first entity. The speculative reads may utilize the CXL.mem MemSpecRd, which provides speculative access not available in PCIe. Data returned in response to speculative reads may be stored in a buffer within the apparatus for rapid delivery when subsequently requested by the first entity.

In some implementations of the apparatus, the apparatus is located in an active cable. The active cable may include the first interface at one end configured to connect to a PCIe device such as a GPU, and the second interface at the other end configured to connect to a CXL device such as a memory expander or memory pool. The computer may be implemented within the cable housing utilizing embedded logic. The active cable form factor may enable translation to be added to existing systems by replacing passive cables with active translation cables, possibly without requiring modifications to the connected devices.

In various implementations, a system comprising: Graphics Processing Units (GPUs), wherein at least one GPU of the GPUs does not support Compute Express Link (CXL) communications; a CXL device coupled to memory having a capacity greater than a capacity of high-bandwidth memory (HBM) of any one of the GPUs; and a computer coupled between the GPUs and the CXL device, the computer comprising: a first interface configured to communicate with the GPUs based on PCIe; and a second interface configured to communicate with the CXL device based on CXL.mem; wherein the computer is configured to: receive, from a GPU of the GPUs via the first interface, a PCIe memory request; translate the PCIe memory request to a CXL.mem Master-to-Subordinate (M2S) request; send, to the CXL device via the second interface, the CXL.mem M2S request; receive, from the CXL device via the second interface, a CXL.mem Subordinate-to-Master Data Response (S2M DRS); translate the CXL.mem S2M DRS to a PCIe Completion; and send the PCIe Completion to the GPU via the first interface. The system may enable GPUs that do not natively support CXL to access memory resources that exceed their local HBM capacity, such as for storing model parameters, intermediate computation results, KV-cache entries, or working data sets for AI/ML inference and training workloads. The CXL device may include a CXL memory expander, a CXL memory pool, a Global Fabric-Attached Memory device (GFD), or a CXL Type 2 device with device-attached memory. The memory coupled to the CXL device may be implemented using DDR5, DDR4, LPDDR, persistent memory, or combinations thereof, and may provide memory capacity and bandwidth characteristics that complement the high-bandwidth but limited-capacity HBM integrated within the GPUs. The computer may be implemented as a semiconductor device, an ASIC, a chiplet, a switch, an active cable, or other suitable form factor positioned between the PCIe domain of the GPUs and the CXL.mem domain of the CXL device. The computer may maintain per-GPU tracking structures, address translation tables, and Tag mapping resources to support concurrent translations from GPUs. In some examples, the computer and the CXL device may be included within a same IC package, optionally coupled by UCIe links or other die-to-die interconnects.

In some implementations of the system, the memory is accessible by the GPUs as a shared memory region, and wherein the computer is configured to translate PCIe memory requests from the GPUs to CXL.mem M2S requests targeting the shared memory region. The shared memory region may enable GPUs to access common data, such as model parameters, training datasets, or intermediate computation results, without requiring explicit data copying between GPUs. The computer may implement arbitration and flow control mechanisms to manage concurrent access from GPUs. The shared memory architecture may reduce total memory requirements and inter-GPU communication latency in multi-GPU systems.

In some implementations of the system, the computer maintains memory allocation information associating portions of the memory with respective GPUs, and wherein translating the PCIe memory request comprises selecting a target address within the memory based on an identity of a requesting GPU of the GPUs. The memory allocation information may enable partitioned access wherein each GPU is assigned a dedicated portion of the memory for private use. The computer may identify the requesting GPU based on the Requester ID in the PCIe memory request or other identification mechanisms, and may direct the CXL.mem M2S request to the appropriate memory partition. The partitioning may provide isolation between GPU workloads for security, fault containment, or resource management purposes.

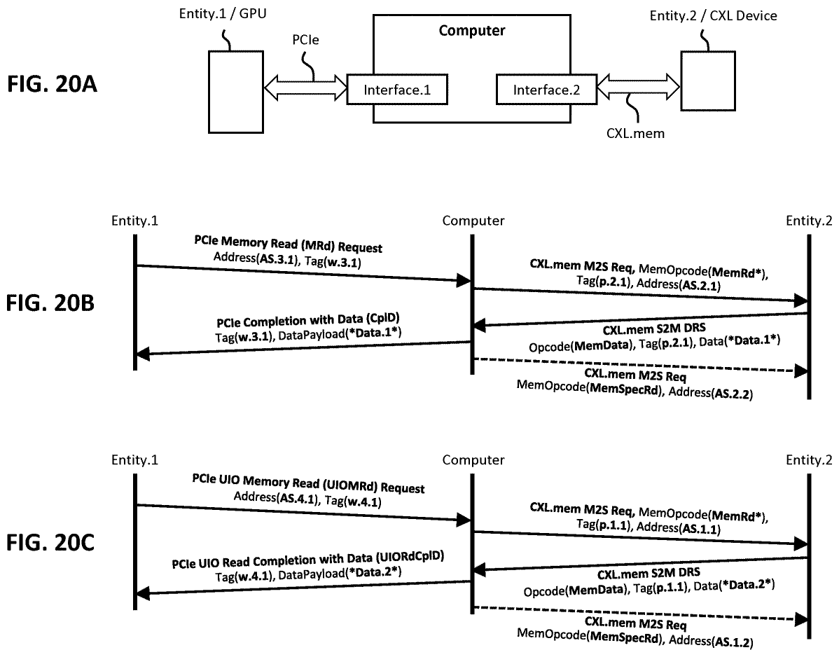

FIG. 20A illustrates an example of a system comprising a switch (e.g., a CXL switch), a processor, or a bridge, which comprises a computer coupled between a first interface (Interface.1) and a second interface (Interface.2). The first interface may communicate according to PCIe with a first entity (Entity.1), such as a GPU. The second interface may communicate according to a CXL protocol, such as CXL.mem, with a second entity (Entity.2), such as a CXL device, which may be a CXL memory expander, a CXL memory pool, or a GFD. The computer may extract physical addresses from messages received via the first interface, wherein these addresses may refer to a first Physical Address (PA) space utilized by the first entity; translate these addresses; and generate messages carrying the translated physical addresses for transmission via the second interface; wherein these translated addresses may refer to a second PA space utilized by the second entity. In some examples, the first PA space and the second PA space may be the same PA space, wherein the computer may perform address translations between addresses within the same PA space. The computer may perform further translations between the PCIe domain and the CXL domain, such as translating between PCIe TLP types (e.g., MRd, UIOMRd) and CXL.mem opcodes (e.g., MemRd, MemRdData, MemRdTEE). The computer may be implemented as a monolithic die, as one or more chiplets within an IC package, or as one or more components on a board. In some examples, the computer and at least one of the first entity or the second entity may be included within the same IC package, optionally coupled by one or more UCIe links.

FIG. 20B illustrates an example of a TFD demonstrating translations, performed by a computer, between PCIe TLPs received from a first entity (Entity.1), which may be a GPU, and CXL.mem messages sent to a second entity (Entity.2), which may be a CXL device, possibly enabling the first entity to access resources mapped to an address space utilized by the second entity. The first entity may initiate a PCIe transaction that includes a PCIe Memory Read (MRd) request comprising Address(AS.3.1) and Tag(w.3.1). The computer may translate the PCIe transaction to a CXL.mem transaction that includes a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses such as translating the CXL.mem S2M DRS to a PCIe Completion with Data (CplD) comprising Tag(w.3.1) and DataPayload(*Data.1*), and may send the CplD to the first entity. The computer may perform further translations, such as protocol translations, opcode translations, command translations, or TLP translations, e.g., translating between PCIe TLPs and CXL.mem messages, wherein these translations may include field translations, such as translating between PCIe Tags and CXL.mem Tags, translating between reserved fields, and translating between reserved and non-reserved fields. The computer may further initiate speculative memory reads targeting the second entity, wherein the speculative memory reads may include a CXL.mem M2S Req comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved.

FIG. 20C illustrates an example of a TFD demonstrating translations between PCIe UIO TLPs received from a first entity (Entity.1), which may be a GPU, and CXL.mem messages sent to a second entity (Entity.2) which may be a CXL device, possibly enabling the first entity to access resources mapped to an address space utilized by the second entity (Entity.2). The first entity may initiate a PCIe UIO transaction that may include a PCIe UIO Memory Read (UIOMRd) request comprising Address(AS.4.1) and Tag(w.4.1). The computer may translate the PCIe UIO transaction to a CXL.mem transaction that may include a CXL.mem M2S request comprising MemOpcode(MemRd*), Tag(p.1.1), and Address(AS.1.1), and may send the CXL.mem M2S request to the second entity. Upon receiving one or more responses from the second entity, which may include a CXL.mem S2M DRS comprising Opcode(MemData), Tag(p.1.1), and Data(*Data.2*), the computer may translate the one or more responses, such as translating the CXL.mem S2M DRS to a PCIe UIO Read Completion with Data (UIORdCplD) comprising Tag(w.4.1) and DataPayload(*Data.2*); and may send the UIORdCplD to the first entity. The computer may perform further translations, such as protocol translations, opcode translations, command translations, or TLP translations, e.g., translating between PCIe UIO TLPs and CXL.mem messages, wherein these translations may include field translations. The computer may further initiate speculative memory reads targeting the second entity, wherein the speculative memory reads may include a CXL.mem M2S Req comprising MemOpcode(MemSpecRd) and Address(AS.1.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved.

In heterogeneous computing architectures, entities may utilize different protocols while requiring coordinated access to shared resources. PCIe UIO and CXL UIO define wire semantics and TLP types to enable multi-path fabrics and improved performance. In environments where a first entity supporting CXL.io UIO needs to access resources coupled to a second entity supporting PCIe, translations between CXL.io UIO TLPs and PCIe TLPs may facilitate memory operations and data transfers across different domains. Such translations may be performed by a computer, an apparatus, a cable, or other suitable devices positioned between the first entity and the second entity. The translations may further enable communication over split flit/non-flit paths, wherein the CXL.io UIO portion utilizes flit-based encoding while the PCIe portion may utilize non-flit-based encoding.

In various implementations, a method for translating between Compute Express Link (CXL) Transaction Layer Packets (TLPs) and Peripheral Component Interconnect Express (PCIe) TLPs, comprising: receiving, from a first entity, a CXL.io Unordered Input/Output (UIO) Memory Read (UIOMRd) request comprising a first address and a first Tag; translating, by a computer, the CXL.io UIOMRd to a PCIe memory request comprising a second address and a second Tag; sending, to a second entity, the PCIe memory request; receiving, from the second entity, a PCIe Completion corresponding to the PCIe memory request; translating, by the computer, the PCIe Completion to a CXL.io UIO Read Completion with Data (UIORdCplD) comprising the first Tag and a data payload; and sending, to the first entity, the CXL.io UIORdCplD. The translation process may encompass various aspects of the protocol messages, including opcodes, addresses, Tags, and other TLP fields, thereby enabling communication between entities that utilize different protocols. The computer may maintain state information, such as pending transaction tables or tracker entries, to correlate incoming PCIe Completions with previously transmitted PCIe memory requests and with pending CXL.io transactions. The method may be implemented in hardware, firmware, software, or combinations thereof, and may be performed by various types of devices, such as semiconductor devices, switches, or active cables. Additionally, the elements may communicate through one or more intermediary components, such as a switch, a retimer, or other suitable entity that facilitates information transfer.

In some implementations of the method, the first address is associated with a first physical address space utilized by the first entity, and wherein translating the CXL.io UIOMRd to the PCIe memory request comprises generating the PCIe memory request comprising the second address that is associated with a second physical address space utilized by the second entity. The address translation may be implemented utilizing lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations of the method, the PCIe memory request comprises a PCIe UIO Memory Read (UIOMRd) request, the PCIe Completion comprises a PCIe UIORdCplD, and the CXL.io UIORdCplD comprises a CXL DevLoad (CDL) populated by the computer with Quality-of-Service (QoS) telemetry information. The UIO-to-UIO path may preserve UIO semantics across the protocol boundary, enabling multi-path routing and out-of-order completion capabilities on both sides of the computer. The CDL in CXL.io UIO completions may carry telemetry information such as device load indicators, queue depth information, or latency metrics. The computer may populate the CDL with information derived from the PCIe UIORdCplD, from the computer itself, or from intermediate components. This telemetry propagation may enable the first entity to make informed decisions regarding request pacing, load balancing, or resource allocation.

In some implementations of the method, the PCIe memory request comprises a PCIe non-UIO Memory Read (MRd) request, and the PCIe Completion comprises a PCIe non-UIO Completion with Data (CplD). The UIO-to-non-UIO translation may enable a first entity utilizing CXL.io UIO to access resources coupled to a second entity that does not support UIO capabilities. The computer may translate the UIOMRd to MRd that conforms to non-UIO PCIe memory read. This translation may extend the reach of UIO-capable devices to legacy PCIe infrastructure or to devices that have not implemented UIO support.

In some implementations of the method, the CXL.io UIORdCplD comprises a CXL DevLoad (CDL), and wherein the computer populates the CDL with Quality-of-Service (QoS) telemetry information. When translating from PCIe non-UIO completions that do not include a CDL, the computer may generate QoS telemetry information based on locally observed conditions, such as queue depths, latency measurements, or congestion indicators. The computer may thus provide telemetry to the first entity even when the second entity does not support telemetry reporting.

In some implementations of the method, communication between the computer and the first entity utilizes flit-based encoding, and wherein communication between the computer and the second entity utilizes non-flit-based encoding. The split flit/non-flit path may enable communication between entities operating in different encoding modes. PCIe specifications define UIO for flit-based encoding, and do not permit direct translation of UIO TLPs to non-flit-based encoding. The translations may enable the computer to bridge these incompatible modes, enabling CXL.io UIO transactions to reach PCIe devices operating in non-flit mode. This capability may extend the utility of UIO-based systems to include legacy PCIe infrastructure.

In some implementations, the method further comprises receiving, from the first entity, a CXL.io UIO Memory Write request (UIOMWr) comprising a third address, a third Tag, and write data; translating, by the computer, the CXL.io UIOMWr to a PCIe UIOMWr comprising a fourth address, a fourth Tag, and the write data; sending, to the second entity, the PCIe UIOMWr; receiving, from the second entity, a PCIe UIO Write Completion (UIOWrCpl) comprising the fourth Tag; translating, by the computer, the PCIe UIOWrCpl to a CXL.io UIOWrCpl comprising a CXL DevLoad (CDL) and the third Tag; and sending, to the first entity, the CXL.io UIOWrCpl. UIO write transactions may provide non-posted write with completion acknowledgment, unlike non-UIO PCIe memory writes that are posted. The computer may maintain a mapping between the third Tag associated with the CXL.io transaction and the fourth Tag associated with the PCIe transaction. Upon receiving the PCIe UIOWrCpl from the second entity, the computer may utilize the fourth Tag to identify the corresponding pending transaction and retrieve the third Tag for inclusion in the CXL.io UIOWrCpl.

In some implementations of the method, the third address is associated with a first physical address space, wherein the fourth address is associated with a second physical address space, and wherein the computer translates between the third address and the fourth address. The computer may track both read and write transactions in the same tracker entries or may maintain separate tracking structures for different transaction types.

In some implementations, the method further comprises receiving, from the first entity, a CXL.io UIO Memory Write request (UIOMWr) comprising a third address and write data; translating, by the computer, the CXL.io UIOMWr to a PCIe non-UIO Memory Write request (MWr) comprising a fourth address and the write data; and sending, to the second entity, the PCIe MWr. The PCIe non-UIO Memory Write request may be a posted write that does not require a completion from the second entity. The computer may synthesize a CXL.io UIOWrCpl to send to the first entity upon accepting the write request, since CXL.io UIOMWr is non-posted and the first entity expects a completion, while the underlying PCIe non-UIO MWr is a posted write that does not generate a PCIe completion. The translation from non-posted UIO to posted non-UIO may involve buffering the write data and managing ordering requirements.

In some implementations of the method, the third address is associated with a first physical address space utilized by the first entity; wherein the fourth address is associated with a second physical address space utilized by the second entity; wherein the first entity comprises a CXL host or a CXL device; and wherein the second entity comprises a PCIe host or a PCIe device. The first entity may include CXL hosts such as processors or CXL devices such as accelerators, memory expanders, or NICs. The second entity may include PCIe hosts such as processors or PCIe devices such as GPUs, storage controllers, or network adapters. The address translation may accommodate the different address space configurations utilized by these various entity types.

In various implementations, an apparatus comprising: a first interface configured to communicate with a first entity based on CXL.io Unordered Input/Output (UIO), wherein CXL denotes Compute Express Link; a second interface configured to communicate with a second entity based on Peripheral Component Interconnect Express (PCIe); and a computer coupled to the first interface and the second interface, the computer configured to: receive, via the first interface, a CXL.io UIO Memory Read (UIOMRd) request comprising a first address and a first Tag; translate the CXL.io UIOMRd to a PCIe memory request comprising a second address and a second Tag; and send, via the second interface, the PCIe memory request to the second entity. The apparatus may be implemented as a semiconductor device, a card, a module, an active cable, or other suitable form factor. The first interface may expose the apparatus to the first entity as a CXL device, such as a CXL Type-2 device or a CXL Type-3 device. The second interface may expose the apparatus to the second entity as a PCIe device or as a host via a root port. The computer may include logic for address translation, Tag management, protocol conversion, and transaction tracking. Optionally, the apparatus may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and optional PCIe switch(es) may be positioned between the second interface and the second entity.

In some implementations of the apparatus, the computer is further configured to: receive, via the second interface, a PCIe Completion corresponding to the PCIe memory request; translate the PCIe Completion to a CXL.io UIO Read Completion with Data (UIORdCplD) comprising the first Tag and a data payload; and send, via the first interface, the CXL.io UIORdCplD to the first entity. The computer may maintain tracker entries or similar data structures to associate incoming PCIe Completions with their corresponding CXL.io requests. The translation may include extracting the data payload from the PCIe Completion and formatting it for CXL.io UIORdCplD.

In some implementations of the apparatus, the first address is associated with a first physical address space utilized by the first entity, the second address is associated with a second physical address space utilized by the second entity, and wherein the computer is further configured to translate between the first address and the second address. The apparatus may include address translation logic, which may be implemented using lookup tables, content-addressable memory, translation lookaside buffers, or programmable translation functions. The translation may enable the first entity to access resources using addresses within its native address space while the second entity operates within its own address space.

In some implementations of the apparatus, the PCIe memory request comprises a PCIe UIOMRd, the PCIe Completion comprises a PCIe UIORdCplD, and wherein the CXL.io UIORdCplD comprises a CXL DevLoad (CDL) populated by the computer with Quality-of-Service (QoS) telemetry information. The apparatus may extract CDL information from the PCIe UIORdCplD or may generate telemetry based on locally observed conditions. The CDL may enable end-to-end QoS telemetry propagation across the protocol boundary.

In some implementations of the apparatus, the PCIe memory request comprises a PCIe non-UIO Memory Read (MRd) request, the PCIe Completion comprises a PCIe non-UIO Completion with Data (CplD), wherein communication via the first interface utilizes flit-based encoding, and wherein communication via the second interface utilizes non-flit-based encoding. The apparatus may bridge flit-based and non-flit-based encoding modes, enabling CXL.io UIO transactions to reach legacy PCIe devices. The computer may handle the different header formats and encoding requirements of each mode.

In some implementations of the apparatus, the first interface exposes a first endpoint to the first entity, and wherein the second interface exposes a second endpoint to the second entity. The first endpoint may be configured as a CXL endpoint that appears to the first entity as a CXL device. The second endpoint may be configured as a PCIe endpoint that appears to the second entity as a PCIe device. The apparatus may thus function as a bridge between CXL and PCIe domains while presenting standard endpoint interfaces to both entities.

In some implementations of the apparatus, the apparatus comprises a cable including a first module coupled to the first interface, a second module coupled to the second interface, and a physical medium coupling the first module and the second module. The cable may be an active cable that includes the computer for performing protocol and address translations. The first module may include electrical or optical components for communicating with the first entity, and the second module may include electrical or optical components for communicating with the second entity. The physical medium may include twinaxial cable, multimode fiber (MMF), or single-mode fiber (SMF). The cable may be implemented as an Active Optical Cable (AOC) or an Active Copper Cable (ACC).

In various implementations, a system comprising: a first entity configured to communicate based on CXL.io Unordered Input/Output (UIO), wherein CXL denotes Compute Express Link; a second entity configured to communicate based on Peripheral Component Interconnect Express (PCIe); and a computer coupled between the first entity and the second entity, the computer configured to: receive, from the first entity, a CXL.io UIO Memory Read (UIOMRd) request comprising a first address; translate the CXL.io UIOMRd to a PCIe memory request comprising a second address; send, to the second entity, the PCIe memory request; receive, from the second entity, a PCIe Completion corresponding to the PCIe memory request; translate the PCIe Completion to a CXL.io UIO Read Completion with Data (UIORdCplD); and send, to the first entity, the CXL.io UIORdCplD. The system may be deployed in datacenters, HPC environments, or AI/ML training and inference clusters. The system architecture may enable CXL-based hosts or devices to access PCIe-attached resources using CXL.io UIO transactions, which may provide performance benefits such as multi-path routing and out-of-order completions. The computer may function as a bridge that maintains the requirements of each protocol while enabling interoperability.

In some implementations of the system, the first address is associated with a first physical address space utilized by the first entity, the second address is associated with a second physical address space utilized by the second entity, wherein the first entity comprises a CXL host or a CXL device, and wherein the second entity comprises at least one of a memory device, a memory expander, a memory pool, a Graphics Processing Unit (GPU), a Network Interface Card (NIC), an accelerator, a PCIe host, or a PCIe device. GPUs may be accessed via the system for AI/ML workloads, graphics rendering, or general-purpose GPU computing. NICs may be accessed for network packet processing, RDMA, or storage traffic handling. Memory devices, memory expanders, or memory pools may provide expanded memory capacity beyond what is directly attached to the first entity. The address translation may enable the first entity to access these diverse resources using a unified address space.

In some implementations of the system, the PCIe memory request comprises a PCIe non-UIO Memory Read (MRd) request, the PCIe Completion comprises a PCIe non-UIO Completion with Data (CplD), and wherein the CXL.io UIORdCplD comprises a CXL DevLoad (CDL) populated by the computer with Quality-of-Service (QoS) telemetry information. The system may enable CXL.io UIO-capable entities to access legacy PCIe devices while still receiving QoS telemetry in the completion. The computer may generate telemetry information based on observed system conditions when the second entity does not provide such information.

In some implementations of the system, the PCIe memory request comprises a PCIe UIOMRd, the PCIe Completion comprises a PCIe UIORdCplD, and wherein the CXL.io UIORdCplD comprises a CXL DevLoad (CDL) populated by the computer with Quality-of-Service (QoS) telemetry information. The UIO-to-UIO system configuration may preserve UIO semantics end-to-end, enabling multi-path routing and enhanced performance on both sides of the computer. QoS telemetry may be propagated from the second entity through the computer to the first entity.

In some implementations of the system, communication between the computer and the first entity utilizes flit-based encoding, and wherein communication between the computer and the second entity utilizes non-flit-based encoding. The system may enable deployment scenarios where newer CXL infrastructure utilizing flit-based encoding needs to communicate with legacy PCIe infrastructure utilizing non-flit-based encoding. The computer may handle the encoding mode differences transparently to the first and second entities.

In heterogeneous computing architectures, entities may communicate using different revisions of CXL.io, wherein earlier protocol revisions may lack support for UIO capabilities present in newer protocol revisions. CXL.io UIO defines wire semantics and TLP types to enable multi-path fabrics and improved performance. In environments where a first entity supporting a first CXL.io needs to access resources coupled to a second entity supporting a second CXL.io with UIO capabilities, translations between CXL.io non-UIO TLPs and CXL.io UIO TLPs may facilitate memory operations and data transfers across incompatible domains. Such translations may be performed by a computer, an apparatus, a cable, or other suitable devices positioned between the first entity and the second entity.

In various implementations, a method for translating between Compute Express Link (CXL) Transaction Layer Packets (TLPs), comprising: receiving, from a first entity, a CXL.io Memory Read (MRd) request comprising a first address and a first Tag; translating, by a computer, the CXL.io MRd to a CXL.io Unordered Input/Output (UIO) Memory Read (UIOMRd) request comprising a second address and a second Tag; sending, to a second entity, the CXL.io UIOMRd; receiving, from the second entity, a CXL.io UIO Read Completion with Data (UIORdCplD) comprising the second Tag and a data payload; translating, by the computer, the CXL.io UIORdCplD to a CXL.io Completion with Data (CplD) comprising the first Tag and the data payload; and sending, to the first entity, the CXL.io CplD. The translation process may encompass various aspects of the protocol messages, including opcodes, addresses, Tags, and other TLP fields, thereby enabling communication between entities that utilize different CXL.io revisions. The computer may convert non-UIO TLP formats to UIO TLP formats for the request path and convert UIO TLP formats back to non-UIO TLP formats for the completion path. The method may be implemented in hardware, firmware, software, or combinations thereof, and may be performed by various types of devices, such as semiconductor devices, switches, or active cables. Additionally, the elements may communicate through one or more intermediary components, such as a switch, a retimer, or other suitable entity that facilitates information transfer.

In some implementations of the method, the first address is associated with a first physical address space utilized by the first entity, and wherein translating the CXL.io MRd to the CXL.io UIOMRd comprises generating the CXL.io UIOMRd comprising the second address that is associated with a second physical address space utilized by the second entity. The address translation may be implemented utilizing mechanisms such as lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include a first HPA space utilized by a first host, and the second physical address space may include a second HPA space utilized by a second host or an address space utilized by a CXL device.

In some implementations of the method, the computer maintains state information comprising tracker entries or pending transaction tables to correlate the CXL.io UIORdCplD with the CXL.io UIOMRd and to associate the second Tag with the first Tag. The computer may allocate tracker entries upon receiving the CXL.io MRd and may store information including the first Tag, the first address, and transaction metadata. When the computer generates the CXL.io UIOMRd, it may assign the second Tag and record the mapping between the first Tag and the second Tag in the tracker entry. Upon receiving the CXL.io UIORdCplD comprising the second Tag, the computer may utilize the state information to identify the corresponding pending transaction and retrieve the first Tag for inclusion in the CXL.io CplD. The tracker entries may be implemented in hardware registers, content-addressable memory, or other suitable storage structures.

In some implementations of the method, the CXL.io UIORdCplD comprises a CXL DevLoad (CDL) field carrying Quality-of-Service (QoS) telemetry information, the second entity utilizes the CDL field for throttling requests from the computer, and the computer does not propagate the CDL field to the first entity in the CXL.io CplD. The CDL in CXL.io UIO completions may carry telemetry information such as device load indicators, queue depth information, or latency metrics populated by the second entity. The second entity may utilize the CDL to communicate its current load state to the computer, enabling the computer to adjust request pacing or implement congestion management. Because the CXL.io utilized by the first entity does not support UIO, the CXL.io CplD does not include a CDL field, and the computer may drop the CDL information when performing the translation and/or log or utilize the CDL information internally for its own traffic management decisions.

In some implementations of the method, a first CXL.io utilized for communicating the CXL.io MRd is an earlier revision than a second CXL.io utilized for communicating the CXL.io UIOMRd, and wherein a first interface utilized by the computer to communicate with the first entity and a second interface utilized by the computer to communicate with the second entity each comprise a CXL endpoint or a switch port. The first CXL.io may conform to an earlier CXL specification revision, such as CXL Specification Revision 1.1, that does not support UIO capabilities, while the second CXL.io may conform to a later CXL specification revision, such as CXL Specification Revision 3.2, that supports UIO capabilities. The first interface may expose a first CXL endpoint or a first switch port to the first entity, and the second interface may expose a second CXL endpoint or a second switch port to the second entity. The computer may thus function as a bridge between different CXL.io revisions while presenting CXL interfaces to both entities. Optionally, the computer may be implemented in an IC package having high-speed differential I/O balls positioned according to a ball grid array layout defined by a PCIe Retimer Supplemental Features and Standard BGA Footprint Specification.

In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

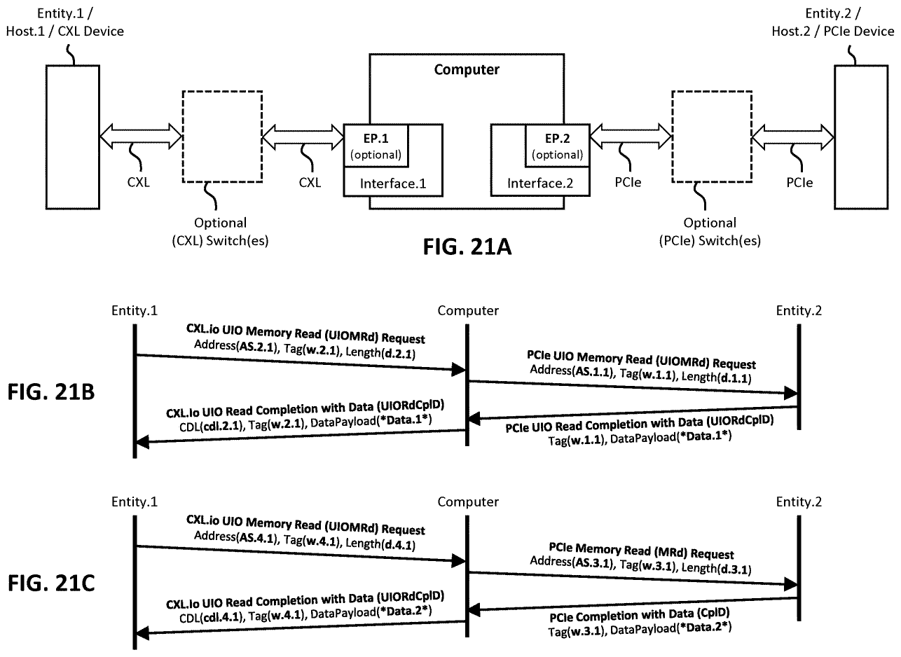

FIG. 21A illustrates an example of a system comprising a computer coupled between a first interface (Interface.1) that may communicate according to a CXL-based protocol, such as CXL.io, CXL.mem, or CXL.cache, and a second interface (Interface.2) that may communicate according to a PCIe-based protocol, such as a protocol conforming to PCI Express Base Specification Revision 6.2. The computer may be implemented in an IC package having high-speed differential I/O balls positioned according to a ball grid array layout defined by the PCIe Retimer Supplemental Features and Standard BGA Footprint Specification. The first interface may expose a first endpoint (EP.1) and may communicate according to a CXL-based protocol with a first entity (Entity.1), which may be a first host (Host.1) or a CXL device. The second interface may expose a second endpoint (EP.2) and may communicate according to a PCIe-based protocol, with a second entity (Entity.2), which may be a second host (Host.2) or a PCIe device. The computer may extract physical addresses from TLPs, PDUs, or messages, received via the first interface, wherein these addresses may refer to a first HPA space utilized by the first entity; translate these addresses; and generate TLPs, PDUs, or messages carrying the translated physical addresses for transmission via the second interface; wherein these translated addresses may correspond to a second HPA space utilized by the second entity. Optional switch(es), such as CXL switches, may be positioned between the first interface and the first entity. Additionally or alternatively, optional switch(es), such as PCIe switches, may be positioned between the second interface and the second entity.

FIG. 21B illustrates an example of a TFD demonstrating translations, performed by a computer, between CXL-based protocol data units (PDUs), such as CXL.io TLPs, received from a first entity (Entity.1), which may be a first host (Host.1) or a CXL device, and PCIe TLPs, sent to a second entity (Entity.2), which may be a second host (Host.2) or a PCIe device, possibly enabling the first entity to access resources mapped to an address space utilized by the second entity. The first entity may initiate a CXL.io transaction that includes a CXL.io UIO Memory Read (UIOMRd) request comprising Address(AS.2.1), Tag(w.2.1), and Length(d.2.1). The computer may translate the CXL.io transaction to a PCIe transaction that includes a PCIe UIOMRd comprising Address(AS.1.1), Tag(w.1.1), and Length(d.1.1), and may send the PCIe UIOMRd to the second entity. Upon receiving a completion from the second entity, which may include a PCIe UIO Read Completion with Data (UIORdCplD) comprising Tag(w.1.1) and DataPayload(*Data.1*), the computer may translate the PCIe UIORdCplD to a CXL.io UIORdCplD comprising CDL(cdl.2.1), Tag(w.2.1), and DataPayload(*Data.1*), wherein the CDL may be populated by the computer with information related to QoS, such as QoS telemetry value or values. The computer may perform further translations, such as protocol translations, opcode translations, command translations, or TLP type translations, e.g., translating between CXL.io UIO TLPs, such as CXL.io UIOMRd TLP, and PCIe non-UIO TLPs, such as PCIe MRd.

Recent PCIe hosts and devices may leverage the PCIe Unordered IO (UIO) optional capability, originally introduced as ECN, and later incorporated into PCIe Base Specification Revision 6.2. PCIe UIO defines a new wire semantic and related capabilities that address limitations of the PCI/PCIe fabric-based ordering rules, enabling improved performance and efficiency, such as by utilizing multi-path routing. The computer may further perform other translations, such as field translations between TLPs conforming to CXL.io and TLPs conforming to PCIe, translations between CXL.io Tags and PCIe Tags, translations between reserved fields, and/or translations between reserved and non-reserved fields.

FIG. 21C illustrates an example of a TFD demonstrating translations between CXL.io TLPs, received from a first entity (Entity.1), and PCIe TLPs, sent to a second entity (Entity.2), possibly enabling the first entity to access resources mapped to an address space utilized by the second entity. The computer may perform further translations, such as protocol translations, opcode translations, command translations, TLP type translations, or field translations, between CXL.io TLPs and PCIe TLPs. The first entity may initiate a CXL.io transaction that includes a CXL.io UIOMRd comprising Address(AS.4.1), Tag(w.4.1), and Length(d.4.1). The computer may translate the CXL.io transaction to a PCIe transaction that includes a PCIe Memory Read (MRd) request comprising Address(AS.3.1), Tag(w.3.1), and Length(d.3.1), and may send the PCIe MRd to the second entity. Upon receiving a completion from the second entity, which may include a PCIe Completion with Data (CplD) comprising Tag(w.3.1) and DataPayload(*Data.2*), the computer may translate the PCIe CplD to a CXL.io UIORdCplD comprising CDL(cdl.4.1), Tag(w.4.1), and DataPayload(*Data.2*), wherein the CDL may be populated by the computer with information related to QoS.

The translations may further enable communication between the first entity and the second entity over a split flit/non-flit path, wherein the CXL.io UIO portion of the path may utilize CXL protocol flits, whereas the PCIe non-UIO portion of the path may utilize Non-Flit Mode (NFM). Such split flit/non-flit path setup is not allowed in standard PCIe Revision 6.2 environments when the whole path utilizes PCIe. In the context of PCIe, Flit Mode (FM) and NFM may use different header formats, wherein routing elements may be required to translate between the FM TLP and NFM TLP formats when the Ingress Port and Egress Port are in different modes. The current PCIe specifications define PCIe UIO for FM, and no translations of UIO TLPs to NFM are permitted.

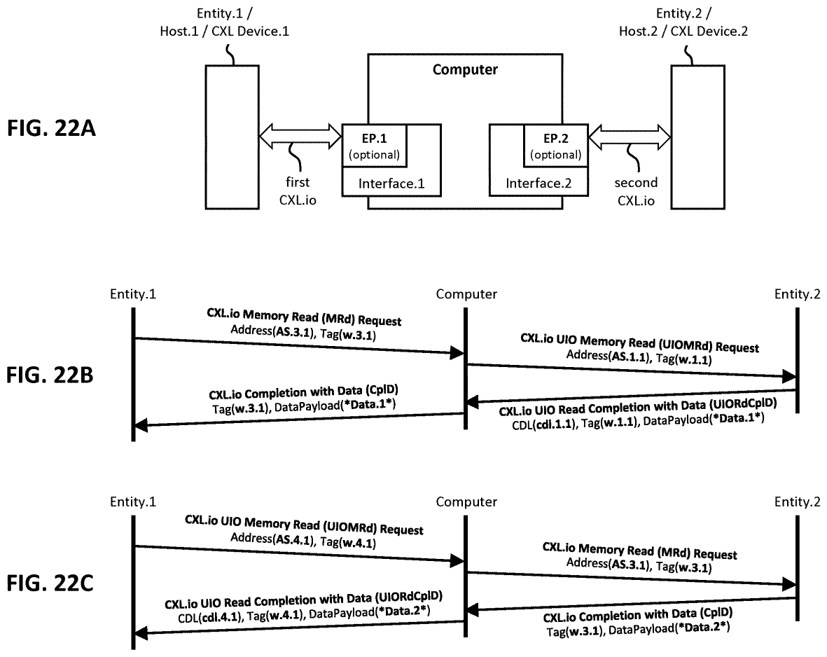

FIG. 22A illustrates an example of a system comprising a computer coupled between first and second interfaces. The first interface (Interface.1) may communicate according to first CXL.io, such as CXL.io conforming to CXL Specification Revision 1.1. The second interface (Interface.2) may communicate according to second CXL.io, such as CXL.io conforming to CXL Specification Revision 3.2. The computer may be implemented in an IC package having high-speed differential I/O balls positioned according to a ball grid array layout defined by PCIe Retimer Supplemental Features and Standard BGA Footprint Specification. The first interface may expose a first endpoint (EP.1) and may communicate according to the first CXL.io with a first entity (Entity.1), which may be a first host (Host.1) or a first CXL device (CXL Device.1). The second interface may expose a second endpoint (EP.2) and may communicate according to the second CXL.io, with a second entity (Entity.2), which may be a second host (Host.2) or a second CXL device (CXL Device.2). The computer may extract physical addresses from first PDUs, such as first CXL.io TLPs, received via the first interface, wherein these addresses may refer to a first physical address space utilized by the first entity; translate these addresses; and generate second PDUs, such as second CXL.io TLPs, carrying the translated physical addresses for transmission via the second interface; wherein these translated addresses may correspond to a second physical address space utilized by the second entity.

FIG. 22B illustrates an example of a TFD demonstrating translations between CXL.io non-UIO TLPs associated with first CXL.io, received from a first entity (Entity.1), which may be a first host (Host.1) or a first CXL device (CXL Device.1), and CXL.io UIO TLPs associated with second CXL.io, sent to a second entity (Entity.2), which may be a second host (Host.2) or a second CXL device (CXL Device.2), possibly enabling the first entity to access resources mapped to an address space utilized by the second entity. The first entity may initiate a CXL.io non-UIO transaction that may include a CXL.io Memory Read (MRd) request comprising Address(AS.3.1) and Tag(w.3.1). A computer may translate the CXL.io non-UIO transaction to a CXL.io UIO transaction that may include a CXL.io UIO Memory Read (UIOMRd) request comprising Address(AS.1.1) and Tag(w.1.1), and may send the CXL.io UIOMRd to the second entity. Upon receiving a completion from the second entity, which may include a CXL.io UIO Read Completion with Data (UIORdCplD) comprising CDL(cdl.1.1), Tag(w.1.1), and DataPayload(*Data.1*), the computer may translate the CXL.io UIORdCplD to a CXL.io Completion with Data (CplD) comprising Tag(w.3.1) and DataPayload(*Data.1*), and send the CXL.io CplD to the first entity. CDL in CXL.io UIO completions may be populated with information related to QoS, such as QoS telemetry value or values. The second entity may utilize the CDL for throttling requests from the computer. The computer may perform additional translations, such as protocol translations, opcode translations, command translations, TLP type translations, Tag translations, length translations, or field translations.

Translations from CXL.io non-UIO to CXL.io UIO may enable CXL hosts and CXL devices to utilize additional capabilities on top of capabilities provided by CXL.io non-UIO, such as peer-to-peer flows to CXL.mem regions, QoS telemetry via CDL Devload (CDL) field in UIO completions, non-posted UIO writes, access to Global-Fabric-Attached Memory Devices (GFDs), use of the Global Integrated Memory (GIM), and cross-domain UIO accesses over a CXL fabric.

FIG. 22C illustrates an example of a TFD demonstrating translations between CXL.io UIO TLPs associated with first CXL.io, received from a first entity (Entity.1), which may be a first host (Host.1) or a first CXL device (CXL Device.1), and CXL.io non-UIO TLPs associated with second CXL.io, sent to a second entity (Entity.2), which may be a second host (Host.2) or a second CXL device (CXL Device.2), possibly enabling the first entity to access resources mapped to an address space utilized by the second entity. The first entity may initiate a CXL.io UIO transaction that may include a CXL.io UIOMRd comprising Address(AS.4.1) and Tag(w.4.1). A computer may translate the CLX.io UIO transaction to a CLX.io non-UIO transaction that may include a CXL.io MRd comprising Address(AS.3.1) and Tag(w.3.1), and may send the CXL.io MRd to the second entity. Upon receiving a completion from the second entity, which may include a CXL.io Completion with Data (CplD) comprising Tag(w.3.1) and DataPayload(*Data.2*), the computer may translate the CXL.io CplD to a CXL.io UIORdCplD comprising CDL(cdl.4.1), Tag(w.4.1), and DataPayload(*Data.2*), and send the CXL.io UIORdCplD to the first entity. CDL in CXL.io UIO completions may be populated with information related to QoS, such as QoS telemetry value or values. The computer may utilize CDL for throttling requests from the first entity. The computer may perform additional translations, such as protocol translations, opcode translations, command translations, TLP type translations, Tag translations, length translations, or field translations. Translations from CXL.io UIO to CXL.io non-UIO may enable newer CXL hosts and CXL devices to utilize legacy non-UIO resources over CXL fabrics and mixed CXL/PCIe fabrics.

CXL Fabric architecture provides scalable interconnects supporting up to 4096 endpoints using Port-Based Routing (PBR). Current Global Fabric-Attached Memory devices (GFDs) are architected as subordinate-only devices that receive and respond to memory access requests, but do not initiate transactions. However, some use cases in AI/ML, high-performance computing, and composable infrastructure may benefit from fabric-attached resources that can both provide memory or compute services to hosts and peer devices, and initiate transactions to access remote resources within the fabric. A Fabric Resource Entity (FRE) may operate as both a requester and a responder within a CXL Fabric, enabling data movement, distributed processing, and fabric-level services without host intervention. Translations between CXL.io requests initiated by the FRE and requests conforming to various target protocols may enable the FRE to access diverse fabric resources including other memory devices, Global Integrated Memory (GIM), accelerators, and peer devices.

In various implementations, a method for enabling bidirectional communication by a Fabric Resource Entity (FRE) in a Compute Express Link (CXL) Fabric, comprising: receiving, from the FRE, a CXL.io request comprising a first address, wherein the FRE is coupled to the CXL Fabric and is configured to operate as both a requester that initiates CXL.io requests and a responder that provides access to resources for hosts or peer devices; translating, by a computer, the CXL.io request to a request conforming to a second protocol, wherein the request conforming to the second protocol comprises a second address; sending, to a target entity, the request conforming to the second protocol; receiving, from the target entity, a response conforming to the second protocol; translating, by the computer, the response conforming to the second protocol to a CXL.io completion; and sending, to the FRE, the CXL.io completion. The FRE may combine characteristics of memory devices, such as GFDs, with requester capabilities that enable fabric operations. The bidirectional nature of the FRE may enable use cases such as memory-to-memory data movement within the fabric, distributed computation across fabric resources, and fabric-level data services including compression, encryption, or deduplication. The computer may function as a translation bridge that enables the FRE to communicate with target entities utilizing various protocols. The method may be implemented in hardware, firmware, software, or combinations thereof.

In some implementations of the method, the CXL.io request comprises a CXL.io Unordered Input/Output (UIO) Memory Read (UIOMRd) request, and wherein the CXL.io completion comprises a CXL.io UIO Read Completion with Data (UIORdCplD). UIO transactions may be utilized for cross-domain communication within CXL Fabrics, as specified in CXL specifications. The FRE may utilize UIOMRd to access remote resources with relaxed ordering constraints, enabling multi-path routing and improved fabric utilization.

In some implementations of the method, the first address is associated with a first physical address space utilized by the FRE, and wherein the second address is associated with a second physical address space utilized by the target entity. The address translation may accommodate scenarios where the FRE and the target entity utilize different physical address spaces. The translation may be implemented utilizing lookup tables, base-and-offset calculations, or programmable translation functions configured by a Fabric Manager or system software.

In some implementations of the method, the second protocol is based on Peripheral Component Interconnect Express (PCIe) UIO, wherein the request conforming to the second protocol comprises a PCIe UIO Memory Read (UIOMRd) request, and wherein the response conforming to the second protocol comprises a PCIe UIO Read Completion with Data (UIORdCplD). The PCIe UIO path may enable the FRE to access PCIe devices that support UIO capabilities, preserving UIO across the translation.

In some implementations of the method, the second protocol is based on Peripheral Component Interconnect Express (PCIe) non-UIO, wherein the request conforming to the second protocol comprises a PCIe Memory Read (MRd) request, and wherein the response conforming to the second protocol comprises a PCIe Completion with Data (CplD). The PCIe non-UIO path may enable the FRE to access legacy PCIe devices that do not support UIO capabilities.

In some implementations of the method, the second protocol is based on CXL.mem, wherein the request conforming to the second protocol comprises a CXL.mem Master-to-Subordinate (M2S) request, and wherein the response conforming to the second protocol comprises a CXL.mem Subordinate-to-Master Data Response (S2M DRS). The CXL.mem path may enable the FRE to access other fabric-attached memory resources, such as GFDs or memory expanders, using CXL.mem. This path may be utilized for memory-to-memory operations within the fabric.

In some implementations of the method, the CXL.mem M2S request comprises MemRd*, and wherein the CXL.mem S2M DRS comprises MemData. MemRd* may request data from the target entity, and MemData may indicate successful data return in the response.

In some implementations of the method, the second protocol is based on CXL.io, wherein the request conforming to the second protocol comprises a CXL.io Memory Read request, and wherein the response conforming to the second protocol comprises a CXL.io Completion with Data. The CXL.io-to-CXL.io path may involve address translation or field translation while maintaining CXL.io on both sides of the computer.

In some implementations of the method, the CXL.io completion comprises a CXL.io Unordered Input/Output (UIO) Read Completion comprising Data (UIORdCplD) and a CXL DevLoad (CDL), and wherein the computer populates the CDL with Quality-of-Service (QoS) telemetry information. The CDL may carry telemetry information such as device load indicators or latency metrics, enabling the FRE to make informed decisions regarding request pacing or resource selection.

In some implementations, the method further comprises receiving, from the FRE, a CXL.io Unordered Input/Output (UIO) Memory Write request (UIOMWr) comprising a third address and write data; translating, by the computer, the CXL.io UIOMWr to a write request conforming to the second protocol; and sending, to the target entity, the write request conforming to the second protocol. Write transactions initiated by the FRE may enable data transfer from the FRE to remote fabric resources, supporting use cases such as result writeback after distributed computation or data replication across fabric-attached memory.

In some implementations of the method, the FRE comprises memory resources, wherein the FRE is configured to receive memory access requests from hosts or peer devices and to initiate CXL.io requests to access remote resources, and wherein the memory resources comprise at least one of Dynamic Random Access Memory (DRAM), High Bandwidth Memory (HBM), persistent memory, or storage-class memory. A memory-focused FRE may provide large-capacity fabric-attached memory while also being capable of initiating data prefetch, data migration, or memory-to-memory copy operations. The various memory technologies may provide different performance and persistence characteristics suitable for different workloads.

In some implementations of the method, the FRE comprises compute resources configured to perform data processing operations, wherein the FRE initiates the CXL.io request to access data from the target entity for the data processing operations, and wherein the compute resources comprise at least one of a processor, a data processing unit (DPU), a machine learning accelerator, a compression engine, an encryption engine, or a Direct Memory Access (DMA) engine. A compute-focused FRE may perform near-memory or in-fabric processing while accessing data from remote fabric resources. Machine learning accelerators may access training data or model parameters stored in remote memory. Compression or encryption engines may process data streams flowing through the fabric.

In some implementations of the method, the target entity comprises at least one of a Global Fabric-Attached Memory device (GFD), a memory expander, a memory pool, Global Integrated Memory (GIM) in a remote host domain, a Graphics Processing Unit (GPU), or a Network Interface Card (NIC). The diverse target entity types may enable the FRE to participate in various fabric topologies and workloads. GFDs and memory pools may provide scalable memory resources. GIM may enable cross-domain data sharing. GPUs and NICs may be accessed for heterogeneous computing or network operations.

In some implementations of the method, the FRE is identified within the CXL Fabric by a Port-Based Routing Identifier (PID), and wherein the CXL.io request comprises a Source PID (SPID) identifying the FRE. The PID may uniquely identify the FRE among up to 4096 endpoints within the CXL Fabric. The SPID in outgoing requests may enable routing of responses back to the FRE and may enable access control decisions at target entities.

In some implementations of the method, the FRE is further configured to: receive, from a host or peer device, a CXL.mem Master-to-Subordinate (M2S) request or a CXL.io Unordered Input/Output (UIO) request targeting resources of the FRE; and send, to the host or peer device, a CXL.mem Subordinate-to-Master (S2M) response or a CXL.io completion corresponding to the received request. The FRE may handle incoming requests from hosts or peer devices in parallel to processing outgoing requests to target entities. Incoming CXL.mem requests may access memory resources of the FRE, while incoming CXL.io UIO requests may provide cross-domain access to the FRE's resources.

In some implementations of the method, the FRE maintains pending CXL.io requests initiated by the FRE to the target entity and pending memory access requests received by the FRE from hosts or peer devices. The FRE may include transaction tracking structures to manage concurrent transactions in both directions. Flow control mechanisms may balance resources between outgoing and incoming transaction processing.

In some implementations of the method, the FRE maintains a first set of transaction identifiers for CXL.io requests initiated by the FRE and a second set of transaction identifiers for memory access requests received from hosts or peer devices. Separate transaction identifier spaces may avoid collisions between outgoing and incoming transactions. The first set of transaction identifiers may include Tags for CXL.io transactions, while the second set may include Tags or other identifiers for incoming requests.

In some implementations of the method, the FRE comprises an address decoder configured to translate Host Physical Addresses (HPAs) in incoming memory access requests to Device Physical Addresses (DPAs) within the FRE. The address decoder may enable the FRE to support multiple hosts or peer devices, each with their own HPA space, accessing a common DPA space within the FRE. The decoder may support per-requester translation entries similar to GFD decoder mechanisms.

In some implementations of the method, the FRE comprises a snoop filter configured to track cacheline ownership for memory resources of the FRE, and wherein the FRE is configured to issue back-invalidate snoops (BISnp) to hosts or peer devices based on the snoop filter. The snoop filter may enable hardware-managed cache coherency for shared memory regions within the FRE. When the FRE detects potential coherency conflicts, it may issue BISnp messages to invalidate stale cachelines held by hosts or peer devices.

In some implementations of the method, the FRE is coupled to the CXL Fabric via a Port-Based Routing (PBR) link, and wherein the CXL.io request is formatted according to a PBR message format. The PBR link may enable scalable fabric attachment with 12-bit PIDs supporting up to 4096 endpoints. The PBR message format may include SPID and DPID fields for fabric routing.

In various implementations, an apparatus comprising: a first interface configured to communicate with a Fabric Resource Entity (FRE) based on CXL.io, wherein CXL denotes Compute Express Link, and wherein the FRE comprises resources accessible by hosts or peer devices within a CXL Fabric and is configured to initiate CXL.io requests to access remote resources; a second interface configured to communicate with a target entity based on a second protocol; and a computer coupled to the first interface and the second interface, the computer configured to: receive, from the FRE via the first interface, a CXL.io request comprising a first address; translate the CXL.io request to a request conforming to the second protocol and comprising a second address; send, via the second interface, the request conforming to the second protocol to the target entity; receive, via the second interface, a response conforming to the second protocol from the target entity; translate the response conforming to the second protocol to a CXL.io completion; and send, via the first interface, the CXL.io completion to the FRE. The apparatus may be implemented as a semiconductor device, a switch component, a bridge device, or other suitable form factor. The apparatus may be positioned within a CXL Fabric to enable FREs to access target entities utilizing various protocols. The computer may include logic for address translation, protocol conversion, and transaction tracking.

In some implementations of the apparatus, the second protocol is based on at least one of Peripheral Component Interconnect Express (PCIe), CXL.mem, or CXL.io. The apparatus may support multiple target protocols, enabling the FRE to access diverse resources within and beyond the CXL Fabric.

In some implementations of the apparatus, the first address is associated with a first physical address space utilized by the FRE, the second address is associated with a second physical address space utilized by the target entity, and wherein the computer is further configured to translate between the first address and the second address. The apparatus may include address translation logic configured by a Fabric Manager or system software to map between the FRE's address space and target entity address spaces.

In some implementations of the apparatus, the FRE comprises at least one of memory resources or compute resources, wherein the memory resources comprise at least one of DRAM, HBM, persistent memory, or storage-class memory, and wherein the compute resources comprise at least one of a processor, a data processing unit (DPU), a machine learning accelerator, a compression engine, an encryption engine, or a Direct Memory Access (DMA) engine. The apparatus may support FREs with various resource combinations, enabling diverse fabric-level services and workloads.

In some implementations of the apparatus, the FRE is identified within the CXL Fabric by a Port-Based Routing Identifier (PID), and wherein the CXL.io request comprises a Source PID (SPID) identifying the FRE. The apparatus may utilize the SPID to identify the requesting FRE for routing responses and for access control decisions.

In various implementations, a system comprising: a Fabric Resource Entity (FRE) coupled to a Compute Express Link (CXL) Fabric, wherein the FRE is configured to receive memory access requests from hosts or peer devices and to initiate CXL.io requests as a requester within the CXL Fabric; a target entity; and a computer coupled between the FRE and the target entity, the computer configured to: receive, from the FRE, a CXL.io request comprising a first address; translate the CXL.io request to a request conforming to a second protocol utilized by the target entity, wherein the request conforming to the second protocol comprises a second address; send, to the target entity, the request conforming to the second protocol; receive, from the target entity, a response conforming to the second protocol; translate the response conforming to the second protocol to a CXL.io completion; and send, to the FRE, the CXL.io completion. The system may be deployed in datacenters, high-performance computing environments, or AI/ML infrastructure. The FRE may provide fabric-attached resources while autonomously accessing other fabric resources, enabling distributed processing and data movement without host intervention.

In some implementations of the system, the FRE comprises memory resources and compute resources, and wherein the target entity comprises at least one of a Global Fabric-Attached Memory device (GFD), a memory pool, Global Integrated Memory (GIM), a Graphics Processing Unit (GPU), or a peer device. The system may support diverse workloads including AI/ML training utilizing distributed memory, scientific computing with fabric-wide data sharing, and data analytics with near-memory processing.

In some implementations of the system, the second protocol is based on at least one of Peripheral Component Interconnect Express (PCIe), CXL.mem, or CXL.io. The system may support heterogeneous target entities utilizing different protocols within the same fabric deployment.

In some implementations, the system further comprises Fabric Resource Entities (FREs) coupled to the CXL Fabric, wherein the computer is configured to translate CXL.io requests from the FREs to requests conforming to the second protocol. Multiple FREs may cooperate within the fabric for distributed computing, parallel data processing, or redundant storage configurations.

In some implementations of the system, the FRE initiates the CXL.io request to transfer data between the FRE and the target entity without intervention by a host processor. This data transfer may reduce host processor overhead and memory bandwidth consumption. The FRE may initiate transfers for data prefetching, result writeback, checkpoint operations, or data migration between fabric-attached memory tiers.

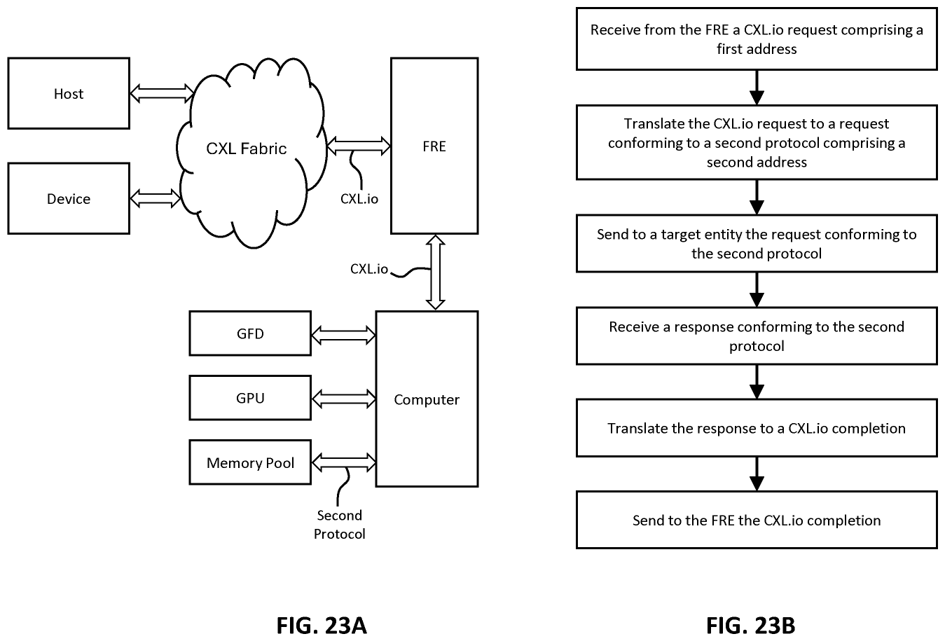

FIG. 23A illustrates a system comprising a CXL Fabric, a Host, a Device, a Fabric Resource Entity (FRE), a computer, a GFD, a GPU, and a Memory Pool. The Host and the Device are each coupled to the CXL Fabric. The FRE is coupled to the CXL Fabric via a CXL.io link, and the FRE is further coupled to the computer via a CXL.io link. The computer is coupled, via a second protocol link, to target entities that may include one or more GFDs, GPUs, and/or Memory Pools. The FRE may operate as both a requester that initiates CXL.io requests toward the computer and a responder that provides access to its resources for entities within the CXL Fabric, such as the Host or the Device. The computer may translate CXL.io requests received from the FRE to requests conforming to the second protocol, and may translate responses conforming to the second protocol received from the GFD, the GPU, or the Memory Pool to CXL.io completions for delivery to the FRE.

FIG. 23B illustrates a method for enabling bidirectional communication by an FRE in a CXL Fabric. In step 1, a CXL.io request comprising a first address is received from the FRE. In step 2, the CXL.io request is translated to a request conforming to a second protocol, wherein the request conforming to the second protocol comprises a second address. In step 3, the request conforming to the second protocol is sent to a target entity. In step 4, a response conforming to the second protocol is received. In step 5, the response conforming to the second protocol is translated to a CXL.io completion. And in step 6, the CXL.io completion is sent to the FRE.

In heterogeneous computing architectures, entities may utilize different PCIe revisions while requiring coordinated access to shared resources. PCIe Unordered IO (UIO) is an optional capability that addresses limitations of PCI/PCIe fabric-based ordering rules, enabling multi-path routing, improved performance, and simplified fabric elements. However, PCIe specifications define UIO for Flit Mode (FM), and require that the entire path from requester to completer uses FM, supports UIO, and has UIO enabled. In environments where a first entity utilizing one PCIe revision needs to access resources coupled to a second entity utilizing a different PCIe revision, translations between PCIe UIO TLPs and PCIe non-UIO TLPs may facilitate memory operations and data transfers across different domains. Such translations may be performed by a computer, an apparatus, a cable, or other suitable devices positioned between the first entity and the second entity. The translations may further enable communication over split flit-mode/non-flit-mode paths, wherein the UIO portion utilizes flit-based encoding while the non-UIO portion may utilize non-flit-based encoding.

In various implementations, a method for translating between Peripheral Component Interconnect Express (PCIe) Transaction Layer Packets (TLPs), comprising: receiving, from a first entity, a first PCIe Memory Read request comprising a first address and a first Tag; translating, by a computer, the first PCIe Memory Read request to a second PCIe Memory Read request comprising a second address and a second Tag; wherein one of the first PCIe Memory Read request and the second PCIe Memory Read request comprises an Unordered Input/Output (UIO) Memory Read (UIOMRd) request, and the other comprises a non-UIO Memory Read (MRd) request; sending, to a second entity, the second PCIe Memory Read request; receiving, from the second entity, a second PCIe Completion comprising the second Tag and a data payload; translating, by the computer, the second PCIe Completion to a first PCIe Completion comprising the first Tag and the data payload; and sending, to the first entity, the first PCIe Completion. The translation process may encompass various aspects of the protocol messages, including opcodes, addresses, Tags, and other TLP fields, thereby enabling communication between entities that utilize different PCIe revisions. The computer may maintain state information, such as pending transaction tables or tracker entries, to correlate incoming PCIe Completions with previously transmitted PCIe Memory Read requests and with pending transactions. The method may be implemented in hardware, firmware, software, or combinations thereof, and may be performed by various types of devices, such as semiconductor devices, switches, bridges, or active cables. Additionally, the elements may communicate through one or more intermediary components, such as a switch, a retimer, or other suitable entity that facilitates information transfer.

In some implementations of the method, the first PCIe Memory Read request comprises the non-UIO MRd, the second PCIe Memory Read request comprises the UIO Memory Read (UIOMRd) request, the second PCIe Completion comprises a UIO Read Completion with Data (UIORdCplD), and the first PCIe Completion comprises a non-UIO Completion with Data (CplD). The non-UIO to UIO translation may enable a first entity that does not support UIO capabilities to access resources coupled to a second entity via a UIO-enabled path. The computer may translate the MRd to a UIOMRd, which may traverse a path supporting multi-path routing or out-of-order completion delivery. Upon receiving the UIORdCplD from the second entity, the computer may translate it to a CplD conforming to non-UIO PCIe completion expected by the first entity.

In some implementations of the method, the UIORdCplD comprises a CXL DevLoad (CDL), and wherein the computer extracts information from the CDL for at least one of: populating a CDL in a response to another entity, throttling subsequent requests, or storing Quality-of-Service (QoS) telemetry. The CDL in the UIORdCplD may carry telemetry information such as device load indicators, queue depth information, or latency metrics populated by the second entity or intermediate components. The computer may extract this information and utilize it for various purposes, such as propagating QoS telemetry to upstream components, implementing adaptive flow control by throttling the rate of subsequent requests, or storing the telemetry for monitoring and analysis. This extraction may enable the computer to make informed decisions regarding request pacing, load balancing, or resource allocation based on conditions observed at the second entity.

In some implementations of the method, the first PCIe Memory Read request comprises the UIO Memory Read (UIOMRd) request, the second PCIe Memory Read request comprises the non-UIO MRd, the second PCIe Completion comprises a non-UIO Completion with Data (CplD), and the first PCIe Completion comprises a UIO Read Completion with Data (UIORdCplD). The UIO to non-UIO translation may enable a first entity utilizing PCIe UIO to access resources coupled to a second entity that does not support UIO capabilities. The computer may translate the UIOMRd to a PCIe MRd, which may extend the reach of UIO-capable devices to legacy PCIe infrastructure or to devices that have not implemented UIO support.

In some implementations of the method, the UIORdCplD comprises a CXL DevLoad (CDL), and wherein the computer populates the CDL with Quality-of-Service (QoS) telemetry information based on at least one of: queue depth at the computer, observed latency, congestion indicators, or bandwidth utilization metrics. When translating from PCIe non-UIO completions that do not include a CDL, the computer may populate the CDL in the UIORdCplD to provide telemetry information to the first entity. The QoS telemetry information may be generated by the computer based on locally observed conditions. Queue depth may indicate the number of pending transactions awaiting completion. Observed latency may reflect the time elapsed between sending requests and receiving completions. Congestion indicators may signal backpressure conditions in downstream paths. Bandwidth utilization metrics may indicate the degree to which available bandwidth is being consumed. The first entity may utilize this telemetry information to make informed decisions about subsequent memory operations, such as throttling request rates, adjusting request priorities, or selecting alternative resources based on observed loading conditions. The computer may thus provide telemetry to the first entity even when the second entity does not support telemetry reporting.

In some implementations of the method, the first address is associated with a first physical address space utilized by the first entity, and wherein the second address is associated with a second physical address space utilized by the second entity. The address translation may be implemented utilizing lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations, the method further comprises receiving, from the first entity, a PCIe non-UIO Memory Write request (MWr) comprising a third address and write data; translating, by the computer, the PCIe MWr to a PCIe UIO Memory Write request (UIOMWr) comprising a fourth address and the write data; sending, to the second entity, the PCIe UIOMWr; and receiving, from the second entity, a PCIe UIO Write Completion (UIOWrCpl). The translation from non-UIO to UIO write may involve converting a posted write (MWr) that does not expect a completion into a non-posted write (UIOMWr) that receives a UIOWrCpl from the second entity. The UIOMWr may traverse a path supporting multi-path routing, potentially improving write performance in fabric topologies with multiple paths between source and destination. The computer may utilize the UIOWrCpl for flow control, error recovery, transaction ordering, or as a basis for generating a write acknowledgment to the first entity, as described in dependent claims.

In some implementations of the method, the computer buffers the write data prior to sending the PCIe UIOMWr, and wherein the computer utilizes the UIOWrCpl for at least one of: flow control, error recovery, or transaction ordering. The computer may buffer the write data internally to decouple the timing of receiving the MWr from the first entity and sending the UIOMWr to the second entity. The UIOWrCpl received from the second entity may provide confirmation that the write data has been accepted, which the computer may utilize for flow control by releasing buffer space, for error recovery by detecting and handling failed writes, or for transaction ordering by confirming completion of writes before allowing subsequent dependent operations.

In some implementations, the method further comprises receiving, from the first entity, a PCIe UIO Memory Write request (UIOMWr) comprising a third address, a third Tag, and write data; translating, by the computer, the PCIe UIOMWr to a PCIe non-UIO Memory Write request (MWr) comprising a fourth address and the write data; sending, to the second entity, the PCIe MWr; and sending, to the first entity, a PCIe UIO Write Completion (UIOWrCpl) comprising the third Tag. The translation from UIO to non-UIO write may involve converting a non-posted write (UIOMWr) that expects a completion into a posted write (MWr) that does not return a completion from the second entity. The computer may generate the UIOWrCpl to acknowledge receipt of the write data to the first entity, even though the second entity does not provide a completion for the posted MWr. This translation may enable UIO-capable devices to write to legacy PCIe devices while maintaining the non-posted write semantics expected by the first entity.

In some implementations of the method, the computer sends the UIOWrCpl to the first entity at one of: before sending the PCIe MWr to the second entity, in parallel with sending the PCIe MWr to the second entity, or after sending the PCIe MWr to the second entity; and wherein the UIOWrCpl comprises a CXL DevLoad (CDL) populated by the computer. The timing of the UIOWrCpl may provide different trade-offs between latency and ordering guarantees. Sending the UIOWrCpl before sending the MWr may reduce latency observed by the first entity and may allow the first entity to proceed with subsequent operations without waiting for the write to propagate to the second entity. Sending the UIOWrCpl in parallel with or after sending the MWr may provide stronger ordering guarantees at the cost of increased latency. The computer may populate the CDL with QoS telemetry information based on locally observed conditions, providing telemetry to the first entity even though the second entity does not return a completion.

In some implementations of the method, the computer buffers the write data, and wherein the computer is configured to retry sending the PCIe MWr to the second entity upon detecting a transmission error. The computer may retain the write data in a buffer after generating the UIOWrCpl to the first entity, enabling error recovery if the posted MWr encounters transmission errors on the path to the second entity. The computer may implement retry logic that re-sends the MWr upon detecting errors, thereby providing reliability guarantees to the first entity even though the posted write on the non-UIO path does not inherently provide acknowledgment. The buffer may be released after the computer determines that the MWr has been successfully transmitted or accepted by downstream components.

In some implementations of the method, communication between the computer and the first entity utilizes a first encoding mode, communication between the computer and the second entity utilizes a second encoding mode different from the first encoding mode, one of the first encoding mode and the second encoding mode comprises flit-based encoding and the other comprises non-flit-based encoding, the first entity comprises at least one of a PCIe host or a PCIe device, and the second entity comprises at least one of a PCIe host or a PCIe device. The split flit/non-flit path may enable communication between entities operating in different encoding modes. PCIe specifications define UIO for flit-based encoding, and do not permit direct translation of UIO TLPs to non-flit-based encoding. By performing TLP type translation, the computer may bridge these incompatible modes, enabling PCIe UIO transactions to reach PCIe devices operating in non-flit mode, or enabling non-flit PCIe devices to access resources via UIO-enabled paths. The first entity and second entity may include various types of hosts and devices, such as servers, processors, GPUs, NICs, storage controllers, memory expanders, or accelerators.

In various implementations, a system for translating between Peripheral Component Interconnect Express (PCIe) Transaction Layer Packets (TLPs), comprising: a first interface configured to communicate with a first entity; a second interface configured to communicate with a second entity; and a computer coupled between the first interface and the second interface, the computer configured to: receive, via the first interface, a first PCIe Memory Read request comprising a first address and a first Tag; translate the first PCIe Memory Read request to a second PCIe Memory Read request comprising a second address and a second Tag; wherein one of the first PCIe Memory Read request and the second PCIe Memory Read request comprises an Unordered Input/Output (UIO) Memory Read (UIOMRd) request, and the other comprises a non-UIO Memory Read (MRd) request; send, via the second interface, the second PCIe Memory Read request; receive, via the second interface, a second PCIe Completion comprising the second Tag and a data payload; translate the second PCIe Completion to a first PCIe Completion comprising the first Tag and the data payload; and send, via the first interface, the first PCIe Completion. The system may be implemented as a semiconductor device, a switch, a bridge, an active cable, or other suitable device positioned between the first entity and the second entity. The first interface and second interface may include physical layer components, link layer components, and transaction layer components configured based on PCIe specifications. The computer may include translation logic, address translation tables, Tag mapping structures, and pending transaction trackers to perform the translation between PCIe UIO and non-UIO TLPs.

In some implementations of the system, the first interface is configured to operate in a first encoding mode, wherein the second interface is configured to operate in a second encoding mode different from the first encoding mode, and wherein one of the first encoding mode and the second encoding mode comprises flit-based encoding and the other comprises non-flit-based encoding. The system may bridge flit-based and non-flit-based encoding modes, enabling UIO transactions originating from or destined to entities operating in Flit Mode to traverse paths operating in Non-Flit Mode, or vice versa. The first interface and second interface may each include encoding and decoding logic appropriate for their respective encoding modes, and the computer may handle the conversion between the different TLP header formats associated with each mode.

In some implementations of the system, the computer comprises: translation logic configured to translate between the UIOMRd and the MRd, and tracker entries, each configured to store a mapping between the first Tag and the second Tag for a pending transaction. The translation logic may include opcode mapping tables, address translation units, and field manipulation circuits to convert between UIO and non-UIO TLP formats. The tracker entries may be implemented as registers, memory structures, or content-addressable memory entries that associate incoming Tags with outgoing Tags and with other transaction state information. The tracker entries may enable the computer to handle concurrent transactions, with each entry tracking a separate pending read or write operation.

In some implementations of the system, the computer is configured to translate between a first physical address belonging to a first physical address space utilized by the first entity and a second physical address belonging to a second physical address space utilized by the second entity; wherein the first entity comprises at least one of a GPU, a Network Interface Card (NIC), a DMA engine, an accelerator, or a PCIe host; and wherein the second entity comprises at least one of a memory device, a memory expander, a memory pool, a storage controller, or a PCIe device. The address translation may be implemented utilizing lookup tables, translation lookaside buffers, page table walkers, or programmable translation functions. The address translation functionality may be configured by system software, firmware, or hardware configuration to establish mappings between the first and second physical address spaces. The computer may support various address space configurations, including identity mapping, offset-based translation, or arbitrary mapping based on page tables or similar structures.

In some implementations of the system, the first interface exposes a first endpoint to the first entity; wherein the second interface exposes a second endpoint to the second entity; and wherein the computer is implemented in an integrated circuit package comprising high-speed differential input/output (I/O) connections positioned according to a ball grid array (BGA) layout. The first endpoint may appear to the first entity as a PCIe device or a PCIe root port, depending on the system configuration. The second endpoint may similarly appear to the second entity as a PCIe device or a PCIe root port. The endpoints may implement capability structures, configuration space registers, and link management functions based on PCIe specifications, enabling the first entity and second entity to discover and communicate with the system using standard PCIe enumeration and configuration mechanisms. Additionally or alternatively, the IC package may conform to PCIe Retimer Supplemental Features and Standard BGA Footprint Specification or similar industry specifications. The BGA layout may facilitate integration of the system into standard PCIe card edge connector configurations, add-in card designs, or motherboard layouts. The high-speed differential I/O connections may support data rates such as 32.0 GT/s or higher as specified by PCIe Revision 6.0 or later specifications.

In various implementations, a method for enabling Unordered Input/Output (UIO) transactions over a split flit-mode/non-flit-mode path, comprising: receiving, via a first interface operating in a first data stream mode, a first Peripheral Component Interconnect Express (PCIe) Transaction Layer Packet (TLP); translating, by a computer, the first PCIe TLP to a second PCIe TLP, wherein the first PCIe TLP comprises a UIO TLP and the second PCIe TLP comprises a non-UIO TLP, or wherein the first PCIe TLP comprises a non-UIO TLP and the second PCIe TLP comprises a UIO TLP; and sending, via a second interface operating in a second data stream mode different from the first data stream mode, the second PCIe TLP; wherein one of the first data stream mode and the second data stream mode comprises Flit Mode (FM), and the other comprises Non-Flit Mode (NFM). PCIe specifications define UIO for Flit Mode, and no translations of UIO TLPs to Non-Flit Mode are permitted according to the PCIe Revision 6.2 specification. The method may enable communication between a first entity and a second entity utilizing UIO over a split FM/NFM path, wherein the UIO TLPs may traverse a path that utilizes FM, whereas the non-UIO TLPs may traverse a path that utilizes NFM. Such split FM/NFM path setup is not permitted in standard PCIe Revision 6.2 environments, and may be enabled by the translation capabilities of the computer. The Data Stream mode may be determined during initial Link training, wherein each PCIe Link is set up following a negotiation of Link width, data rate, and Flit mode by the two agents at each end of the Link.

In some implementations of the method, the first data stream mode comprises FM, the second data stream mode comprises NFM, the first PCIe TLP comprises a UIO TLP, and the second PCIe TLP comprises a non-UIO TLP. The FM-to-NFM direction may enable a first entity operating in Flit Mode with UIO capabilities to access resources coupled to a second entity operating in Non-Flit Mode. The computer may translate the UIO TLP received via the FM interface to a non-UIO TLP for transmission via the NFM interface, thereby bridging the encoding mode boundary while adapting the TLP type to conform to the capabilities of the NFM path.

In some implementations of the method, the first data stream mode comprises NFM, the second data stream mode comprises FM, the first PCIe TLP comprises a non-UIO TLP, and the second PCIe TLP comprises a UIO TLP. The NFM-to-FM direction may enable a first entity operating in Non-Flit Mode to access resources coupled to a second entity via a Flit Mode path that supports UIO. The computer may translate the non-UIO TLP received via the NFM interface to a UIO TLP for transmission via the FM interface, thereby enabling the first entity to benefit from UIO capabilities such as multi-path routing even though the first entity operates in NFM.

In some implementations, the method further comprises receiving, via the second interface, a third PCIe TLP comprising a PCIe Completion corresponding to the second PCIe TLP; translating, by the computer, the third PCIe TLP to a fourth PCIe TLP; and sending, via the first interface, the fourth PCIe TLP to a first entity. The completion flow may complete the transaction initiated by the first PCIe TLP. The third PCIe TLP may include a UIO completion or a non-UIO completion depending on the TLP type of the second PCIe TLP. The computer may translate the third PCIe TLP to the fourth PCIe TLP, which may include a UIO completion or a non-UIO completion corresponding to the TLP type of the first PCIe TLP, thereby maintaining protocol consistency on each side of the computer.

In some implementations of the method, the first PCIe TLP comprises a UIO Memory Read (UIOMRd) request, the second PCIe TLP comprises a non-UIO Memory Read (MRd) request, the third PCIe TLP comprises a non-UIO Completion with Data (CplD), the fourth PCIe TLP comprises a UIO Read Completion with Data (UIORdCplD) comprising a CXL DevLoad (CDL), and wherein the computer populates the CDL. When translating from a CplD that does not include a CDL to a UIORdCplD that includes a CDL, the computer may populate the CDL with QoS telemetry information based on locally observed conditions. This population may enable the first entity to receive telemetry feedback even when the second entity does not support UIO or telemetry reporting.

In some implementations of the method, the first PCIe TLP comprises a non-UIO Memory Read (MRd) request, the second PCIe TLP comprises a UIO Memory Read (UIOMRd) request, the third PCIe TLP comprises a UIO Read Completion with Data (UIORdCplD) comprising a CXL DevLoad (CDL), and the fourth PCIe TLP comprises a non-UIO Completion with Data (CplD). When translating from a UIORdCplD that includes a CDL to a CplD that does not include a CDL, the computer may extract the information from the CDL and utilize it for purposes such as throttling subsequent requests, implementing adaptive flow control, or storing the telemetry for monitoring and analysis.

In some implementations of the method, the first PCIe TLP comprises a PCIe Memory Write request, and wherein the method further comprises: receiving, via the second interface, a third PCIe TLP comprising a PCIe UIO Write Completion (UIOWrCpl) when the second PCIe TLP comprises a UIO Memory Write request (UIOMWr); translating, by the computer, the third PCIe TLP to a fourth PCIe TLP; and sending, via the first interface, the fourth PCIe TLP. When the first PCIe TLP comprises a UIOMWr transmitted via an FM interface, the second PCIe TLP may include a MWr transmitted via an NFM interface as a posted write. The computer may generate a UIOWrCpl to send to the first entity even though the second entity does not return a completion for the posted MWr. Conversely, when the first PCIe TLP comprises a MWr, the computer may translate it to a UIOMWr and receive a UIOWrCpl from the second entity.

In some implementations of the method, the first PCIe TLP comprises a first physical address in a first physical address space, the second PCIe TLP comprises a second physical address in a second physical address space, a first entity coupled to the first interface comprises at least one of a GPU, a Network Interface Card (NIC), a DMA engine, or an accelerator, and wherein a second entity coupled to the second interface comprises at least one of a memory device, a memory expander, a memory pool, a storage controller, or a PCIe host. GPUs may utilize PCIe memory transactions to access large memory pools for graphics rendering, machine learning inference, or general-purpose GPU computing workloads. NICs may utilize PCIe memory transactions to access memory buffers for network packet processing, RDMA, or storage traffic handling. DMA engines may utilize PCIe memory transactions to transfer data between memory regions on behalf of other system components. The address translation may enable these devices to access resources utilizing addresses within their native address space while the second entity operates within its own address space.

In some implementations of the method, the first interface exposes a first endpoint to a first entity, wherein the second interface exposes a second endpoint to a second entity, wherein the first PCIe TLP comprises a first physical address in a first physical address space utilized by the first entity, and wherein the second PCIe TLP comprises a second physical address in a second physical address space utilized by the second entity. The first endpoint may be configured as a PCIe endpoint that appears to the first entity as a PCIe device operating in the first data stream mode. The second endpoint may be configured as a PCIe endpoint that appears to the second entity as a PCIe device operating in the second data stream mode. The endpoints may handle link training, flow control initialization, and capability negotiation according to their respective data stream modes. The address translation between the first physical address space and the second physical address space may be implemented utilizing lookup tables, page tables, base-and-offset calculations, or programmable translation functions.

In various implementations, a system for enabling Unordered Input/Output (UIO) transactions over a split flit-mode/non-flit-mode path, comprising: a first interface configured to operate in a first data stream mode and to communicate with a first entity; a second interface configured to operate in a second data stream mode different from the first data stream mode and to communicate with a second entity; wherein one of the first data stream mode and the second data stream mode comprises Flit Mode (FM), and the other comprises Non-Flit Mode (NFM); and a computer coupled between the first interface and the second interface, the computer configured to: receive, via the first interface, a first Peripheral Component Interconnect Express (PCIe) Transaction Layer Packet (TLP); translate the first PCIe TLP to a second PCIe TLP, wherein the first PCIe TLP comprises a UIO TLP and the second PCIe TLP comprises a non-UIO TLP, or wherein the first PCIe TLP comprises a non-UIO TLP and the second PCIe TLP comprises a UIO TLP; and send, via the second interface, the second PCIe TLP. The system may bridge Flit Mode and Non-Flit Mode encoding boundaries while performing TLP type translation between UIO and non-UIO formats. The first interface and second interface may each include physical layer components configured for their respective data stream modes, including different scrambling, encoding, and framing mechanisms. The computer may include translation logic to convert between the different TLP header formats and field arrangements associated with FM and NFM operation.

In some implementations of the system, the first interface is configured to perform link training to establish the first data stream mode with the first entity, and wherein the first entity comprises at least one of a legacy PCIe device operating in NFM, a GPU, or a NIC; and wherein the second interface is configured to perform link training to establish the second data stream mode with the second entity, and wherein the second entity comprises at least one of a UIO-capable memory device, a memory pool operating in FM, or a fabric switch. The link training may include negotiation of Link width, data rate, and Flit mode between each interface and its respective entity. The first interface may negotiate FM with the first entity if both support FM, or may fall back to NFM otherwise. The second interface may independently negotiate FM or NFM with the second entity. The system may thus establish different data stream modes on each interface based on the capabilities of the connected entities. Additionally, legacy PCIe devices may operate in NFM due to hardware generation or design choices, and may benefit from access to UIO-enabled paths through the system's translation capabilities. GPUs and NICs may operate in either FM or NFM depending on their capabilities and may utilize the system to access memory resources across encoding mode boundaries. Memory pools and fabric switches operating in FM with UIO support may provide high-bandwidth, low-latency memory access that becomes accessible to NFM devices through the system.

In some implementations of the system, the first interface supports a first data rate, wherein the second interface supports a second data rate different from the first data rate, and wherein FM is selected when a data rate exceeds a threshold data rate. PCIe specifications may require FM for data rates exceeding 32.0 GT/s. The system may support different data rates on each interface, with the first interface potentially operating at a higher data rate in FM while the second interface operates at a lower data rate in NFM, or vice versa. This capability may enable the system to connect entities with different performance capabilities while providing translation between encoding modes.

In some implementations of the system, the computer comprises: translation logic configured to translate between UIO TLPs and non-UIO TLPs; and an address translation unit configured to translate between a first physical address belonging to a first physical address space utilized by the first entity and a second physical address belonging to a second physical address space utilized by the second entity. The translation logic may include opcode mapping circuits, header format converters, and field manipulation logic to transform TLPs between UIO and non-UIO formats while also converting between FM and NFM header layouts. The address translation unit may operate in conjunction with the translation logic to modify addresses during the TLP translation process.

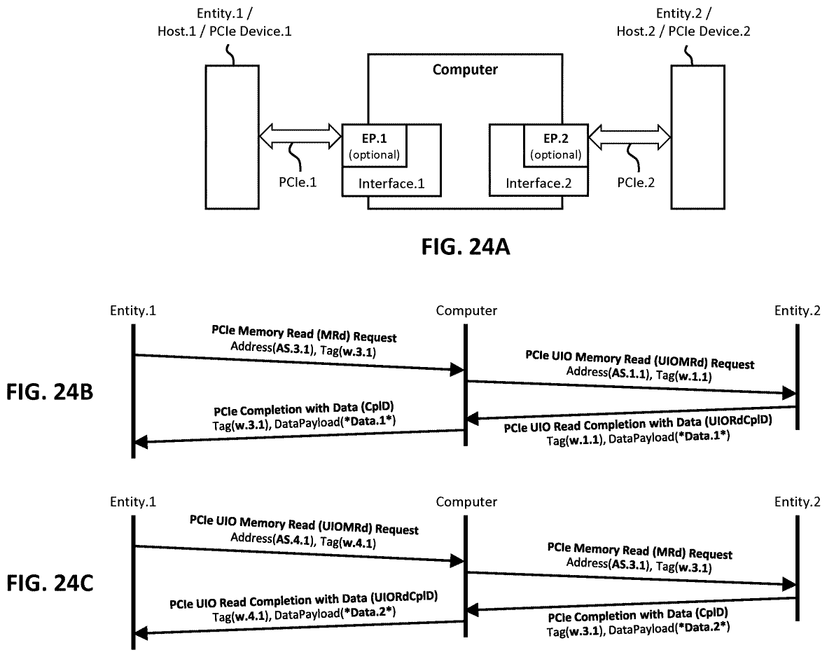

FIG. 24A illustrates an example of a system comprising a computer coupled between first and second interfaces. The first interface (Interface.1) may communicate according to a first PCIe-based protocol, such as PCIe Specification Revision 5.0. The second interface (Interface.2) may communicate according to a second PCIe-based protocol, such as PCIe Specification Revision 6.2. The computer may be implemented in an IC package having high-speed differential I/O balls positioned according to a ball grid array layout defined by PCIe Retimer Supplemental Features and Standard BGA Footprint Specification. The first interface may expose a first endpoint (EP.1) and may communicate according to the first PCIe-based protocol with a first entity (Entity.1), which may be a first host (Host.1) or a first PCIe device (PCIe Device.1). The second interface may expose a second endpoint (EP.2) and may communicate according to the second PCIe-based protocol, with a second entity (Entity.2), which may be a second host (Host.2) or a second PCIe device (PCIe Device.2). The computer may extract physical addresses from first PDUs, such as first TLPs, received via the first interface, wherein these addresses may refer to a first physical address space utilized by the first entity; translate these addresses; and generate second PDUs, such as second TLPs, carrying the translated physical addresses for transmission via the second interface; wherein these translated addresses may correspond to a second physical address space utilized by the second entity.

FIG. 24B illustrates an example of a transaction flow diagram (TFD) demonstrating translations between TLPs associated with a first PCIe, received from a first entity (Entity.1), which may be a first host (Host.1) or a first PCIe device (PCIe Device.1), and UIO TLPs associated with a second PCIe, sent to a second entity (Entity.2), which may be a second host (Host.2) or a second PCIe device (PCIe Device.2), possibly enabling the first entity to access resources mapped to an address space utilized by the second entity. The first entity may initiate a PCIe transaction that includes a PCIe Memory Read (MRd) request comprising Address(AS.3.1) and Tag(w.3.1). A computer may translate the PCIe transaction to a PCIe UIO transaction that includes a PCIe UIO Memory Read (UIOMRd) request comprising Address(AS.1.1) and Tag(w.1.1), and may send the PCIe UIOMRd to the second entity. Upon receiving a completion from the second entity, which may include a PCIe UIO Read Completion with Data (UIORdCplD) comprising Tag(w.1.1), and DataPayload(*Data.1*), the computer may translate the PCIe UIORdCplD to a PCIe Completion with Data (CplD) comprising Tag(w.3.1) and DataPayload(*Data.1*), and send the PCIe CplD to the first entity.

The computer may perform further translations, such as protocol translations, opcode translations, command translations, TLP type translations, Tag translations, length translations, or field translations. Recent PCIe hosts and devices may utilize the PCIe Unordered IO (UIO) optional capability, originally introduced as ECN, and later incorporated into PCIe Base Specification Revision 6.2. PCIe UIO defines a new wire semantic and related capabilities that address limitations of the PCI/PCIe fabric-based ordering rules, enabling improved performance and efficiency, such as by utilizing multi-path routing. Some PCIe revisions, such as PCIe Revision 6.2, may use two Data Stream modes: Flit Mode (FM), and Non-Flit Mode (NFM). Support of Data Stream in NFM may be mandatory, while support of Data Stream in FM may be mandatory for example only if data rate that exceeds 32.0 GT/s is supported. The Data Stream mode may be determined during initial Link training, wherein each PCIe Link is set up following a negotiation of Link width, data rate, and Flit mode by the two agents at each end of the Link. If FM is not disabled, and if both the Ports (and all Pseudo-Ports, if any) support it, FM may be chosen. Otherwise, NFM may be chosen. The current PCIe specifications define PCIe UIO for FM, and no translations of UIO TLPs to NFM are permitted. According to PCIe Revision 6.2 specifications, UIO may be used when the entire path from requester to completer uses FM, supports UIO, and has UIO enabled. The translations may further enable communication between the first entity and the second entity utilizing UIO over a split FM/NFM path, wherein the UIO TLPs may traverse a path that may utilize FM, whereas the non-UIO TLPs may traverse a path that may utilize NFM. Such split FM/NFM path setup is not allowed in standard PCIe Revision 6.2 environments, and may be enabled by the translation capabilities of the computer.

FIG. 24C illustrates an example of a TFD demonstrating translations between UIO TLPs associated with a first PCIe, received from a first entity (Entity.1), which may be a first host (Host.1) or a first PCIe device (PCIe Device.1), and TLPs associated with a second PCIe, sent to a second entity (Entity.2), which may be a second host (Host.2) or a second PCIe device (PCIe Device.2), possibly enabling the first entity to access resources mapped to an address space utilized by the second entity. The first entity may initiate a PCIe UIO transaction that includes a PCIe UIOMRd comprising Address(AS.4.1) and Tag(w.4.1). A computer may translate the PCIe UIO transaction to a PCIe transaction that includes a PCIe MRd comprising Address(AS.3.1) and Tag(w.3.1), and may send the PCIe MRd to the second entity. Upon receiving a completion from the second entity, which may include a PCIe CplD comprising Tag(w.3.1) and DataPayload(*Data.2*), the computer may translate the PCIe CplD to a PCIe UIORdCplD comprising Tag(w.4.1), and DataPayload(*Data.2*), and send the PCIe UIORdCplD to the first entity. The computer may perform further translations, such as protocol translations, opcode translations, command translations, TLP type translations, Tag translations, length translations, or field translations.

The PCIe specification Revision 6.2 defines PCIe UIO for FM, no translations of UIO TLPs to NFM are permitted, and UIO may be used when the entire path from requester to completer uses FM, supports UIO, and has UIO enabled. The translations may further enable communication between the first entity and the second entity utilizing UIO over a split FM/NFM path, wherein the UIO TLPs may traverse a path that may utilize FM, whereas the non-UIO TLPs may traverse a path that may utilize NFM. Such split FM/NFM path setup is not allowed in standard PCIe Revision 6.2 environments, and may be enabled by the translation capabilities of the computer.

PCIe UIO is a capability that enables fabrics with multiple paths between a source and destination, more closely matching the semantics of common IO fabrics including on-die fabrics. UIO shifts the responsibility for enforcing observed ordering from the fabric to the requester, simplifying fabric elements such as switches. All UIO requests have corresponding UIO Completions, which provide the requester with the ability and responsibility to enforce ordering requirements. However, UIO may only be used when the entire path from requester to completer uses Flit Mode, supports UIO, and has UIO enabled. In environments where requesters that do not utilize UIO need to access resources via UIO-enabled paths, or where UIO requesters need to access resources via non-UIO paths, translations between PCIe UIO and PCIe non-UIO TLPs may enable access to multi-path routing benefits or may manage the transition between different ordering models. Such translations may be performed by a computer located between the requester and completer.

In various implementations, a method for enabling multi-path routing for a requester, comprising: receiving, from a first entity that does not utilize Unordered Input/Output (UIO), a Peripheral Component Interconnect Express (PCIe) memory request; translating, by a computer, the PCIe memory request to a PCIe UIO memory request; sending the PCIe UIO memory request to a second entity via a path supporting multi-path routing; receiving, from the second entity, a PCIe UIO Completion; translating, by the computer, the PCIe UIO Completion to a PCIe non-UIO Completion; and sending the PCIe non-UIO Completion to the first entity. The translation from non-UIO to UIO may enable a first entity that does not support UIO capabilities to access resources via paths that support multi-path routing. Multi-path routing may provide benefits such as higher bandwidth through utilization of parallel paths, lower latency through selection of less congested paths, and improved fault tolerance through availability of alternative paths when failures occur. The computer may perform the translation transparently, such that the first entity is unaware that the downstream path utilizes UIO. The method may be implemented in hardware, firmware, software, or combinations thereof.

In some implementations of the method, the path supporting multi-path routing comprises a fabric providing concurrent paths between the computer and the second entity. Non-UIO PCIe fabrics typically utilize tree topologies where a single path exists between any source and destination. UIO may enable fabric topologies where concurrent paths exist between a source and destination, permitting the fabric to distribute traffic across multiple paths for load balancing or to select alternative paths based on congestion or fault conditions. The fabric providing concurrent paths may include switches, bridges, or other routing elements that support UIO and implement mechanisms to manage multi-path routing while avoiding deadlocks and loops. Such topologies may include mesh interconnects, redundant link configurations, or parallel switch fabrics.

In some implementations of the method, the PCIe UIO memory request is routed via one of the concurrent paths selected based on at least one of: load balancing, congestion avoidance, or fault tolerance. Load balancing may distribute requests across available paths to maximize aggregate bandwidth utilization. Congestion avoidance may route requests away from paths experiencing high utilization or backpressure. Fault tolerance may enable continued operation when one or more paths become unavailable due to link failures, device failures, or maintenance activities. The selection mechanism may be implemented in the fabric routing elements using techniques such as adaptive routing algorithms, weighted path selection, or explicit path specification.

In some implementations of the method, the PCIe memory request comprises a non-UIO Memory Read (MRd) request comprising a first address and a first Tag, wherein the PCIe UIO memory request comprises a UIO Memory Read (UIOMRd) request comprising a second address and a second Tag, wherein the PCIe UIO Completion comprises a UIO Read Completion with Data (UIORdCplD), and wherein the PCIe non-UIO Completion comprises a non-UIO Completion with Data (CplD). The MRd from the first entity may conform to PCIe memory read with fabric-based ordering. The computer may translate the MRd to a UIOMRd for transmission to the second entity via the multi-path fabric. Upon receiving the UIORdCplD from the second entity, the computer may translate it to a CplD in the non-UIO completion format expected by the first entity.

In some implementations, the method further comprises receiving, from the first entity, a PCIe non-UIO Memory Write request (MWr) comprising write data; translating, by the computer, the PCIe MWr to a PCIe UIO Memory Write request (UIOMWr) comprising the write data; sending the PCIe UIOMWr to the second entity via the path supporting multi-path routing; and receiving, from the second entity, a PCIe UIO Write Completion (UIOWrCpl). The translation from non-UIO to UIO write may convert a posted write that does not expect a completion into a non-posted write that receives a UIOWrCpl from the second entity. The UIOWrCpl may provide end-to-end acknowledgment that the write data has been received by the second entity, which the computer may utilize for flow control, error handling, or telemetry collection. The UIOMWr may be sent to the second entity via the path supporting multi-path routing, taking advantage of load balancing or alternative routing available on that path.

In some implementations of the method, the computer translates the PCIe MWr to multiple PCIe UIO Memory Write requests, and wherein the multiple PCIe UIO Memory Write requests are sent via respective paths to multiple second entities, wherein the write data is distributed across the second entities according to a striping scheme. The striping scheme may distribute sequential portions of the write data across the second entities, enabling parallel write operations that increase aggregate write bandwidth. The computer may split the write data into stripes based on configurable stripe sizes, address ranges, or device characteristics. Each PCIe UIO Memory Write request may carry a portion of the original write data to a respective second entity. The computer may receive UIOWrCpl from each of the second entities and may use these completions for internal flow control, error tracking, or telemetry collection.

In some implementations of the method, the computer translates the PCIe MWr to multiple PCIe UIO Memory Write requests comprising essentially identical write data, and wherein the multiple PCIe UIO Memory Write requests are sent via respective paths to multiple second entities for data mirroring. Data mirroring may provide redundancy by writing essentially identical copies of the write data to second entities. The computer may generate multiple PCIe UIO Memory Write requests each carrying essentially the same write data for transmission to different second entities. The mirroring may enable fault tolerance wherein data remains accessible from surviving second entities if one or more second entities fail.

In some implementations of the method, the computer generates parity data based on the write data, translates the PCIe MWr to multiple PCIe UIO Memory Write requests comprising data chunks and parity chunks, and sends the multiple PCIe UIO Memory Write requests via respective paths to multiple second entities. Erasure coding may provide fault tolerance with improved storage efficiency compared to mirroring. The computer may compute parity chunks from the write data using erasure coding algorithms such as Reed-Solomon coding, XOR-based parity, or other error-correction schemes. The data chunks and parity chunks may be distributed across the second entities such that the original write data can be reconstructed from a subset of the chunks if one or more second entities become unavailable.

In some implementations of the method, the PCIe memory request comprises a first physical address in a first physical address space utilized by the first entity, and wherein the PCIe UIO memory request comprises a second physical address in a second physical address space utilized by the second entity. The address translation may accommodate scenarios where the first entity and the second entity utilize different physical address spaces. The translation may be implemented utilizing lookup tables, page tables, base-and-offset calculations, or programmable translation functions.

In some implementations of the method, the first entity comprises at least one of a legacy PCIe host, a legacy PCIe device, a GPU, or a NIC that does not support UIO; and wherein the second entity comprises at least one of a memory device, a memory expander, a memory pool, a Global Fabric-Attached Memory device (GFD), or a PCIe device supporting UIO. Legacy PCIe hosts and devices may not support UIO due to hardware generation, firmware limitations, or configuration choices. GPUs and NICs may benefit from multi-path routing for memory access operations even when they do not natively support UIO. Memory devices, memory expanders, memory pools, and GFDs may be deployed in fabric configurations that support multi-path routing to provide high-bandwidth, low-latency memory access to multiple requesters. The translation performed by the computer may enable these legacy or non-UIO devices to access the benefits of multi-path fabrics.

In various implementations, a system for enabling multi-path routing for a requester, comprising: a first interface configured to communicate with a first entity that does not utilize Unordered Input/Output (UIO); a second interface configured to communicate with one or more second entities via a path supporting multi-path routing; and a computer coupled between the first interface and the second interface, the computer configured to: receive, via the first interface, a Peripheral Component Interconnect Express (PCIe) memory request from the first entity; translate the PCIe memory request to a PCIe UIO memory request; send, via the second interface, the PCIe UIO memory request to at least one of the second entities; receive, via the second interface, a PCIe UIO Completion from the at least one of the second entities; translate the PCIe UIO Completion to a PCIe non-UIO Completion; and send, via the first interface, the PCIe non-UIO Completion to the first entity. The system may enable a first entity that does not support UIO capabilities to access resources via paths that support multi-path routing. The second interface may be coupled to the second entities, enabling the computer to distribute requests across devices for load balancing, fault tolerance, or data distribution schemes such as striping or mirroring. The system may be implemented as a semiconductor device, a switch, a bridge, or other suitable device positioned between the first entity and the second entities.

In some implementations of the system, the computer is configured to send the PCIe UIO memory request to one or more of the second entities based on at least one of: address mapping, load balancing, or a data distribution policy. The computer may select which of the second entities receives the PCIe UIO memory request based on address mapping that assigns address ranges to specific second entities, load balancing that distributes requests to minimize congestion, or a data distribution policy that implements striping, mirroring, or erasure coding across the second entities. The second interface may include ports or channels to communicate with the second entities concurrently.

In some implementations of the system, at least two of the second entities utilize different physical address spaces, and wherein the computer comprises address translation logic configured to translate a physical address from the first entity to respective physical addresses for each of the at least two of the second entities. The different physical address spaces may have different base addresses, different sizes, and/or different memory layouts. The address translation logic may maintain separate translation tables or mappings for each of the second entities, enabling the computer to translate an address from the first entity into different addresses for the respective second entities. This capability may enable unified addressing from the perspective of the first entity while accommodating heterogeneous memory configurations across the second entities.

In some implementations of the system, the computer is further configured to implement at least one of: data striping across the second entities, data mirroring to the second entities, or erasure coding with parity distribution across the second entities. The computer may include logic to split write data into stripes for distribution across the second entities, to replicate write data for mirroring to the second entities, or to compute parity chunks for erasure coding distribution. The computer may also include logic to reassemble striped read data from the second entities, to select among mirrored copies for read operations, or to reconstruct data from erasure-coded chunks when one or more of the second entities are unavailable. The computer may operate transparently to the first entity, presenting a unified memory view while implementing the selected data distribution scheme.

In some implementations of the system, the second interface is coupled to a fabric comprising physical paths to the one or more of the second entities, and wherein the computer is configured to select among the physical paths based on path availability or congestion. The fabric may include redundant links, parallel switch paths, or mesh interconnect topologies that provide concurrent paths between the computer and the one or more of the second entities. The computer may monitor path availability and congestion indicators to select paths that optimize latency, bandwidth, or reliability. Path selection may be performed per-request, per-flow, or at other granularities based on system requirements.

In various implementations, a method for managing ordering in translation, comprising: receiving, from a first entity, a Peripheral Component Interconnect Express (PCIe) Unordered Input/Output (UIO) memory request, wherein the first entity is configured to enforce ordering requirements for the PCIe UIO memory request; translating, by a computer, the PCIe UIO memory request to a PCIe non-UIO memory request; sending the PCIe non-UIO memory request to a second entity via a path that enforces fabric-based ordering; receiving, from the second entity, a PCIe non-UIO Completion; translating, by the computer, the PCIe non-UIO Completion to a PCIe UIO Completion; and sending the PCIe UIO Completion to the first entity. UIO shifts the responsibility for enforcing observed ordering from the fabric to the requester, whereas non-UIO PCIe relies on fabric-based ordering rules. When translating from UIO to non-UIO, the computer may manage this transition by translating requests from a domain where the requester enforces ordering to a domain where the fabric enforces ordering. The first entity, utilizing UIO, may issue requests with the expectation that completions may arrive in various orders and that the first entity bears responsibility for ordering requirements. The non-UIO path to the second entity may enforce ordering according to non-UIO PCIe rules. The computer may bridge these different ordering models while maintaining correct transaction semantics on each side.

In some implementations of the method, the first entity is configured to accept PCIe UIO Completions without a predetermined order, and to enforce ordering requirements based on completion arrival. UIO requesters may accept UIO Completions in various orders according to PCIe UIO specifications. The first entity may implement ordering enforcement mechanisms such as completion reordering buffers, sequence number tracking, or dependency tracking to enforce required ordering based on the order in which completions arrive. This requester-based ordering may simplify fabric elements by removing the need for in-order completion delivery while placing ordering responsibility on the endpoints.

In some implementations of the method, the path that enforces fabric-based ordering enforces producer-consumer ordering rules based on PCIe specifications, and wherein the computer is configured to track pending transactions to correlate the PCIe non-UIO Completion with the PCIe UIO memory request. PCIe fabric ordering rules may include requirements such as posted requests not passing other posted requests to the same destination, completions not being blocked by requests, and non-posted requests maintaining ordering with respect to posted requests. These producer-consumer ordering rules may enable PCIe devices to operate correctly without implementing ordering enforcement logic. The computer may maintain tracker entries or pending transaction tables to associate incoming completions with their corresponding requests, enabling correct translation of completions back to the UIO domain with appropriate Tag restoration.

In some implementations of the method, the PCIe UIO memory request comprises a UIO Memory Read (UIOMRd) request comprising a first address and a first Tag, wherein the PCIe non-UIO memory request comprises a non-UIO Memory Read (MRd) request comprising a second address and a second Tag, wherein the PCIe non-UIO Completion comprises a non-UIO Completion with Data (CplD), and wherein the PCIe UIO Completion comprises a UIO Read Completion with Data (UIORdCplD). The UIOMRd from the first entity may be issued with the expectation of out-of-order completion delivery. The computer may translate the UIOMRd to an MRd for transmission to the second entity, where the fabric may enforce ordering with respect to other transactions. Upon receiving the CplD from the second entity, the computer may translate it to a UIORdCplD for delivery to the first entity.

In some implementations, the method further comprises receiving, from the first entity, a PCIe UIO Memory Write request (UIOMWr) comprising a Tag and write data, wherein the first entity expects a UIO Write Completion (UIOWrCpl) for the UIOMWr; translating, by the computer, the PCIe UIOMWr to a PCIe non-UIO Memory Write request (MWr) comprising the write data; sending the PCIe MWr to the second entity via the path that enforces fabric-based ordering; and sending, to the first entity, a PCIe UIOWrCpl comprising the Tag. The translation from UIO to non-UIO write may involve converting a non-posted write that expects a completion into a posted write that does not return a completion from the second entity. The first entity, utilizing UIOMWr, may expect a UIOWrCpl to confirm write completion and to enforce ordering requirements. The computer may generate the UIOWrCpl to satisfy the first entity's expectation, even though the MWr sent to the second entity is posted and does not receive a completion. The fabric-based ordering on the non-UIO path may provide ordering guarantees that the first entity would otherwise need to enforce based on UIOWrCpl arrival.

In some implementations of the method, the computer sends the UIOWrCpl to the first entity at one of: before sending the PCIe MWr to the second entity, in parallel with sending the PCIe MWr to the second entity, or after the computer receives acknowledgment that the PCIe MWr has been accepted by a downstream component. Sending the UIOWrCpl before sending the MWr may reduce latency observed by the first entity, enabling the first entity to proceed with subsequent operations and enforce required ordering based on early completion notification. Sending the UIOWrCpl in parallel with the MWr may balance latency and ordering considerations. Sending the UIOWrCpl after receiving downstream acknowledgment may provide stronger guarantees that the write data has progressed toward the second entity before the first entity receives completion notification. The selection between these timing options may be configurable or may be determined dynamically based on system conditions.

In some implementations of the method, the UIOWrCpl comprises a CXL DevLoad (CDL), and wherein the computer populates the CDL with Quality-of-Service (QoS) telemetry information based on at least one of: queue depth at the computer, observed latency, or congestion indicators. The computer may populate the CDL with locally generated telemetry information since the posted MWr sent to the second entity does not return a completion carrying telemetry. The first entity may utilize this telemetry to make informed decisions about subsequent write operations, such as throttling write rates or selecting alternative destinations based on observed conditions at the computer.

In some implementations of the method, the PCIe UIO memory request comprises a first physical address in a first physical address space utilized by the first entity, and wherein the PCIe non-UIO memory request comprises a second physical address in a second physical address space utilized by the second entity. The address translation may enable the first entity to access resources at the second entity utilizing physical addresses within a physical address space utilized by the first entity, while the computer translates to physical addresses appropriate for the physical address space utilized by the second entity. The translation may be implemented utilizing lookup tables, page tables, base-and-offset calculations, or programmable translation functions.

In some implementations of the method, the first entity comprises at least one of a UIO-capable host, a UIO-capable GPU, a UIO-capable NIC, or a UIO-capable accelerator, and wherein the second entity comprises at least one of a legacy PCIe device, a legacy PCIe host, a memory device, or a storage controller that does not support UIO. UIO-capable hosts, GPUs, NICs, and accelerators may implement UIO to benefit from multi-path routing, out-of-order completion handling, or simplified fabric interactions. Legacy PCIe devices and hosts may not support UIO due to hardware generation or design choices. Memory devices and storage controllers may operate using PCIe with fabric-based ordering. The translation performed by the computer may enable UIO-capable devices to access these legacy or non-UIO resources while maintaining correct ordering on each side of the translation boundary.

In various implementations, a system for managing ordering in translations, comprising: a first interface configured to communicate with a first entity that utilizes Peripheral Component Interconnect Express (PCIe) Unordered Input/Output (UIO) and is configured to enforce ordering requirements; a second interface configured to communicate with a second entity via a path that enforces fabric-based ordering; and a computer coupled between the first interface and the second interface, the computer configured to: receive, via the first interface, a PCIe UIO memory request from the first entity; translate the PCIe UIO memory request to a PCIe non-UIO memory request; send, via the second interface, the PCIe non-UIO memory request to the second entity; receive, via the second interface, a PCIe non-UIO Completion from the second entity; translate the PCIe non-UIO Completion to a PCIe UIO Completion; and send, via the first interface, the PCIe UIO Completion to the first entity. The system may bridge different ordering models, translating between UIO where the requester enforces ordering and non-UIO where the fabric enforces ordering. The system may enable UIO-capable devices to access legacy PCIe infrastructure while maintaining correct transaction semantics on each side of the translation boundary.

In some implementations of the system, the computer comprises ordering management logic configured to receive PCIe UIO memory requests arriving at the computer without fabric-based ordering, and to send corresponding PCIe non-UIO memory requests via the path that enforces fabric-based ordering according to producer-consumer ordering rules. The ordering management logic may buffer or queue incoming PCIe UIO memory requests and may release corresponding PCIe non-UIO memory requests according to the ordering constraints of the non-UIO path. The ordering management logic may implement mechanisms to prevent deadlocks that could arise from the interaction between UIO and non-UIO ordering models.

In some implementations of the system, the computer comprises tracker entries, each tracker entry configured to store state information for a pending transaction including a mapping between a first Tag from the PCIe UIO memory request and a second Tag for the PCIe non-UIO memory request. The tracker entries may enable the computer to correlate incoming PCIe non-UIO Completions with their corresponding PCIe UIO memory requests, enabling correct restoration of Tags when translating completions back to the UIO domain. The tracker entries may support concurrent transactions, with each entry tracking a separate pending operation.

In some implementations of the system, the computer comprises completion generation logic configured to generate PCIe UIO Completions for PCIe UIO Memory Write requests when the PCIe non-UIO memory request comprises a posted write that does not receive a completion from the second entity. The completion generation logic may generate UIOWrCpl to satisfy the first entity's expectation of completion acknowledgment for non-posted UIO writes, even though the translated MWr sent to the second entity is posted and does not return a completion. The completion generation logic may determine the timing of completion generation based on configuration settings, system conditions, or ordering requirements.

In some implementations of the system, the computer is further configured to translate between a first physical address belonging to a first physical address space utilized by the first entity and a second physical address belonging to a second physical address space utilized by the second entity. The computer may utilize lookup tables, translation lookaside buffers, page table walkers, or programmable translation functions for the address translation, which may enable the first entity to access resources at the second entity utilizing physical addresses within an address space utilized by the first entity, while the second entity operates utilizing physical addresses within a different address space.

In some implementations of the system, the first entity comprises at least one of a UIO-capable GPU, a UIO-capable NIC, or a UIO-capable accelerator, and wherein the second entity comprises at least one of a legacy PCIe memory device, a legacy PCIe storage controller, or a legacy PCIe host. UIO-capable GPUs, NICs, and accelerators may implement UIO to benefit from multi-path routing, out-of-order completion handling, or simplified fabric interactions in modern datacenter and high-performance computing environments. Legacy PCIe memory devices, storage controllers, and hosts may operate using PCIe with fabric-based ordering. The system may bridge these different device generations and capabilities, enabling modern UIO-capable devices to access legacy infrastructure.

### Terminology

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and Infinity Fabric, ARM's CHI C2C, and NVIDIA's NVLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D1.4), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### General Considerations

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CplD), a PCIe UIO Read Completion with Data (UIORdCplD), a UALink UPLI Data Beat carrying Read Response Data, or an NVLink data transmission. *Data* may also denote PDUs having collectively essentially the same payload, such as when splitting a 128 B cacheline into two 64 B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/sending, receive/receiving, communicate/communicating, or exchange/exchanging when used to describe elements (e.g., computer, RPU, MxPU, processor, semiconductor device, switch, port, interface) involved in data, message, packet, or other information exchanges, may refer to direct or indirect operation(s) that facilitate information transfer to/from/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCIe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS.1.1)=00-00-CA-FE in a protocol that utilizes 32-bit address fields, which corresponds to the address (AS.2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. A method for translating between Compute Express Link (CXL) messages, comprising:
receiving, from a first entity, a CXL.cache Host-to-Device (H2D) request;
translating the CXL.cache H2D request to a CXL.cache Device-to-Host (D2H) request; and
sending the CXL.cache D2H request to a second entity.

2. The method of claim 1, wherein the first entity comprises a first host, and the CXL.cache H2D request comprises a first address belonging to a first Host Physical Address (HPA) space utilized by the first host; and wherein the second entity comprises a second host, and wherein the CXL.cache D2H request comprises a second address belonging to a second HPA space utilized by the second host.

3. The method of claim 2, wherein the CXL.cache H2D request comprises snoop invalidate (SnpInv) and Unique Queue ID (UQID), and wherein the CXL.cache D2H request comprises CacheLine Flush (CLFlush) and command queue identifier (CQID).

4. The method of claim 2, wherein the CXL.cache H2D request comprises snoop invalidate (SnpInv) and Unique Queue ID (UQID), and the CXL.cache D2H request comprises command queue identifier (CQID) and Read for Ownership No Data (RdOwnNoData) or Read for Ownership (RdOwn).

5. The method of claim 2, further comprising receiving from the second host a CXL.cache H2D Data, translating the CXL.cache H2D Data to a CXL.cache Device-to-Host (D2H) Data, and sending the CXL.cache D2H Data to the first host.

6. The method of claim 2, wherein the CXL.cache H2D request comprises SnpData and Unique Queue ID (UQID), and the CXL.cache D2H request comprises RdShared and command queue identifier (CQID).

7. The method of claim 2, wherein the CXL.cache H2D request comprises SnpData and Unique Queue ID (UQID), and the CXL.cache D2H request comprises RdOwn and command queue identifier (CQID).

8. The method of claim 2, wherein the CXL.cache H2D request comprises snoop invalidate (SnpInv) and Unique Queue ID (UQID), the CXL.cache D2H request comprises RdOwn and command queue identifier (CQID), and further comprising receiving from the second host a CXL.cache H2D Data message comprising cacheline data.

9. The method of claim 1, further comprising: receiving, from the second entity, a CXL.cache H2D Data message comprising cacheline data and command queue identifier (CQID); translating the CXL.cache H2D Data message to a CXL.cache D2H Data message comprising the cacheline data and Unique Queue ID (UQID); and sending the CXL.cache D2H Data message to the first entity.

10. The method of claim 1, further comprising receiving, from the second entity, a CXL.cache H2D response comprising a GO opcode and command queue identifier (CQID); translating the CXL.cache H2D response to a CXL.cache D2H response comprising Rsp* and Unique Queue ID (UQID); and sending the CXL.cache D2H response to the first entity.

11. The method of claim 10, wherein the CXL.cache H2D response comprises a GO opcode and a field indicating an Invalid state (GO-I), and wherein the CXL.cache D2H response comprises RspIHitI.

12. The method of claim 1, further comprising receiving, from the second entity, a CXL.cache H2D Data comprising command queue identifier (CQID); translating the CXL.cache H2D Data to a CXL.cache D2H response comprising *Fwd* and Unique Queue ID (UQID); and sending the CXL.cache D2H response to the first entity.

13. The method of claim 12, wherein the CXL.cache D2H request comprises RdCurr and command queue identifier (CQID); and further comprising translating the CXL.cache H2D Data to a CXL.cache D2H response comprising RspVFwdV and Unique Queue ID (UQID).

14. The method of claim 1, further comprising receiving, from the second entity, a CXL.cache H2D response comprising a GO opcode and command queue identifier (CQID); translating the CXL.cache H2D response to a CXL.cache D2H Data comprising Unique Queue ID (UQID); and sending the CXL.cache D2H Data to the first entity.

15. The method of claim 1, further comprising exposing a CXL Type-1 device or a CXL Type-2 device to the first entity via a first interface, and exposing a CXL Type-1 device or a CXL Type-2 device to the second entity via a second interface.

16. The method of claim 1, wherein the translating comprises performing translations between the CXL.cache H2D request and the CXL.cache D2H request, wherein the translations comprise translations between Unique Queue ID (UQID) and command queue identifier (CQID), translations between reserved fields, and/or translations between reserved and non-reserved fields.

17. The method of claim 1, further comprising: receiving, from the second entity, a CXL.cache H2D response comprising a GO-S indication and command queue identifier (CQID); translating the CXL.cache H2D response to a CXL.cache D2H response comprising RspSHitSE and Unique Queue ID (UQID); and sending the CXL.cache D2H response to the first entity.

18. The method of claim 1, further comprising: receiving, from the second entity, a CXL.cache H2D response comprising a GO-E indication and command queue identifier (CQID); translating the CXL.cache H2D response to a CXL.cache D2H response comprising an opcode selected from RspIHitI, RspIHitSE, or RspIFwdM, and comprising Unique Queue ID (UQID); and sending the CXL.cache D2H response to the first entity.

19. The method of claim 1, further comprising: receiving, from the second entity, a CXL.cache H2D response comprising a GO-M indication and command queue identifier (CQID), and a CXL.cache H2D Data message comprising cacheline data; translating the CXL.cache H2D response to a CXL.cache D2H response comprising RspIFwdM and Unique Queue ID (UQID); and sending the CXL.cache D2H response to the first entity.

20. The method of claim 1, further comprising exposing a cache abstraction to the first entity via a CXL.cache interface, wherein the cache abstraction acts as a proxy for a cache included in the second entity, and the CXL.cache H2D request targets the cache abstraction.

21. The method of claim 1, wherein the translating enables cacheline state orchestration between a first cache maintained by the first entity and a second cache maintained by the second entity.

22. The method of claim 21, wherein the cacheline state orchestration comprises cross invalidation of cacheline states; and/or wherein the cacheline state orchestration enables cache-coherent memory sharing between the first entity and the second entity.

23. A non-transitory computer-readable medium comprising instructions which, when executed by a processor, cause the processor to perform the method of claim 1.

24. One or more integrated circuits configured to perform the method of claim 1, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

25. An active cable comprising first and second pluggable modules coupled by a physical medium; wherein the active cable further comprises hardware circuitry, integrated into the active cable, configured to perform the method of claim 1.

26. An apparatus configured to operate as a switch, wherein the apparatus comprises switching circuitry and is configured to perform the method of claim 1.

27. A system comprising:
first and second interfaces based on Compute Express Link (CXL);
a computer coupled to the first and second interfaces, wherein the computer is configured to:
receive, from a first entity via the first interface, a CXL.cache Host-to-Device (H2D) request comprising a first address belonging to a first Host Physical Address (HPA) space;
translate the CXL.cache H2D request to a CXL.cache Device-to-Host (D2H) request comprising a second address belonging to a second HPA space; and
send the CXL.cache D2H request to a second entity via the second interface.

28. The system of claim 27, wherein the first entity comprises a first host utilizing the first HPA space, and the second entity comprises a second host utilizing the second HPA space; and wherein the computer is further configured to identify an intent indicated by the CXL.cache H2D request, wherein the intent comprises a cacheline state intent for a cacheline address, and wherein the translating is based at least in part on the identified intent.

29. A system comprising:
first and second interfaces based on Compute Express Link (CXL);
a computer coupled to the first and second interfaces, wherein the computer is configured to:
receive, from a first entity via the first interface, a CXL.cache Host-to-Device (H2D) request;
translate the CXL.cache H2D request to a CXL.cache Device-to-Host (D2H) request; and
send the CXL.cache D2H request to a second entity via the second interface; wherein the translation enables cacheline state orchestration between a first cache maintained by the first entity and a second cache maintained by the second entity.

30. The system of claim 29, wherein the cacheline state orchestration comprises cross invalidation of cacheline states, and wherein the cacheline state orchestration enables cache-coherent memory sharing between the first entity and the second entity.
